(19) United States
(12) Patent Application Publication
(10) Pub. No.: US 2020/0029133 A1
(43) Pub. Date: Jan. 23, 2020

(54) Camera Capture in an Organization Information Distribution System

(71) Applicant: NRS Systems, Yakima, WA (US)

(72) Inventors: John Michael Gehlsen, Yakima, WA (US); Jeffrey Brian Jarvis, Beaverton, OR (US); Joseph Alan Kogut, Yakima, WA (US)

(73) Assignee: NRS Systems, Yakima, WA (US)

(21) Appl. No.: 16/378,348

(22) Filed: Apr. 8, 2019

Related U.S. Application Data
(63) Continuation-in-part of application No. 16/042,486, filed on Jul. 23, 2018.

(51) Int. Cl. H04N 21/8549; H04N 21/2187; G06K 9/00; H04L 9/08

(52) U.S. Cl. CPC H04N 21/8549; H04N 21/2187; H04L 9/0863; G06K 9/00751; G06K 9/00288

(57) ABSTRACT

Techniques described herein provide video capture via an organization information distribution system. In implementations, a video monitoring device connects to a camera over a network and obtains video data associated with a live video stream. Some implementations store the video data in a circular buffer. In response to receiving a trigger event, one or more implementations generate a video clip from the video data in the circular buffer, where the video clip includes video data stored prior to the trigger event. In turn, one or more implementations transmit the video clip to a destination computing device.

### PRIORITY

This application is a continuation-in-part and claims priority to U.S. patent application Ser. No. 16/042,486 entitled “Immediate Views” and filed Jul. 23, 2018, the disclosure of which is incorporated by reference herein in its entirety.

### BACKGROUND

Organizations oftentimes occupy large spaces that span multiple rooms and/or locations. These large spaces and diverse locations can make it difficult to disseminate information throughout the organization in real-time.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment capable of distributing an immediate view across an organization in accordance with one or more implementations;

FIG. 2 illustrates an example environment in which cloud-based services can be used to distribute immediate views across an organization in accordance with one or more implementations;

FIGS. 3a and 3b illustrate an example progression of deploying and immediate view over an arbitrary time period in accordance with one or more implementations;

FIG. 4 illustrates various interaction between devices over a network to invoke an immediate view in accordance with one or more implementations;

FIG. 5 illustrates an example of deploying an immediate view to different devices and locations in accordance with one or more implementations;

FIG. 6 illustrates an example of distributing actions to different device types across an organization in accordance with one or more implementations;

FIG. 7 illustrate example features of an immediate view in accordance with one or more implementations;

FIG. 8 illustrates an immediate view that includes timing mechanisms in accordance with one or more implementations;

FIGS. 9a-j illustrate example user interfaces that can be used to configure organization preferences in accordance with one or more implementations;

FIG. 10 illustrates example devices associated with invoking a trigger event in accordance with one or more implementations;

FIG. 11 illustrates a flow diagram of an example method that invokes an immediate view in accordance with one or more implementations;

FIG. 12 illustrates a flow diagram of an example method that deploys actions to various devices in an organization information distribution system in accordance with one or more implementations;

FIG. 13 illustrates an example environment that includes an invocation device in accordance with one or more implementations;

FIG. 14 illustrates various interactions between devices to invoke a notification of a trigger event in accordance with one or more implementations;

FIG. 15 illustrates an example of invoking distributed actions via a single user interaction in accordance with one or more implementations;

FIG. 16 illustrates an example environment that includes an invocation device in accordance with one or more implementations;

FIG. 17 illustrates an example detection system that can be used to invoke a notification of a trigger event in accordance with one or more implementations;

FIG. 18 illustrates an example environment that includes an invocation device in accordance with one or more implementations;

FIG. 19 illustrates an example of invoking distributed actions via a single user interaction in accordance with one or more implementations;

FIG. 20 illustrates an example of a detection system invoking a notification of a trigger event in accordance with one or more implementations;

FIGS. 21a and 21b illustrate an example of a tiered deployment process in accordance with one or more implementations;

FIG. 22 illustrates a flow diagram that can be used to send a notification of a trigger event in accordance with one or more implementations;

FIG. 23 illustrates an example environment in which an organization information distribution system can be utilized to extract video clips from a camera in accordance with one or more implementations;

FIG. 24 illustrates an example environment in which an organization information distribution system can be utilized to extract video clips from a camera in accordance with one or more implementations;

FIG. 25 illustrates an example circular buffer that can be used to generate a video clip in accordance with one or more implementations;

FIG. 26 illustrates an example environment in which an organization information distribution system can be utilized to extract video clips from a camera;

FIG. 27 illustrates an example of trigger event-based camera captures in accordance with one or more implementations;

FIG. 28 illustrates an example method that can be utilized to generate video clips using an organization information distribution system that is in accordance with one or more implementations;

FIG. 29 illustrates an example environment in which vape detection devices can be utilized in an organization information distribution system in accordance with one or more implementations;

FIG. 30 illustrates features of vape detection in an organization information distribution system that are in accordance with one or more implementations;

FIG. 31 illustrates an example method that can be utilized to employ vape detection in an organization information distribution system in accordance with one or more implementations;

FIG. 32 illustrates an example method that can be utilized to employ vape detection in an organization information distribution system in accordance with one or more implementations;

FIG. 33 illustrates an example environment in which features of real-time messaging are implemented in an organization information distribution system in accordance with one or more embodiments;

FIG. 34 illustrates an example environment in which features of real-time messaging in an organization information distribution system can be implemented in accordance with one or more embodiments;

FIG. 35 illustrates an example method that can be utilized to deploy real-time messages in an organization information distribution system in accordance with one or more implementations;

FIG. 36 illustrates an example environment n which features of test modes in an organization information distribution system can be implemented in accordance with one or more embodiments;

FIG. 37 illustrates an example environment that can be used to implement features of client control applications in an organization information distribution system in accordance with one or more embodiments;

FIG. 38 illustrates an example environment that can be used to implement features of a client control application in an organization information distribution system that are in accordance with one or more implementations;

FIG. 39 illustrates an example environment that can be used to implement a client control application in an organization information distribution system in accordance with one or more embodiments;

FIG. 40 an example environment in which cloud-based services can be utilized to provide client control of an organization information distribution system accordance with one or more implementations;

FIG. 41 illustrates an example method that can be used for remotely controlling an organization information distribution system via a client control application in accordance with one or more implementations;

FIG. 42 illustrates an example environment in which an organization information distribution system interfaces with security sensors and/or service providers in accordance with one or more implementations;

FIG. 43 illustrates an example environment that can be used to implement features of security monitoring in an organization information distribution system in accordance with one or more implementations;

FIG. 44 an example method that ban be utilized to monitor security systems with an organization information distribution system in accordance with one or more implementations;

FIG. 45 is an illustration of an example content management device in accordance with one or more implementations;

FIG. 46 is an illustration of an example invocation device in accordance with one or more implementations; and

FIG. 47 is an illustration of an example system server device in accordance with one or more implementations.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Techniques described herein provide an organization information distribution system. At least some implementations connect to a system server associated with an organization information distribution system over a communication network. In response to receiving a notification from the system server, various implementations present default content associated with operating in a default mode. The default content can be presented in a persistent manner and/or for a predetermined time period. Upon receiving a second notification from the system server, one or more implementations transition out of the default mode and present different content associated with the second notification, such as an immediate view, audio files and/or content, video content, and so forth, where an immediate view corresponds to content that is disseminated in real-time across an organization.

Various techniques described herein deploy actions across an organization using an organization information distribution system. At least one implementation receives a notification of a trigger event from a device associated with the organization distribution system. The trigger event can include any combination of information associated with alarms and/or events. In response to receiving the notification, various implementations analyze an organization profile associated with the organization information distribution system to determine actions to deploy to devices associated with the organization system. Some techniques deploy a same action to multiple devices. Alternately or additionally, various techniques deploy different actions to sub-groups of devices within the organization.

Various techniques provided herein generate trigger events in an organization information distribution system. Various implementations establish a connection between an invocation device and a server using a communication network. Establishing the connection can include authenticating the invocation device to the server and/or authenticating the server to the invocation device. In response to establishing the connection to the server, one or more implementations detect a trigger event, such as the actuation of a hardware mechanism and/or a sensor detecting the trigger event without user-intervention. Some implementations capture content based on a point in time associated with when the trigger event occurs. Upon detecting the trigger event, various implementations forward a notification of the trigger event and/or the captured content.

Consider now an example environment in which various aspects as described herein can be employed.

### Example Environment

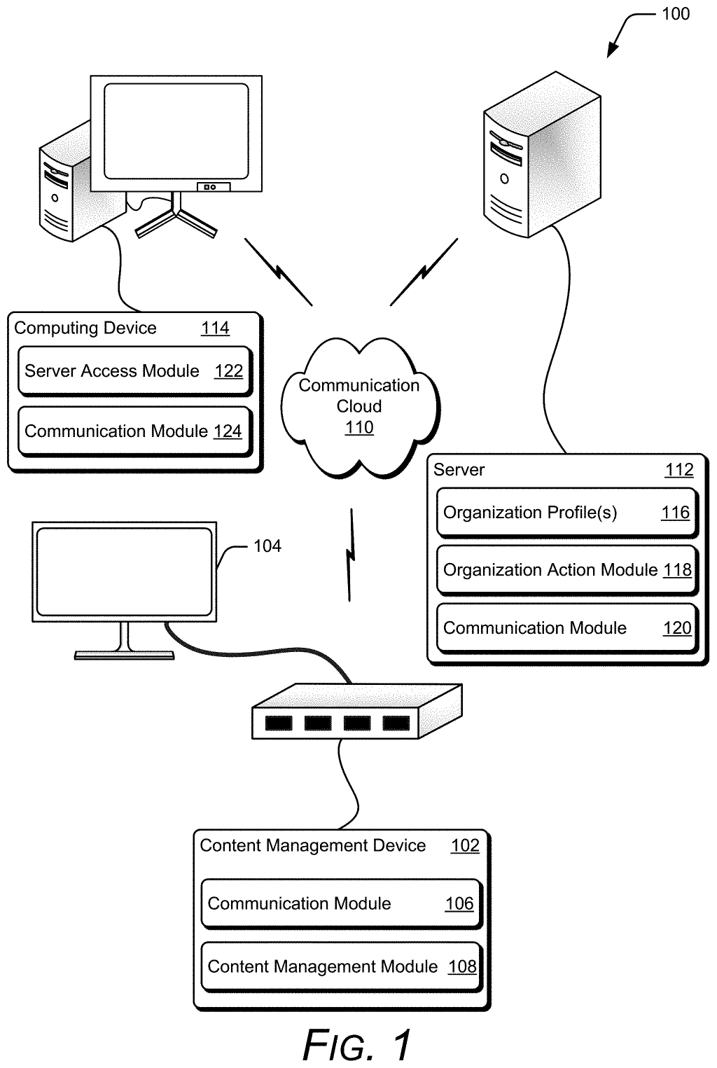

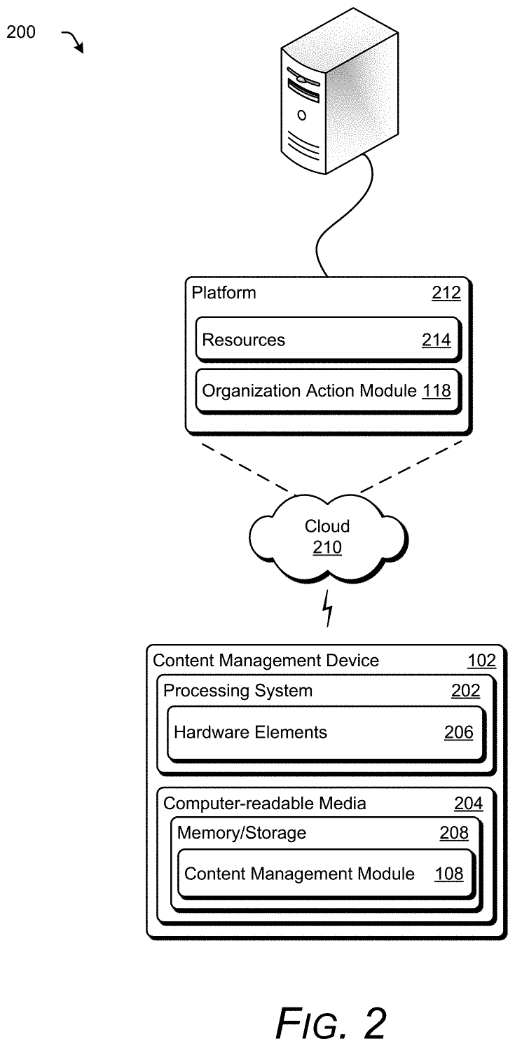

FIG. 1 illustrates an example environment 100 that includes an example organization information distribution system in accordance with one or more implementations. As part of the organization information distribution system, environment 100 includes content management device 102 that is capable of driving the presentation of content, such as rendering images, outputting audio, and so forth. In at least some implementations, content management device 102 represents a smart device, such as an Internet of Things (“IoT”) device that corresponds to a network of interconnected devices that inter-operate with one another using the network. Accordingly, content management device 102 can range from a system with significant processing power, to a lightweight device with minimal processing power. To render content, content management device 102 connects to an external display device 104, but other implementations of content management device 102 include an integrated display device without departing from the scope of the claimed subject matter. Content management device 102 can alternately or additionally present other types of content, such as audible content.

Display device 104 represents any suitable type of device that can be used to render images, such as an organic light-emitting diode (OLED) display, Liquid Crystal Display (LCD), a light-emitting diode display (LED), an electroluminescent display (ELD), a plasma display panel (PDP), and so forth. In some implementations, display device 104 includes touch input capabilities, where input can be received through physical interactions with the display device (e.g., fingers, styluses, etc.). Various implementations use combinations of hardware, firmware and/or software to generate a device capable of rendering content.

Various implementations of content management device 102 include a communication module 106 and a content management module 108 to determine what content to present. Communication module 106 represents any suitable combination of hardware, software, and/or firmware used to facilitate the exchange of information with one or more other devices, such as images, addresses, audio, video, commands, queries, messaging, data, and so forth. For instance, some implementations of communication module 106 include one or more protocol stacks associated with a network over which data is exchanged, firmware that drives hardware to generate signals and/or process messages used in maintaining a wireless and/or wired communication session, and so forth. Some implementations of communication module 106 include computer networking ports, such as a Transmission Control Protocol (TCP) port, a User Datagram Protocol (UDP) port, a File Transfer Protocol (FTP) port, a Hypertext Transfer Protocol (HTTP) port, an Internet Message Access Protocol (IMAP) port, and so forth. Alternately or additionally, communication module 106 includes physical communication ports, such as a serial port, a parallel port, a Universal Serial Bus (USB) port, a keyboard port, a display port, an audio port, etc. As example, some implementations of content management device 102 render content on display device 104 using a display port that communicatively couples the content management device with the display device. While not illustrated here, content management device 102 can alternately or additionally drive an audio output through a corresponding audio port, such as audio synchronized with a video.

Content management module 108 manages what content is presented by content management device 102 and when. As an example, various implementations of content management module 108 determine to present default content, such as a video, a web page, a playlist of one or more images, a slideshow, an audio clip, and so forth. Here, the phrase “presenting content” denotes the ability to render and/or play out content in any suitable manner, such as by displaying an image, outputting audio files and/or content, transmitting messages, etc. Content management module 108 can also determine to switch from the default content to different content. As one example, content management module 108 can receive and/or send messages with a remote server to determine when to change what content is presented, such as receiving a message from the remote server that indicates to switch from presenting default content to presenting an immediate view, where an immediate view corresponds to content that is disseminated in real-time across an organization, as further described herein. Accordingly, content management module 108 represents functionalities for performing different tasks via the content management device 102. In various implementations, content management module 108 provides content management device 102 with access to cloud-based services as further described herein. Accordingly, content management module 108 may be installed locally on the content management device 102 to be executed via a local runtime environment, and/or corresponds to portals that access remote functionality, such as cloud-based services, web apps, and so forth. Thus, content management module 108 may take a variety of forms, such as locally-executed code, portals to remotely hosted services, and so forth.

Content management device 102 uses communication module 106 to connect with other devices over communication cloud 110. Communication cloud 110 generally represents any suitable type of communication network that facilitates a bi-directional link between various computing devices. Accordingly, communication cloud 110 can include multiple interconnected communication networks that comprise a plurality of interconnected elements, such as a wireless local area network (WLAN) with Ethernet access, a wireless telecommunication network interconnected with the Internet, a wireless (Wi-Fi) access point connected to the Internet, an IoT network, and so forth. Alternately or additionally, communication cloud 110 can include wired connections between devices, such as a sensor device connected to a switch device over a wired connection. In this example, communication cloud 110 connects content management device 102 with server 112, server 112 with computing device 114, and/or other devices not illustrated here.

Server 112 represents a remote server that provides organization information distribution services to content management device 102. As one example, server 112 identifies an incoming trigger event associated with a particular organization, determines what actions to deploy across the organization, and deploys the various actions and/or messages. Here, the phrase “trigger event” is used to indicate the occurrence of something that is relevant and/or of interest to an organization. When a trigger event occurs, the system can handle and/or process the trigger event in various ways, as further described herein. This can include deploying an immediate view to content management device 102 in response to the trigger event, where an immediate view corresponds to content that is disseminated in real-time across the organization. Various implementations process the immediate view and/or trigger event as a point-in-time event that occurs for a finite duration and/or process the trigger event as a persistent event/alarm that can change states (e.g., on/off, triggered/cleared, enabled/disabled, etc.). In various implementations, the server deploys actions and/or content to various devices using a tiered system as further described herein.

An organization information distribution system supplies a user with the ability to disseminate content in real-time to multiple devices associated with an organization based upon various trigger events. This can include devices registered to an organization, and/or devices that are not registered to the organization but are selected to receive information from the organization. Accordingly, server 112 includes organization profiles 116 and organization action module 118 to determine which devices to communicate with for a particular organization, as well as what actions to direct to each device. Various implementations configure server 112 as a server that provides cloud-based services and/or a platform of functionality to remote devices. For example, server 112 can represent a central computing device that uses a platform to deliver an experience to various recipient devices that tailored to each recipient device and yet provides a common experience to all of the devices.

Organization profiles 116 generally represent a subscriber's preferences for a particular organization, such as which devices are included in, or associated with, the organization, what partitioning is applied to the devices to form sub-groups, what default content is displayed via the devices and/or sub-groups, what content is presented in an immediate view, what actions to deploy for particular trigger events, and so forth. This can include disseminating still images, video images, audio, character-based messages (e.g., text), enabling text-to-speech audio, and so forth. An immediate view can be disseminated to any suitable number of devices, such as a single device in an organization, a sub-group of devices within the organization, multiple sub-group devices within the organization, and/or all of the devices included in the organization. Thus, various implementations enable a subscriber to the organization information distribution system to configure an immediate view to correspond to their organization, as well as what devices receive the immediate view, what trigger events deploy the immediate view, what non-organization device receive notifications, etc. In some scenarios, a subscriber can configure different immediate views for different trigger events by way of an organization profile. While illustrated here as residing on server 112, alternate or additional implementations store portions or all of an organization profile on a content management device.

Organization action module 118 analyzes an organization profile to determine what actions correspond to what trigger event and deploy the identified actions across an organization. In various implementations, organization action module 118 provides platform functionality used in a distributed system, such as over a “cloud” as further described herein. While an organization profile describes what trigger events, content, actions, devices, etc. belong to an organization, the organization action module analyzes the organization profile, and deploys the actions according to the profile. Accordingly, organization action module 118 can invoke various different actions in response to a trigger event, such as sending a Short Message Service (SMS) text message to designated mobile devices, sending an e-mail to designated e-mail devices and/or accounts, sending audible messages to designated telephone numbers, enabling text-to-speech output at a content management device, enabling or disabling an electronic switch and/or relay, initiating a telephone call, and so forth. To deploy the various actions, server 112 includes a communication module 120 as a way to communicate with remote devices over communication cloud 110. As in the case of communication module 106, communication module 120 generally represents any combination of software, hardware, and/or firmware that enables server 112 to communicate across the communication cloud.

Computing device 114 represents a user device in which a user can access server 112 and/or invoke a trigger event. For example, in environment 100, computing device 114 provides access to server 112 and/or organization profiles 116 by way of server access module 122 and communication module 124. As one example, server access module 122 can be configured as a web browser that renders a web page hosted by server 112 and/or a stand-alone application, such as a smart phone application, a desktop application, etc. When invoked, the web browser and/or stand-alone application can provide a navigable user interface that enables a user to enter configuration parameters and/or user preferences to an organization profile. By way of example and not of limitation, the configuration parameters can include registering devices to an organization, creating sub-groups of devices within the organization, removing devices from an organization, associating non-organization devices to the organization, configuring content for immediate views/default views, identifying or adding trigger events, assigning actions to trigger events, and so forth. Various implementations of server access module 122 provide a mechanism to invoke a trigger event, such as a software control displayed on a corresponding user interface that sends server 112 a notification of a trigger event. As described with respect to communication module 106 and communication module 120, communication module 124 represents any suitable combination of software, hardware, and/or firmware that enables computing device 114 to communicate across communication cloud 110 to various devices.

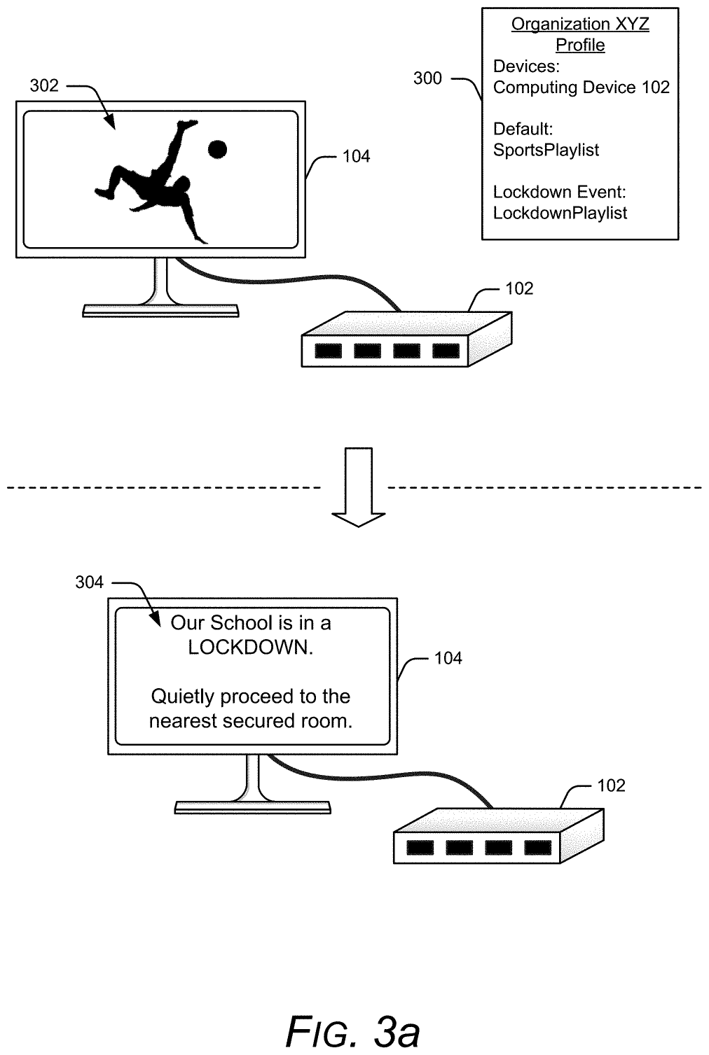

Consider now FIG. 2 that illustrates an example environment 200 in accordance with one or more implementations. In various implementations, the example described with respect to FIG. 2 can be considered a continuation of the example described with respect to FIG. 1.

Environment 200 includes content management device 102, server 112, and communication cloud 110 of FIG. 1, where content management device 102 includes a processing system 202, and one or more computer-readable media 204. Processing system 202 is representative of functionality to perform one or more operations using hardware. Accordingly, the processing system 202 is illustrated as including hardware elements 206 that may be configured as processors, functional blocks, and so forth. This may include implementation in hardware as an application specific integrated circuit or other logic device formed using one or more semiconductors. The hardware elements 206 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 204 is illustrated as including memory/storage 208. The memory/storage 208 represents memory/storage capacity associated with one or more computer-readable media. The memory/storage 208 may include volatile media (such as random access memory (RAM)) and/or nonvolatile media (such as read only memory (ROM), Flash memory, optical disks, magnetic disks, and so forth). The memory/storage 208 may include fixed media (e.g., RAM, ROM, a fixed hard drive, and so on) as well as removable media (e.g., Flash memory, a removable hard drive, an optical disc, and so forth). The computer-readable media 204 may be configured in a variety of other ways as further described below. Here, content management module 108 is illustrated as residing within memory/storage 208, but alternate or additional implementations can implement content management module 108 using combinations of firmware, hardware, and/or software without departing from the scope of the claimed subject matter.

Example environment 200 enables multiple devices to be interconnected through server 112, where server 112 can be local to the multiple devices or remote from the multiple devices. In one or more implementations, server 112 is configured as a cloud of one or more server computers that are connected to the multiple devices through a network, the Internet, or other data communication link. This interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

The cloud 210 includes and/or is representative of a platform 212 for resources 214 and/or organization action module 118 of FIG. 1. The platform 212 abstracts underlying functionality of hardware (e.g., servers) and software resources of the cloud 210. Resources 214 may include applications and/or data that can be utilized while computer processing is executed on servers that are remote from the content management device 102. Accordingly, while organization action module 118 is illustrated here as residing separate from resources 214, alternate or additional implementations of resources 214 include organization action module 118 as a way to provide associated cloud-based services over the Internet and/or through a subscriber network.

The platform 212 may abstract resources and functions to connect content management device 102 with other computing devices. The platform 212 may also serve to abstract scaling of resources to provide a corresponding level of scale to encountered demand for the resources 214 and/or organization action module 118 that are implemented via the platform 212. Accordingly, in an interconnected device embodiment, implementation of functionality described herein may be distributed throughout an organization information distribution system. For example, the functionality may be implemented in part on the content management device 102 as well as via the platform 212 that abstracts the functionality of the cloud 210.

Having described example operating environments in which various aspects of immediate views can be utilized, consider now a discussion of deploying actions across an organization in accordance with one or more implementations.

Deploying Actions Across an Organization

Organizations generally correspond to a collective grouping of individuals and/or devices with a shared goal, whether it is a business goal, a political goal, a governmental goal, a principality, and so forth. For example, an organization can include a business, a school, a family, a city, a state, a country, etc. Depending upon the shared goal and size, organizations oftentimes span multiple rooms, buildings, and/or locations. This can make real-time communications across the organization difficult, especially when various members of the organization are not located at a same place. Consider an example where a company has a factory line with multiple stages, where each stage of the line is positioned at a different location within the factory. Depending upon the size of each stage, scenarios exist in which workers at a first stage of the factory line are unaware of happenings at other stages of the factory line due to distance and objects between the various stages. To compound this issue, factory lines oftentimes involve heavy machinery that produce loud operating noises, making verbal communication difficult. Accordingly, communicating information across the factory line in real-time has challenges.

Techniques described herein provide an organization information distribution system that deploys various actions to different devices included in an organization, such as an immediate view. Alternately or additionally, the organization information distribution system can deploy actions and/or information to non-organization devices. In at least some implementations an organization device connects to a system server associated with the organization information distribution system over a communication network. In response connecting to the system server, various implementations receive a notification from the system server, such as a notification to perform various action(s). For example, the notification can include a command to present default content while the device operates in a default mode. Default content can be presented in a persistent manner and/or for a predetermined time period, such as when the default content is associated with an alarm or event as further described herein. Upon receiving a second notification from the system server, the device can transition out of the default mode and present different content associated with the second notification, such as an immediate view, audio content, video content, and so forth.

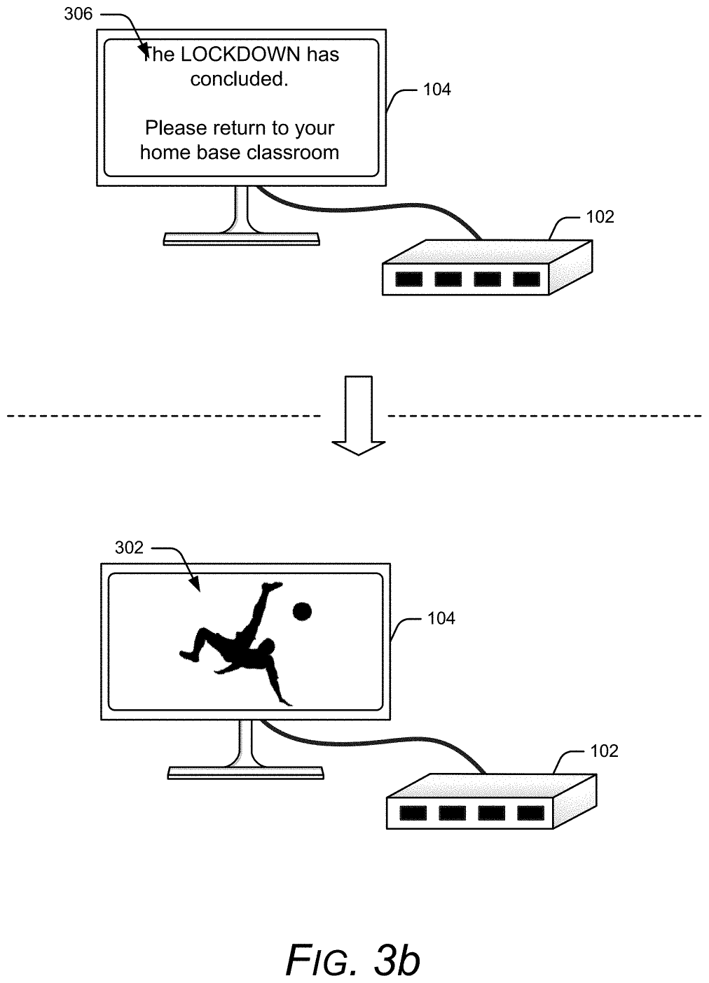

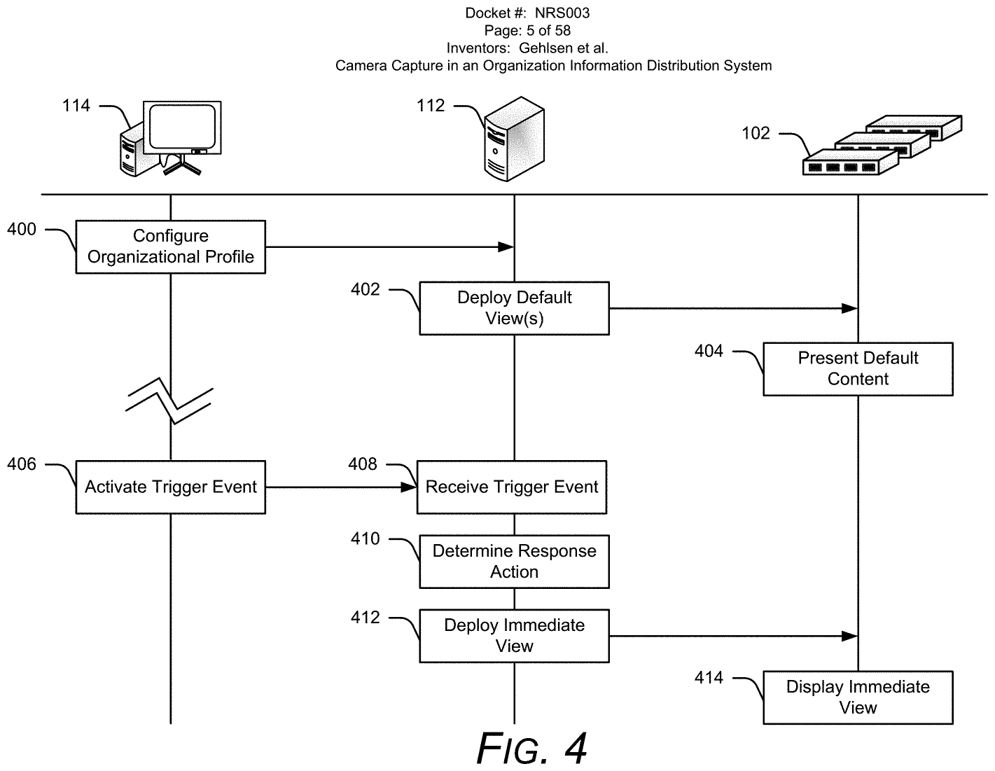

To illustrate, consider now FIGS. 3a and 3b that include an example of deploying an immediate view in accordance with one or more implementations. Collectively, FIGS. 3a-3b illustrate an example progression of events over an arbitrary time period. In this example, the progression over time begins in the upper portion of FIG. 3a then moves to the lower portion of FIG. 3a. The events then proceed to the upper portion of FIG. 3b, followed by the lower portion of FIG. 3b. It is to be appreciated that the progression of events described with respect to FIGS. 3a and 3b are for discussion purposes, and that any other ordering, omission, and/or addition to the events can occur without departing from the scope of the claimed subject matter.

The upper portion of FIG. 3a includes content management device 102 and display device 104 of FIG. 1, where content management device 102 belongs to a set of devices included in an organization profile 300 associated with Organization XYZ. As part of its configuration information, organization profile 300 specifies content to be presented for a default operating mode (e.g., SportsPlaylist), and content to be presented during a Lockdown trigger event (e.g., LockdownPlaylist). As further described herein, the organization profile 300 can reside locally on content management device 102 and/or remotely on a system server. The organization profile can be stored in any suitable manner, such as a metadata file, a text file, parameter settings within an application, and so forth. For discussion purposes, the entries included in organization profile 300 have been simplified. Accordingly, an organization profile can include any type of configuration parameter, device, content, actions, and so forth without departing from the scope of the claimed subject matter.

The default content in this example corresponds to content and/or actions presented by content management device 102 when operating in a default mode where no trigger events have been received. For instance, the default content can be presented after content management device 102 initially powers up. Accordingly, in the upper portion of FIG. 3a, content management device 102 presents default content 302 on display device 104. Default content 302 in this example presents a series of still images of various school activities in a slideshow presentation format that successively alternates between images. However, as further described herein, the presented content can alternately or additionally include a video clip, a web page, an audio clip, a PDF document, and so forth. In various implementations, this can include mixing the types of content presented (e.g., video, followed by a web page, followed by an audio clip, etc.). Various embodiments use organization profile 300 to determine not only what default content to present, but to identify playback parameters based on user preferences, such as playback duration time for each image, transition time between images, repeat cycles, etc.

Moving to the lower portion of FIG. 3a, consider now a scenario in which content management device 102 receives notification of a trigger event, such as a lockdown trigger event, and/or a notification to present an immediate view associated with the trigger event. The trigger event can be achieved in various manners, such as through the user activating a software control at computing device 114 of FIG. 1 (not illustrated here), an invocation device, a detection sensor that detects a particular scenario, and so forth. In response to receiving the notification, content management device 102 presents an immediate view 304 based on what the organization profile indicates. For example, the content management device can receive an instruction and/or commend from a system server (not illustrated here) to display immediate view 304 (where the system server access the organization profile to identify immediate view 304), access the organization profile locally to identify the content to present (e.g., immediate view 304), query/communicate with the system server in response to receiving the notification to determine what content to present, and so forth. Here, content management device 102 presents LockdownPlaylist as immediate view 304 in response to receiving the notification. Similar to that described with respect to default content 302, immediate view 304 can include any type of content, be persistent, and/or be presented for a finite duration.

In the lower portion of FIG. 3a, immediate view 304 renders a text-based message on display device 104, but other implementations can include text-to-speech audio, animations, maps, tracking images (e.g., track where and when objects move), etc. While FIG. 3a demonstrates a single content management device transitioning from a default operating mode to an immediate view, other implementations synchronize multiple content management devices to perform this transition. In turn, this allows an organization to disseminate information in real-time across several locations and improve communication across the organization.

Returning to the factory line example, consider now a scenario in which different content management devices and/or display devices are positioned at the different stages of the factory line. By configuring these devices into a shared organization structure, such as an organization profile, trigger events can be used to synchronize what information is displayed at each stage in the factory line and/or communicate the information in real-time at each stage (e.g., less than 1 second discrepancy between display updates). For instance, an organization profile can be used to associate a first trigger event with a first immediate view that conveys “Shutdown at stage 3 of the factory line, Emergency Response Teams are on site”, associate a second trigger event with a second immediate view that conveys “Lunch break is starting now”, associate a third trigger event with a third immediate view that conveys “Backup at stage 4 of the factory line”, and so forth. The real-time dissemination of the information throughout the factory line improves communication between employees by providing an indication of what is occurring and/or where, thus improving overall operations of factory line itself.

Trigger events can be handled by the organization information distribution system as events and/or alarms, where events are finite in duration and correspond to response actions that occur for a finite duration. Conversely, alarms have a persistent and/or indefinite duration and correspond to response actions that have a state: triggered or cleared. Accordingly, a trigger event can signify the occurrence of an event, the occurrence of an alarm, and/or a combination of the two. Some trigger events can correspond to multiple events, multiple alarms, and/or a combination of multiple events and alarms.

To illustrate, some implementations identify when a locked door has opened, process this occurrence as an event, and initiate a response action that deploys an immediate view to various devices of the organization. Since events are processed by the organization information distribution system as having a finite duration, the response action of displaying an immediate view across the organization occurs for a finite duration (e.g., a predetermined time duration). When the predetermined time expires (such as by a timer expiring), the immediate view and/or corresponding event is removed or considered to be complete. It is to be appreciated that, while the described response action corresponds to an immediate view, the system can deploy multiple different types of actions in response to an event.

If the occurrence of the door opening is processed as an alarm, the organization information distribution system transitions a corresponding door alarm associated with the trigger event from a cleared state to a triggered state and deploys the immediate view for an indefinite amount of time. In other words, the alarm remains in a persistent triggered state until cleared. Accordingly, until notified otherwise, the organization information distribution system retains the triggered state of the door alarm and the immediate view. However, in response to receiving a notification to clear the triggered state of the door alarm, such as through a separate trigger event, the immediate view is removed from the various organization devices and the alarm state transitions to a cleared state. Accordingly, various implementations provide an indication of when an alarm associated with a trigger event has transitioned from a triggered state to a cleared state.

Continuing on with the example presented with respect to FIGS. 3a and 3b, consider now the upper portion of FIG. 3b that illustrates content management device 102 driving display device 104 with immediate view 306. In various implementations, the organization information distribution system processes the lockdown trigger event as corresponding to an alarm which is transitioned into a triggered state. In response to receiving a second trigger event at some arbitrary point in time later, the content information distribution system transitions the alarm from a triggered state to a cleared stated. The transition to a cleared state can be invoked in a manner similar to those described with respect to a trigger event, examples of which are provided herein. Since immediate view 306 corresponds to the end of an alarm, some implementations display immediate view 306 for a predetermined time period, then revert to default content 302 as illustrated in the lower portion of FIG. 3b. The predetermined time period can be configured in any suitable manner, such as through a default time period and/or a user-defined time period. Alternately or additionally, the transition back to default content 302 can be driven by content management device 102 receiving a trigger event dedicated to transitioning to a default operating mode.

A content management device communicates with a system server to determine what content to present and when. In some implementations, the content management device exchanges messages with the system server to make these determinations. Alternately or additionally, the content management device communicates with the system server by accessing cloud-based services provided by the system server. Accordingly, various techniques described herein enable the organization information distribution to deploy actions across an organization. For example, the system server can receive a notification that a trigger event has occurred from a device associated with the organization distribution system and, in response to receiving the notification, analyze an organization profile to determine what actions to deploy across the organization system.

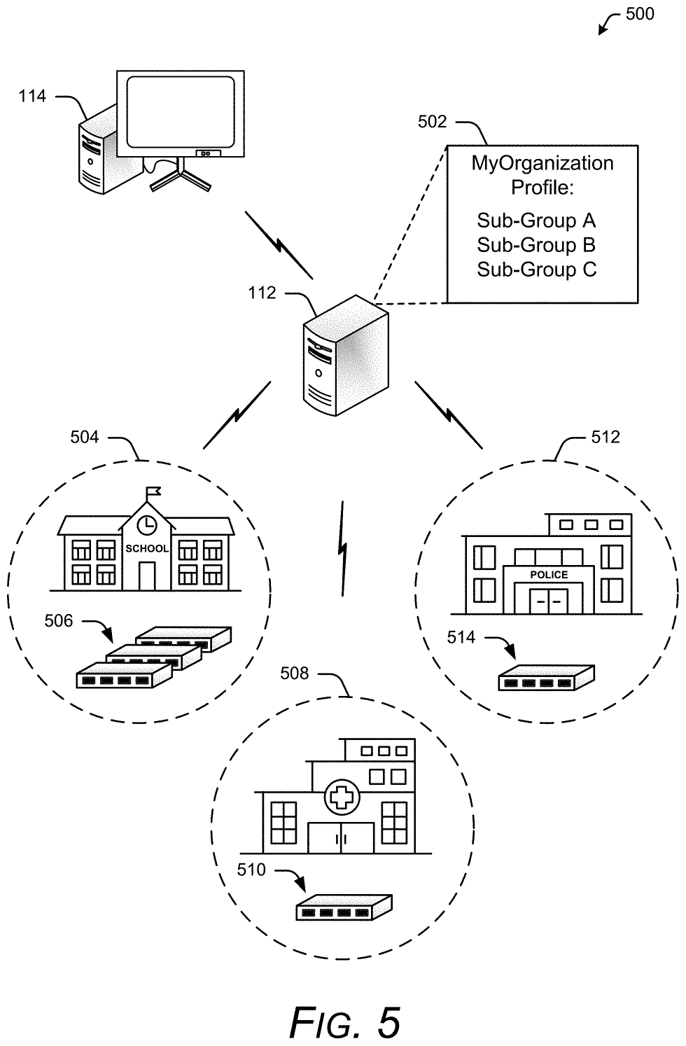

To illustrate, consider now FIG. 4 that demonstrates example communication exchanges between devices in accordance with one or more embodiments. These communication exchanges can be messages and/or software invocation steps, such as invocation steps performed between devices based on using cloud-based services. In various implementations, the example described with respect to FIG. 4 can be considered a continuation of one or more examples described with respect to FIGS. 1-3b. FIG. 4 includes computing device 114, server 112, and multiple instances of content management device 102 of FIG. 1, where the multiple instances of the content management device represent devices positioned at different locations. The respective vertical lines underneath each device corresponds to actions performed at that device. Thus, the vertical line beneath computing device 114 corresponds to actions performed by user devices in an organization information distribution system, the vertical line beneath server 112 corresponds to actions performed by servers in the organization information distribution system, and the vertical line beneath content management device 102 corresponds to actions performed by each instance of a content management device in the organization information distribution system. In various implementations, the actions performed at server 112 can be associated with cloud-based and/or platform functionality provided by server 112 as further described herein. The horizontal action lines between the different devices represents communication across a network between the connected devices, such as through transmitting and receiving messages and/or the invocation of software functionality across devices using cloud-based services.

At 400, computing device 114 configures an organization profile by logging on to server 112. While illustrated as a single step, it is to be appreciated that this can entail multiple messages, including bi-directional messages between computing device 114 and server 112, as part of the configuration process. For instance, a user can access a web page hosted by server 112 to add and remove devices to a respective organization, upload content to be used in an immediate view, add addresses to send communications to, assign actions to various trigger events, configure network-based pages that include content, and so forth. Alternately or additionally, the user can access server 112 using a stand-alone application. While illustrated in FIG. 4 as a desktop personal computer, computing device 114 can be any other suitable type of computing device, examples of which are provided herein.

At 402, server 112 deploys default view(s) to the multiple instances of content management device 102. This can be initiated by the organization profile being updated at 400 and/or in response to server 112 identifying a content management device logging onto and/or communicating with server 112. The phrase “default view” generally indicates any suitable type of content, playlist, and so forth, that can be presented by content management device 102 when operating in a default mode, such as an immediate view. Deploying the default view can include downloading the content to content management device 102 and/or providing the content management device with an address to the content, such as a web page or a file located on a network. In some scenarios, server 112 sends content management device 102 an organization profile to communicate the current configuration parameters (e.g., which views and/or actions correspond to what trigger events). While illustrated as a single step, it is to be appreciated that deploying the default view at 402 can entail multiple messages, including bi-directional messages between server 112 and content management device 102. As one non-limiting example, server 112 can first download content (or addresses) used by content management device 102, receive a confirmation from content management device 102 that the content was downloaded successfully, and then send a “default view” message or command to content management device 102 that initiates the presentation of the default content.

At 404, the multiple instances of content management device 102 present the default content. In some implementations, each instance of content management device 102 presents the same default content and/or the same immediate view. In other words, server 112 configures each instance of the content management devices to present the same default content. Other implementations partition the multiple instances of content management device 102 into sub-groups of devices and direct each sub-group to display different default content from other sub-groups.

At an arbitrary point in time later, computing device 114 activates a trigger event at 406. While illustrated here as originating from a computing device that configured the corresponding organization profile, other devices besides the configuring device can generate the trigger event. Activating a trigger event can also entail multiple messages, including bi-directional messages between server 112 and computing device 114. However, from a user's perspective, these multiple messages are obscured such that the activation process can be invoked via a single user-interaction with computing device 114. For instance, some implementations configure computing device 114 as a smart phone that includes a stand-alone application. In such a scenario, a user invokes the stand-alone application and uses a single user-interaction to actuate a control button associated with the desired trigger event. As another example, the user can apply a single user-interaction to actuate a control button displayed in a user interface of the smart phone without invoking an application. Other implementations invoke a trigger event through the use of an invocation device.

At 408, server 112 receives a notification of the trigger event. While illustrated as a single step, receiving the notification can entail multiple messages, including bi-directional messages between server 112 and computing device 114. Some implementations include username and/or password information, location information, a subscriber identification number, and so forth, as part of the notification to identify what device originated the trigger event and/or what organization the trigger event is associated with. In turn, this information can be used to determine what response action to deploy at 410. As one example, server 112 analyzes the organization profile using the received information to identify how to respond and/or what action(s) to deploy. Accordingly, at 412, server 112 has determined that the trigger event corresponds to an immediate view response action and deploys an immediate view to some or all of the multiple instances of content management device 102. For instance, the server can send a message, indication, command, and/or notification to each instance of the multiple content management devices that either indicates what trigger event occurred and/or indicates what action to perform. Alternately or additionally the server can send content, or an address that points to the content, to the content management devices. In some implementations, each instance of the multiple content management devices in the organization is notified, while in other implementations, sub-groups of devices within the organization are notified. In response to the server determining that the trigger event is associated with an alarm, the immediate view can be deployed as a persistent immediate view. Alternately or additionally, in response to the server determining that the trigger event is associated with an event, the immediate view can be deployed for a finite duration.

At 414, at least one instance of the multiple content management devices displays an immediate view. To illustrate, some implementations of content management device 102 locally access content stored in memory and present the content in response to receiving the notification and/or command from server 112. Alternately or additionally, various implementations of content management device 102 receive content from server 112 with the notification and present the newly received content as an immediate view. As yet another example, various implementations access remote content based on an address (e.g., a web page), and present the remote content. As further described herein, different instances of content management device 102 can display the same immediate view, or different immediate views from one another, based on how the organization profile partitions the devices.

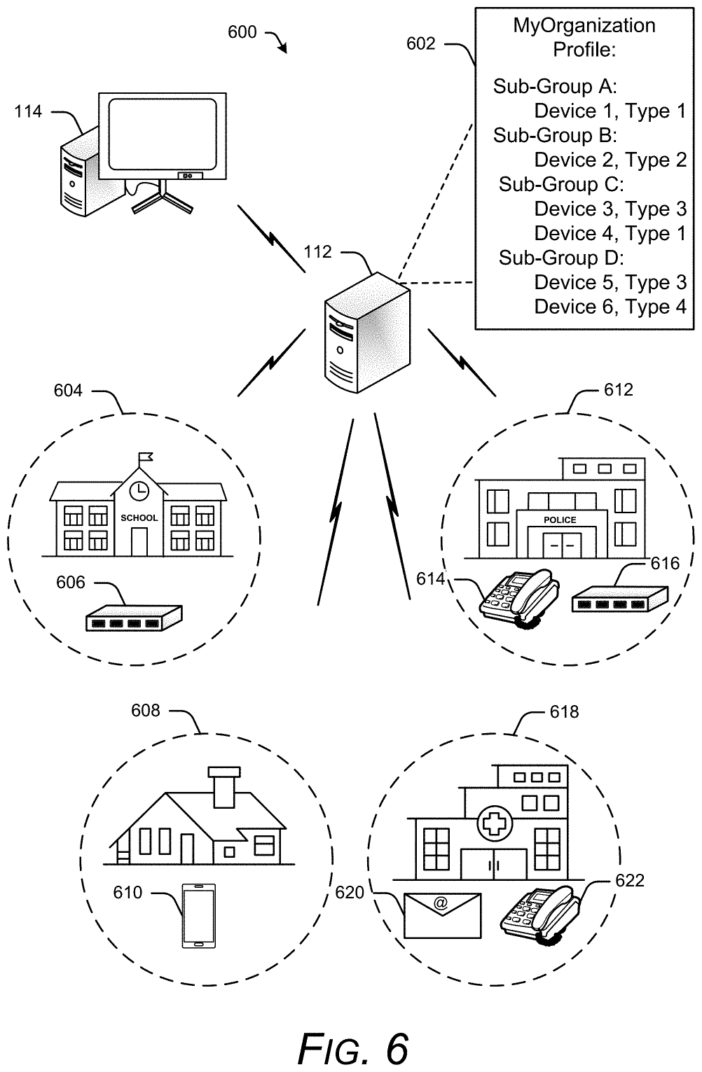

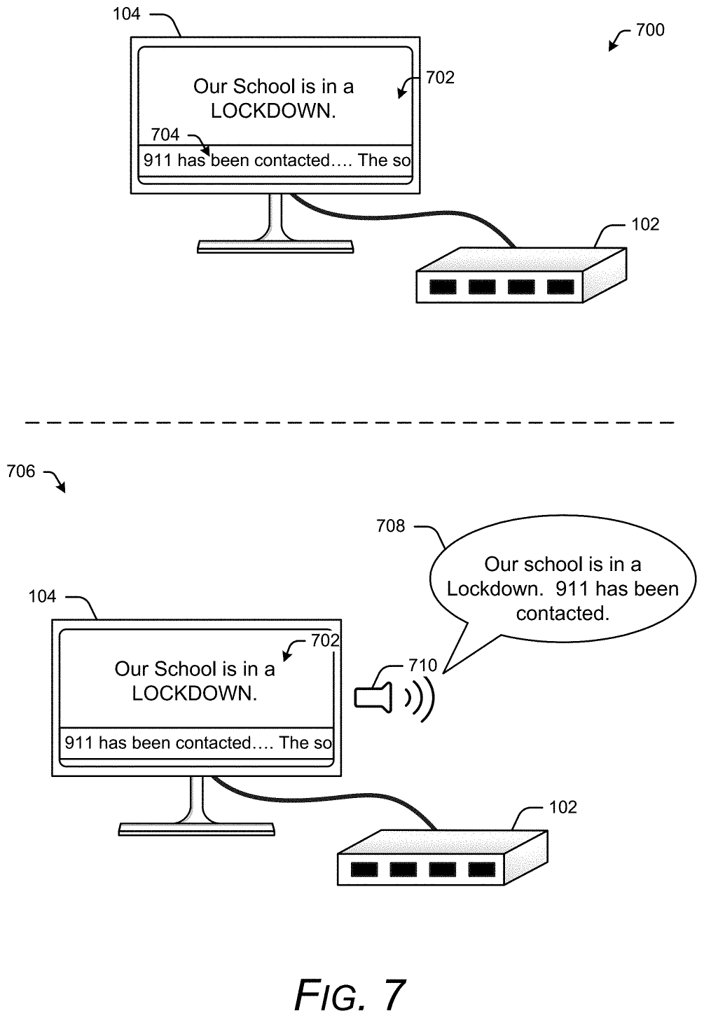

To demonstrate, consider now FIG. 5, which illustrates environment 500 in which an organization information distribution system deploys immediate views across multiple locations. In various implementations, FIG. 5 represents a continuation of one or more examples described with respect to FIGS. 1-4. Environment 500 includes computing device 114 and server 112 of FIG. 1, where computing device 114 provides a user with access to server 112 via computing device 114.

Server 112 includes organization profile 502 that is associated with a subscriber to the organization information distribution system. For instance, the subscriber can be a company, an individual of the company, a government agency, and so forth. While illustrated here as residing on server 112, alternate or additional implementations store organization profile 402 on a content management device and/or use a cloud-based system to distribute the information stored within the profile. Information included in the organization profile configures the organization information distribution system according to user-preferences.

Based on the information included in organization profile 502, the organization devices of the associated organization have been partitioned into three sub-groups: Sub-Group A, Sub-Group B, and Sub-Group C. The organization devices can be partitioned in any suitable manner, such as by location, by associated owner, by device type, and so forth. Accordingly, organization devices can be partitioned into any number of sub-groups, where the sub-groups can include any number and/or type of device. In this example, a subscriber to the system accesses server 112, and subsequently organization profile 502, configures the profile by way of computing device 114 to create the sub-groups and/or select devices for each respective sub-group.

Environment 500 includes an example of sub-groups that have been partitioned by location. Location 504 corresponds to a school that includes multiple content management devices, labeled here as sub-group 506. Location 508 corresponds to sub-group 510 that corresponds to a single content management device located at a hospital, while location 512 corresponds to sub-group 514 that also includes a single content management device located at a police station. Accordingly, in environment 500, a subscriber has determined to create various sub-groups based on location. However, other factors can be utilized to create and/or organize devices included in an organization.

As further described herein, immediate views can be deployed to content management devices based on an organization profile, where the content management devices can reside at different locations. To demonstrate, consider a scenario in which a school district places each content management device of sub-group 506 in a respective classroom of a school. The school can include each of these content management devices in the organization profile even though the devices are physically located in different rooms. However, the school has also determined to add the content management device at location 508 into the organization profile, as well as the content management device at location 512. When personnel of the school desire to deploy an immediate view to the various devices, a trigger event can be invoked that communicates over a network to server 112. In turn, server 112 deploys an immediate view to the various devices of the organization according to the organization profile. For instance, personnel can access a software control and/or invocation device corresponding to the immediate view that sends a trigger event and/or notification of a trigger event to server 112. Server 112 then sends a notification, message, and/or command to sub-group 506, sub-group 510, and/or sub-group 514 based on the organization profile to invoke immediate view 304 of FIG. 3 using a single user-interaction.

Alternately or additionally, the organization information distribution system can direct different immediate views to different sub-groups. Consider again the scenario in which personnel at a school initiate a trigger event. Organization profile 502 can indicate to send a first immediate view directed to sub-group 506 located at the school, a second immediate view to sub-group 510 located at the hospital, and a third immediate view directed to sub-group 514 located at the police station. Accordingly, a subscriber can configure a single trigger event to map to different types of immediate views and/or actions to different devices. Some implementations alternately or additionally adapt an immediate view to different types of devices.

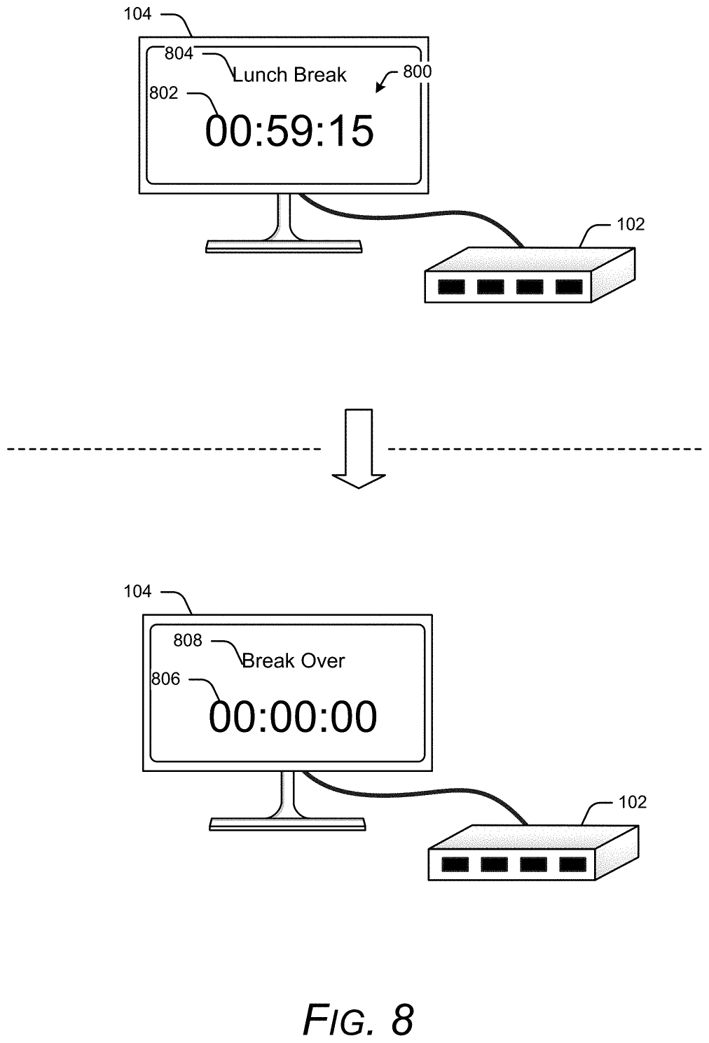

Consider now FIG. 6 that illustrates an environment 600 where an organization information distribution system deploys different immediate views and/or actions across multiple locations and devices. In various implementations, FIG. 6 represents a continuation of one or more examples described with respect to FIGS. 1-5. Environment 600 includes computing device 114 and server 112 of FIG. 1, where computing device 114 represents any suitable type of device that provides a user with access to server 112. Environment 600 also includes organization profile 602.

Organization profile 602 includes user-defined information, such as user preferences on how the organization devices and/or non-organization devices are partitioned into sub-groups. Here, the various devices range over multiple types of devices: Type 1, Type 2, Type 3, and Type 4 that correspond to a content management device type, mobile phone, telephone, and e-mail device respectively. While described in the context of a device, alternate implementations include an e-mail account and/or address as a virtual device since the e-mail account can receive information at multiple device types. Accordingly, organization profile 602 includes device type information in addition to partitioning information. In this example, Sub-Group A corresponds to the device at location 604: content management device 606. While not illustrated here, organization profile 602 can also include an action assignment to Sub-Group A, such as what immediate view is deployed in response to a trigger event. Some implementations format the immediate view to the type of receiving device.

Moving on, Sub-Group B corresponds to the device at location 608: mobile phone 610, while Sub-Group C corresponds to the devices at location 612: telephone device 614 and content management device 616. Organization profile 602 also includes Sub-Group D, which corresponds to devices at location 618: e-mail device 620 and telephone device 622. To indicate the different device types, organization profile 602 includes and/or assigns device type identifications to the registered organization devices. Thus, telephone device 614 in Sub-Group C is assigned a device type of Device 3, e-mail device 620 of Sub-Group D is assigned a device type of Type 4, etc. By identifying a device type for each respective organization device, various implementations of the organization information distribution system can format data being deployed across the organization according to device type. Some implementations can alternately or additionally send notifications to non-organization devices, such as third-party vendors that provide content distribution to various devices. As an example, server 112 can contact the third-party vendor with e-mail content that the third-party vendor then distributes according to a predetermined list. As yet another example, various implementations initiate calls and/or deploy an audio message to a public safety answering point (PSAP) to convey information about a particular trigger event.

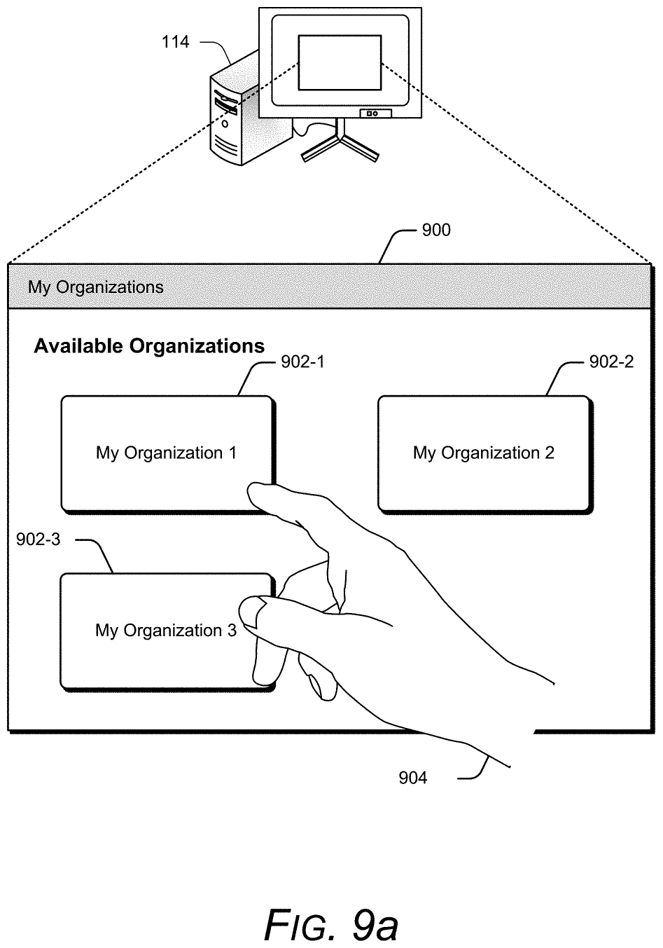

Immediate views can also be updated in real-time with supplemental information. To demonstrate, now consider FIG. 7 that includes various examples of alternate or additional features that can be added to immediate views. In various implementations, the examples described with respect to FIG. 7 represent continuations of one or more examples described with respect to FIGS. 1-6. The upper portion of FIG. 7 illustrates an environment 700 that includes content management device 102 and display device 104 of FIG. 1. In environment 700, content management device 102 presents immediate view 702 on the display device. The presentation of immediate view 702 can be initiated in any suitable manner using various techniques as described herein. In addition to, or as part of, immediate view 702, the displayed content includes marquee 704 that scrolls across the bottom of the display from right to left with additional and/or supplemental content. The positioning and direction of movement associated with the marquee can vary from implementation to implementation, such as at the top of a display, at a right-hand side, a left-hand side, moving from top-to-bottom, left-to-right, and so forth. Environment 700 illustrates marquee 704 including text-based content as the supplemental content, where the supplemental content corresponding to updates that are added and/or displayed in real-time, but other types of additional content can be displayed as well.

To demonstrate how supplemental content can be added to an immediate view, consider again the scenario in which school personnel has initiated display of an immediate view, such as immediate view 702. After deploying the immediate view, various implementations expose a control and/or text-entry field, such as through a corresponding user interface of a software application, such that the school personnel can enter content into the control and/or field that is then forwarded to the system server. In turn, the entered content is subsequently propagated by the system server to marquee 704. Any type of supplemental content can be added, such as audio files and/or content, text-based content, video content, files, addresses pointing to content, and so forth. As real-time updates are received, the organization information distribution system can update marquee 704 to replace existing content in the marquee and/or amend the updated content to the existing marquee content.

Moving to the lower portion of FIG. 7, environment 706 includes content management device 102 and display device 104 of FIG. 1, where content management device 102 again drives display device to display immediate view 702 and marquee 704. Various implementations include text-to-speech capabilities that convert text-based content into audible content. Accordingly, audible output 708 corresponds to synthesized speech that has been generated from text content included in marquee 704 and immediate view 702. Here, audible output 708 is projected outwardly via speaker 710, which can be an integrated speaker of content management device 102, an integrated speaker of display device 104, or an external speaker connected to an audio port of content management device 102 and/or display device 104. Further, while environment 706 generates audible output 708 by applying text-to-speech capabilities to the marquee content and immediate view 702, text-to-speech conversions can be applied to any other source of text-based content.

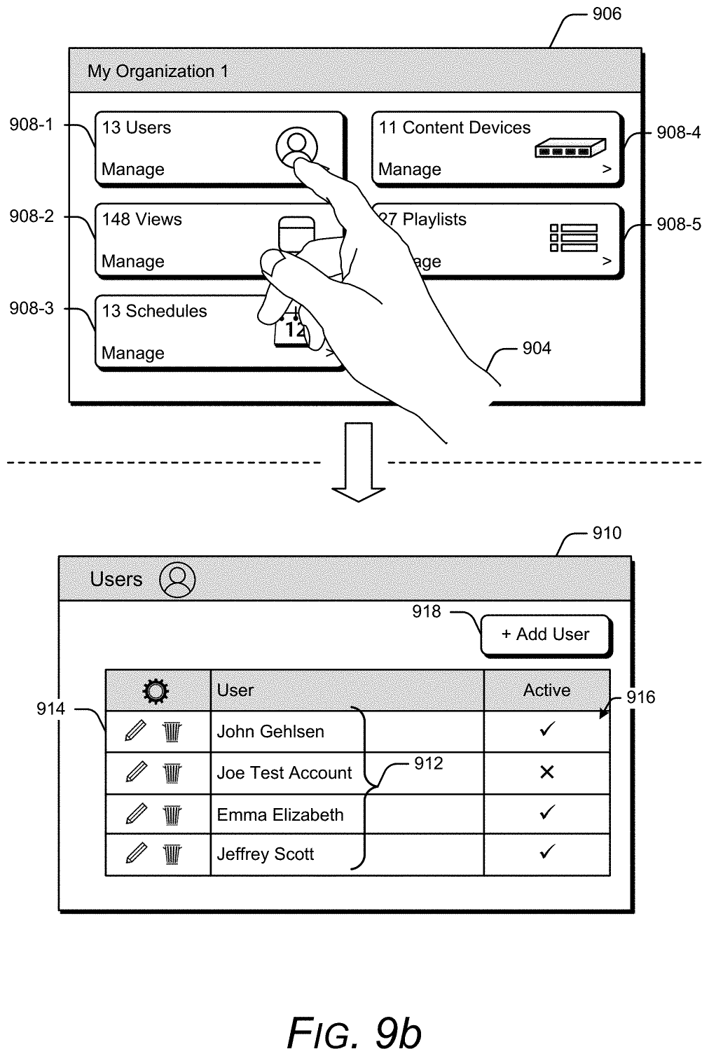

Now consider FIG. 8 that illustrates an example immediate view in accordance with one or more implementations. In various implementations, FIG. 8 represents a continuation of one or more examples described with respect to FIGS. 1-7. The upper portion of FIG. 8 includes content management device 102 and display device 104 of FIG. 1. In this example, the immediate view 800 includes a countdown timer 802 with a display format corresponding to HH:MM: SS (hours, minutes, and seconds respectively) and a timer label 804. Various implementations include timing mechanisms within an immediate view, such as a countdown timer that counts down an arbitrary amount of time to zero, an alarm clock that deploys an audible and/or visual alert at a predetermined time, a real-time clock display that displays a current time, a stopwatch that displays an amount of elapsed time, and so forth. This can include still images of the timer, or a running timer and/or clock that visually updates in fixed increments. Various parameters of the timing mechanism can be user-defined, such as displaying a digital clock, displaying an analog clock, a duration for a countdown timer, update intervals, and so forth. In the upper portion of FIG. 8, the countdown timer updates in real-time using one second intervals. This continues until the timer expires, as illustrated in the lower portion of FIG. 8 where the immediate view displays expired timer 806 (also formatted as HH:MM:SS), and label 808 that can include directions corresponding to the expired timer. For example, label 808 can include an action to be performed at the expiration of a timer, such as “Break over, please return to your work station”. Alternately or additionally, the expiration of the timer can invoke a trigger event that is sent to the system server to deploy an action and/or immediate view corresponding to the expiration of the timer. While FIG. 8 illustrates an example that updates an immediate view in response to the countdown timer expiring, it is to be appreciated that alternate or additional implementations deploy actions at other predetermined points in time during the execution of the countdown timer, such as at the start of the timer, at a predetermined intermediate point, at one or more predetermined intervals, at a predetermined amount of time remaining for the timer, and so forth. For example, some implementations deploy audio alerts to signify the expiration of the timer, the start of the timer, a remaining time duration of the countdown timer, and so forth. The audio alert can alternately or additionally include text-to-speech output, an audio clip, etc.

Accordingly, various implementations enable user customization of how an organization information distribution system responds to trigger events (e.g., timing mechanism, immediate view content, sub-grouping of devices, etc.). In turn, these customizations can be stored within the system as organization parameters, organization profiles, etc. To illustrate, as a subscriber joins the organization information distribution system, some implementations generate an organization profile associated with the subscriber to capture configuration parameters that describe organization-specific response actions to various trigger events. The organization profile can be generated at a system server, via a user computing device, via a content management device, or any other suitable device.

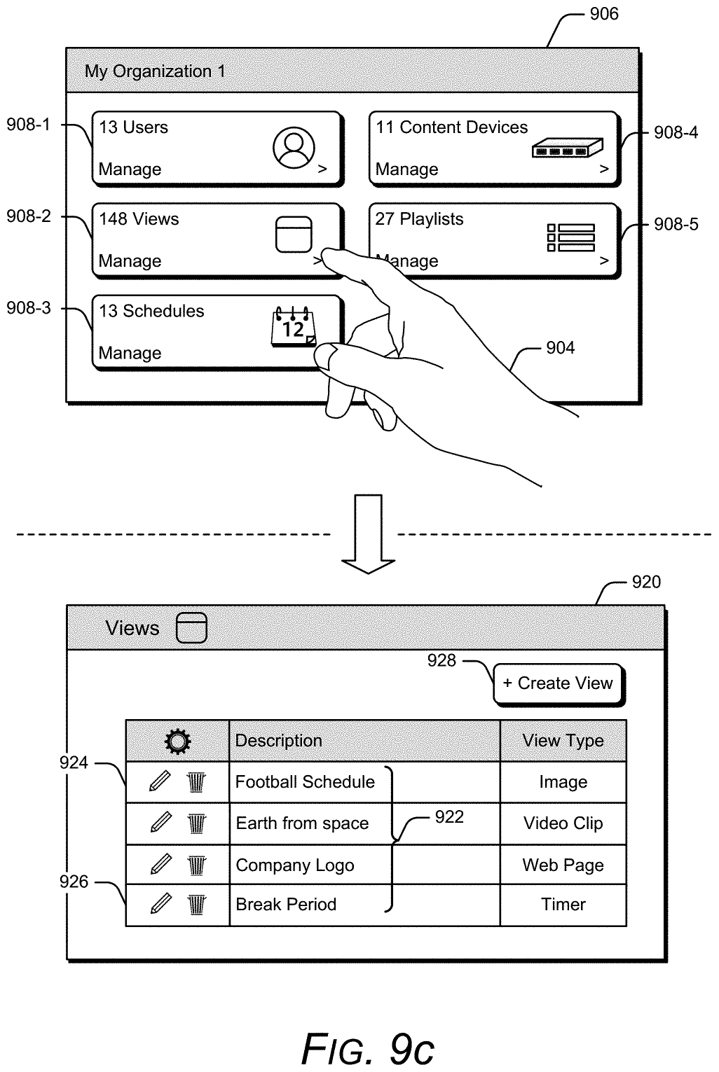

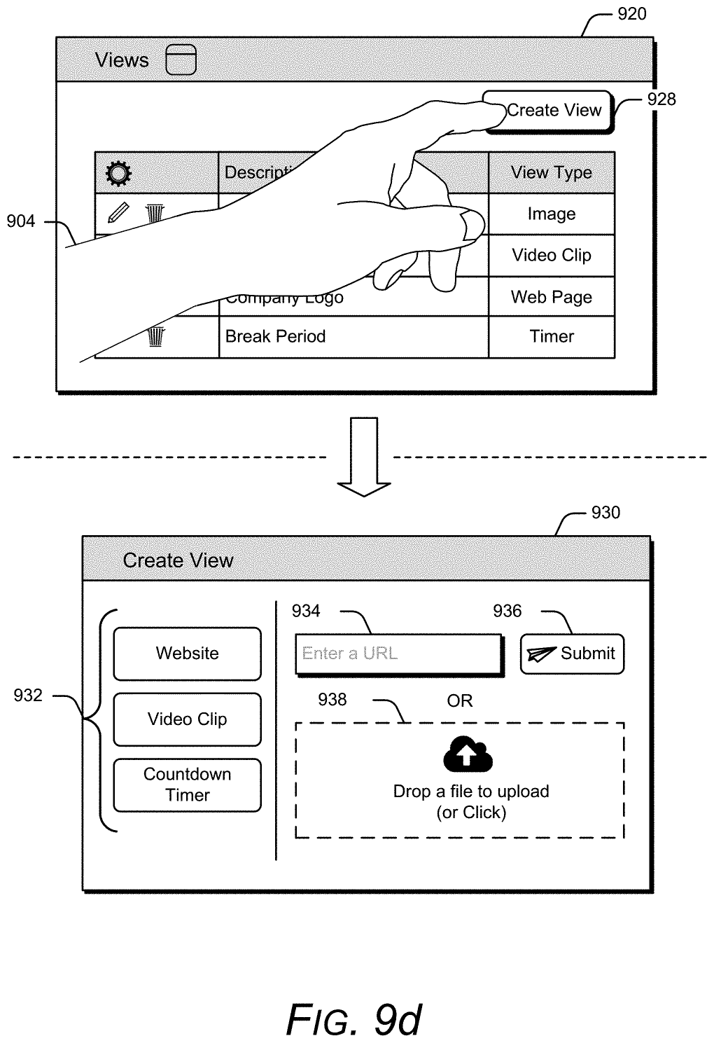

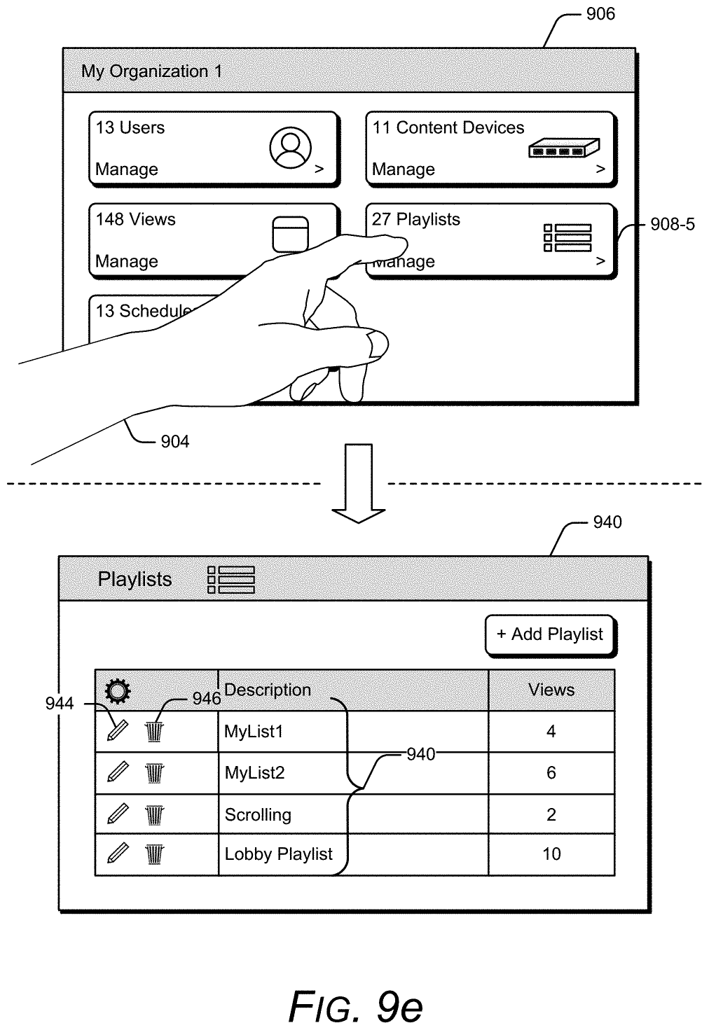

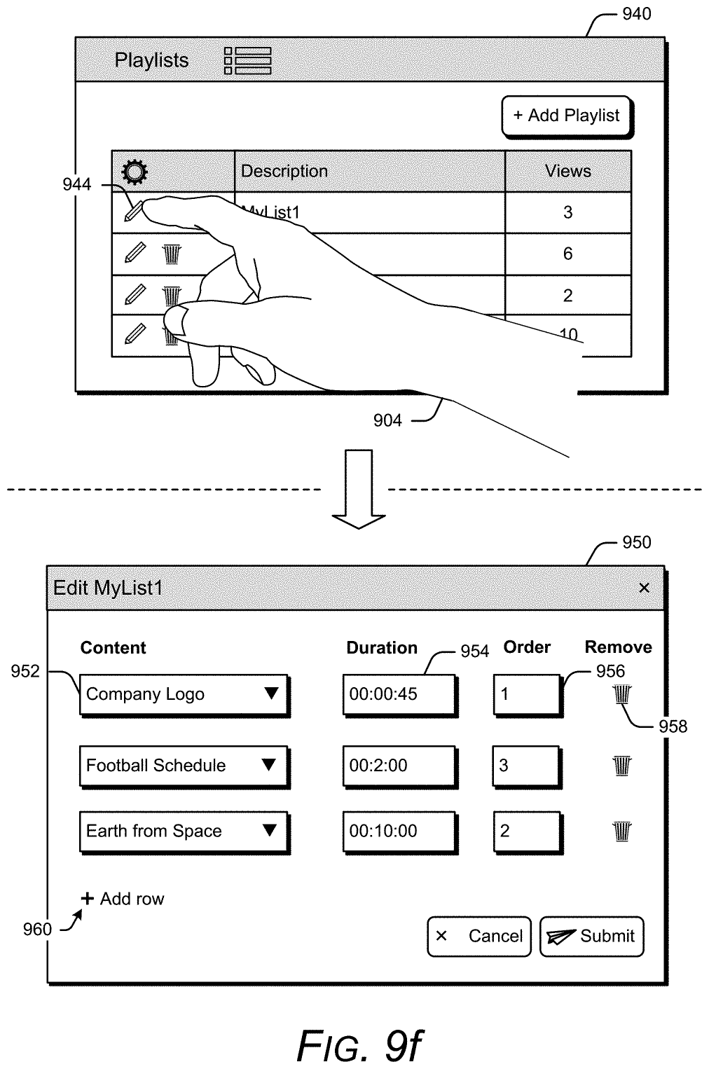

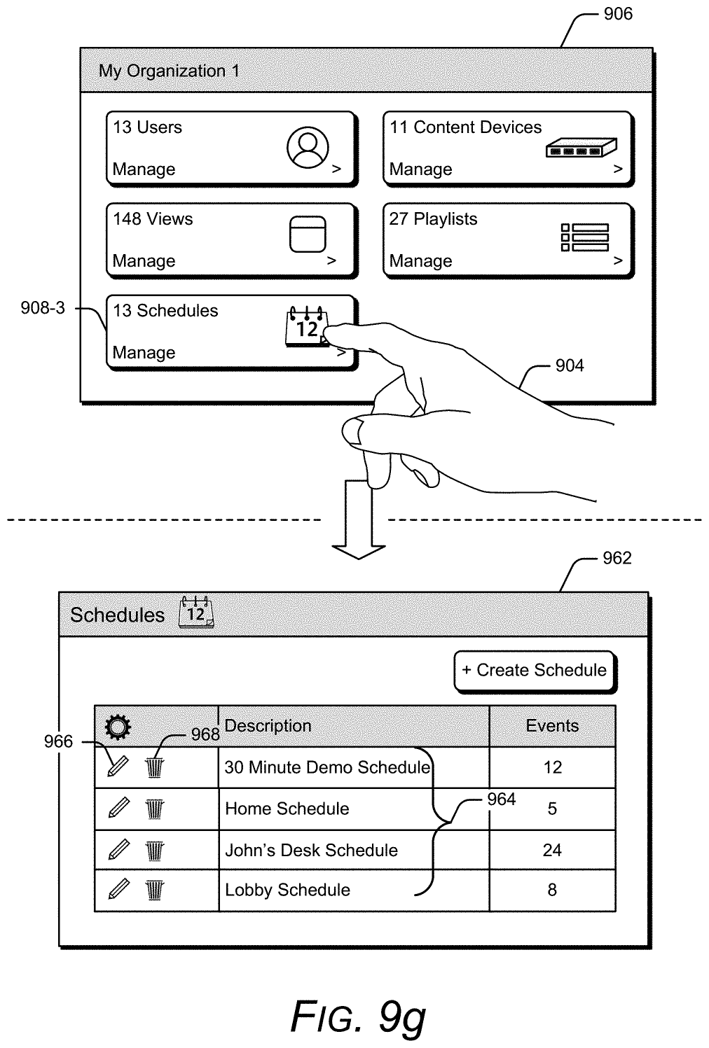

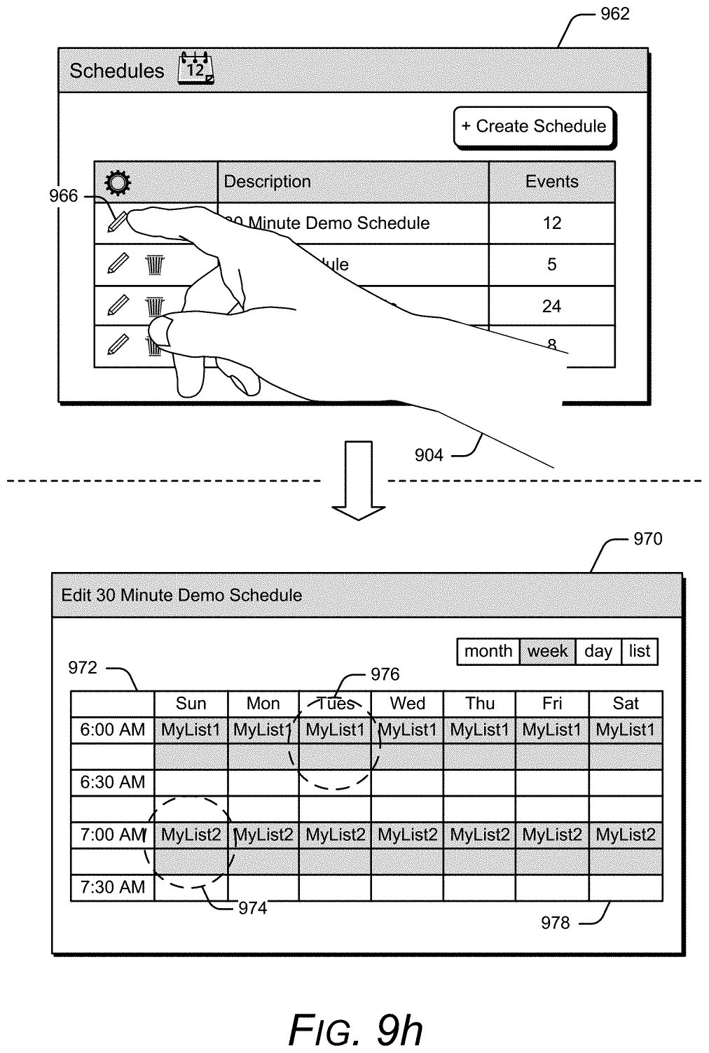

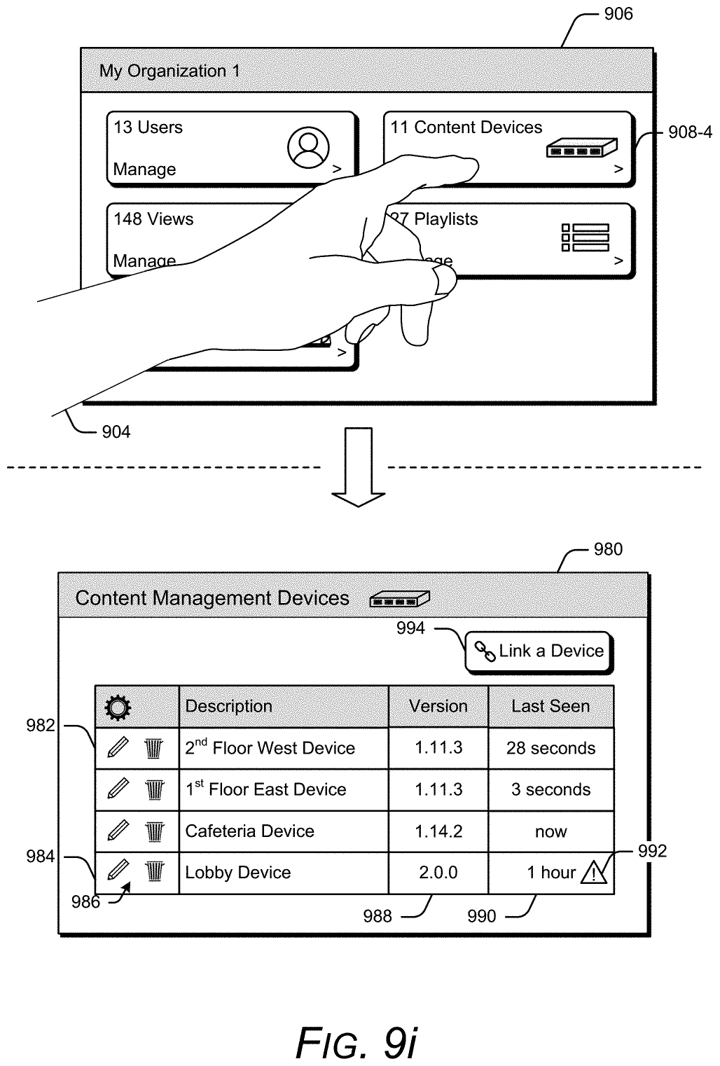

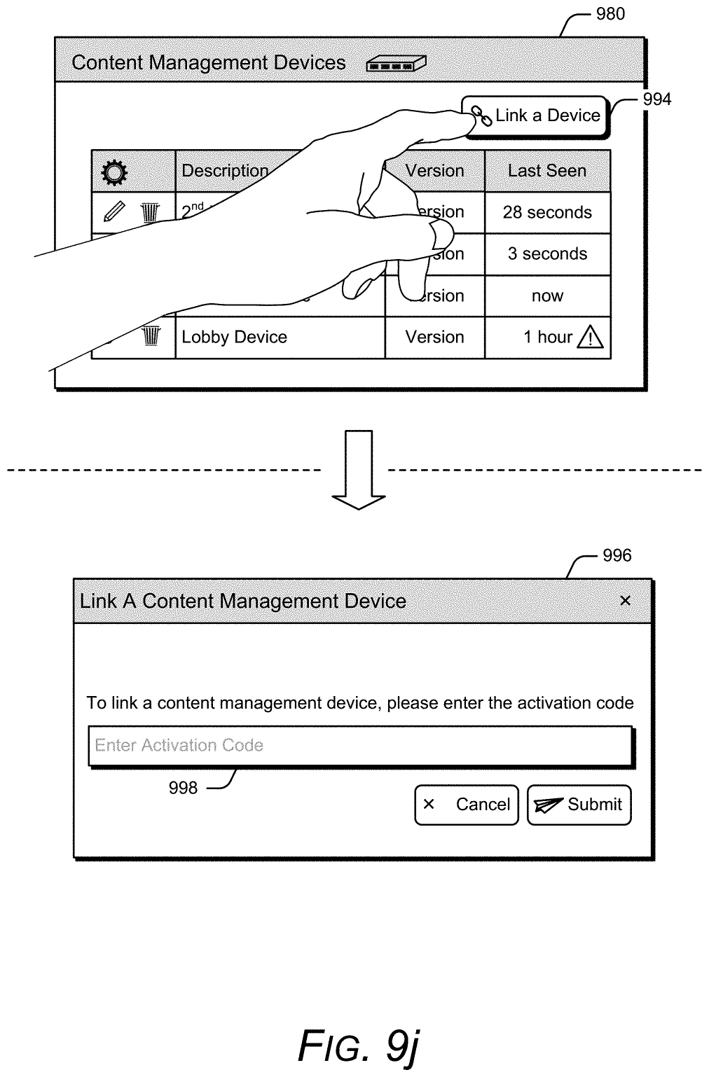

To further demonstrate, consider now FIGS. 9a-j that illustrate example user interfaces in accordance with one or more implementations. In various implementations, FIGS. 9a-j represent a continuation of one or more examples described with respect to FIGS. 1-8. Some of the examples illustrate a progression of events over an arbitrary point in time, where for a respective Figure the progression over time begins in the upper portion of the Figure and then moves to the lower portion. It is to be appreciated that any progression of events described herein are for discussion purposes, and that any other ordering, omission, and/or addition to the events can occur without departing from the scope of the claimed subject matter.

FIG. 9a illustrates an example configuration of user interface 900 that can be used to provide user-defined customizations to an organization profile. While computing device 114 of FIG. 1 is illustrated as rendering user interface 900, other computing devices can be used without departing from the scope of the claimed subject matter. Further, the content and/or options discussed with respect to user interface 900 are not intended to be limiting such that that the user interface can alternately or additionally expose other suitable type of content, options, and/or configuration parameters.

User interface 900 includes a collection of organizations associated with a particular account and/or user profile. As further described herein, various implementations provide a user with the ability to create multiple groupings of various devices that are recipients of immediate views, playlists, SMS test messaging, email, audio, etc. Alternately or additionally, the user can include invocation devices within the groupings as devices that generate trigger events. In various implementations, the user provides authentication information to gain access to user interface 900, such as a username/login name and password. This can be achieved through the use of a web browser or a standalone application executing on computing device 114 that presents user-editable fields associated with collecting the authentication information. In turn, the collected authentication information is forwarded to a system server for validation. In response to validating the authentication information, computing device 114 presents user interface 900.

User interface 900 includes three selectable controls in the form of a software button: control 902-1, control 902-2, and control 902-3. Here, each control corresponds to a respective grouping of content management devices, but it is to be appreciated that these respective groupings can include any combination of content management devices, mobile devices, landline telephone devices, email accounts, and/or invocation devices as further described herein. In various implementations, each respective grouping corresponds to portions or all of a respective organization profile, such as organization profile 300 of FIG. 3a, organization profile 502 of FIG. 5, and/or organization profile 602 of FIG. 6. In FIG. 9a, user 904 actuates control 902-1 that corresponds to “My Organization 1”.

Moving to the upper portion of FIG. 9b, and in response to the actuation of control 902-1, computing device 114 renders user interface 906. Here, user interface 906 includes various controls that provide the ability to configure what content is deployed to various devices in response to a trigger event. User interface 906 also provides the ability to identify what users have access to modify configuration settings of a corresponding organization profile. Accordingly, control 908-1 corresponds to user configuration such that users can be added and/or removed from access to the respective organization profile (e.g., “My Organization”), while control 908-2 corresponds to view content configuration. Here, view content relates to a particular instance of content added to the respective organization profile. Thus, the actuation of control 908-2 exposes the ability to add and remove content that can be incorporated into a playlist.

Control 908-3 corresponds to scheduling when various playlists are deployed to the organization devices, while control 908-4 corresponds to managing what content management devices are included into, and/or removed from, the respective organization profile. Finally, control 908-5 corresponds to creating playlists as well as configuring what content is included in each respective playlist. Accordingly, controls 908-1 through 908-5 provide a user with access to customize and/or modify playback setting parameters associated with the respective organization profile. In the upper portion of FIG. 9b, user 904 actuates control 908-1 using a touch-input gesture, but alternate or additional input mechanisms can be utilized, such as mouse input, keyboard input, audible input, etc.

Moving to the lower portion of FIG. 9b, and in response to the actuation of control 908-1, various implementations render user interface 910 that includes a list 912 of users that have configuration access to the respective organization in a table format. User interface 910 also displays controls that allows for the editing and/or removal of each respective user. For example, row 914 corresponds to the respective user “John Gehlsen” and includes editing controls associated with modifying the respective user information, such as name, address information, email information, company information, mobile and/or telephone information. Row 914 also includes control associated with removing the respective user from list 912 and/or modifying a level of access give to the respective user. In various implementations, each row displays status information for the respective user. For instance, status 916 corresponds to row 914 and indicates that the respective user has been activated in the system. User interface 910 also includes the ability to add a new user to list 912 through control 918 such that newly added users are granted the ability to modify playback configuration settings of the respective organization profile.

Returning to user interface 906, consider now FIG. 9c that illustrates an example of adding view content in accordance with one or more implementations. The upper portion includes user interface 906 of FIG. 9b where user 904 actuates control 908-2 using a touch-input gesture. In response to this user input, various implementations expose various parameters settings that can be used to add, remove, and/or edit content associated with the respective view.

Moving to the lower portion of FIG. 9c, and in response to the actuation of control 908-2, various implementations render user interface 920 that displays the current view content included in the organization profile. Here, user interface 902 displays a list 922 of the currently entered content in a table format, where each row of the table corresponds to a respective view and/or the respective view content. For instance, row 924 corresponds to the respective view content described as “Football Schedule”, has image content, and can be edited and/or deleted. As another example, row 926 corresponds to the respective view content described as “Break Period”, has timer content, and can also be edited and/or deleted. Thus, view content can include any suitable type of content, such as images, video clips, web pages, timers, audio, text-based content, and so forth. In turn, respective instances of view content can be combined in a playlist such that the combination is deployed to a same organization device as further described herein. To add new view content, user interface 920 includes control 928.

Moving to the upper portion of FIG. 9d, user 904 activates control 928 using a touch-input gesture. In response to the actuation of control 928, various implementations expose controls associated with uploading and/or entering new content into the organization profile. An example user interface 930 is illustrated in the lower portion of FIG. 9d, where the user interface exposes respective controls for uploading different types of content. For example, widgets 932 collectively provide controls to enter view content associated with a website, view content associated with a video clip, and view content associated with a countdown timer. The term “widget” is used to indicate a user interface that enables a user to invoke a respective functionality provided by the organization information distribution system, which includes uploading different types of content into the system.

User interface 930 also includes text field 934 and submit control 936. Text field 934 provides a mechanism for manually entering a Universal Resource Locator (URL) character by character. Accordingly, text field 934 receives character input that describes a URL. In turn, the actuation of submit control 936 enters the URL information into the organization profile as view content. As an alternative mechanism for content entry, user interface 930 includes file upload field 938 that provides drag-and-drop options where a selected file icon can be dragged and dropped into the file upload field 938. In turn, content entered into the file upload field is then submitted into the organization profile as view content. The content entered into the file upload field can upload automatically in response to the field receiving the selected file icon or can upload in response to the actuation of submit control 936.

Returning to user interface 906, consider now FIGS. 9e and 9f that collectively illustrate an example of generating a playlist using view content in accordance with one or more implementations. In the upper portion of FIG. 9e, user 904 actuates control 908-5 to manage the playlists associated with the respective organization. Accordingly, computing device 114 renders example user interface 940 as illustrated in the lower portion of FIG. 9e. While user interface 940 illustrates a particular grouping of information and/or controls, it is not intended to be limiting such that alternate or additional implementations can include and/or omit information and controls without departing from the scope of the claimed subject matter.

User interface 940 generally displays a list 942 of the current playlists in a table format, where the content of each row of the table corresponds to a respective playlist associated with the respective organization profile. For example, edit control 944 corresponds to editing the playlist labeled as “MyList1” while delete control 946 corresponds to deleting the respective playlist. Accordingly, each row provides the user with an ability to examine what view content is included in a respective playlist, modify the associated view content, and/or delete the playlist entirely.

To further demonstrate, now consider the upper portion of FIG. 9f where user 904 actuates edit control 944. In response to the actuation, various implementations display and/or expose the ability to modify the respective playlist. Here, computing device 114 renders example user interface 950 as illustrated in the lower portion of FIG. 9f.

User interface 950 displays various characteristics associated with the selected playlist (e.g., MyList1). For example, drop-down menu 952 has a current setting state that corresponds to the view content labeled as “Company Logo”. Recall, too, from user interface 920 of FIG. 9c that this view content corresponds to web page content. However, actuating the corresponding control of drop-down menu 952 provides alternative view content options to select as the current content setting of that drop-down menu, such as those included in user interface 920. Accordingly, the view content selected and/or added to the respective playlist corresponds to the content deployed to a content management device as further described herein. Thus, when playlist “MyList1” is deployed to a content management device, the view content associated with “Company Logo”, “Football Schedule”, and “Earth from Space” are each deployed at respective times to the content management device. The respective duration and ordering of the view content included in the playlist can be configured as well. For instance, duration field 954 sets and/or defines the duration that the respective view content “Company Logo” is rendered at a content management device, while order field 956 sets and/or defines the relative order in which the view content is deployed. In this example, the web page content corresponding to the view “Company Logo” has a setting of 45 seconds and an order position of “1”. In turn, when the respective playlist is deployed to a content management device, the corresponding web page is rendered for 45 seconds. Since each of drop-down menu 952, duration field 954, and order field 956 are user configurable, user interface 950 provides the ability to modify the playlist settings. User interface 950 also provides the ability to remove view content from the respective playlist via delete control 958, as well as add view content to the playlist through add control 960.

The deployment of a playlist to various organization device can be scheduled as well. To further demonstrate, consider now the upper portion of FIG. 9g in which user 904 actuates control 908-3 via a touch-input gesture. In response to the actuation of control 908-3, various implementations provide scheduling parameter settings in accordance with one or more implementations. Here, computing device 114 renders example user interface 962 as illustrated in the lower portion of FIG. 9g.

User interface 962 generally displays a list 964 of the current schedules in a table format, where the content of each row of the table corresponds to a respective schedule associated with the respective organization profile. For example, edit control 966 corresponds to editing the schedule labeled as “30 Minute Demo Schedule” while delete control 968 corresponds to deleting the respective schedule. Accordingly, each row provides the user with an ability to examine what schedules are defined for the organization profile and modify the associated content.

To further demonstrate, now consider the upper portion of FIG. 9h where user 904 actuates edit control 966. In response to this actuation, various implementations provide editable settings associated with the respective schedule. Here, computing device 114 renders example user interface 970 as illustrated in the lower portion of FIG. 9h.

User interface 970 includes a schedule corresponding to the respective schedule labeled as “30 Minute Demo Schedule”. The corresponding schedule has been partitioned into a table 972 such that each horizontal partition of the table corresponds to weekdays, and each vertical partition corresponds to a 15 minute interval. However, it is to be appreciated that both the horizontal and vertical partitions can have any suitable type of unit without departing from the scope of the claimed subject matter. Based upon the selected unit sizes associated with the horizontal and vertical partitions of table 972, the respective schedule displayed in user interface 970 has been configured into 15 minute partitions by day. For instance, schedule 974 corresponds to deploying the playlist entitled “MyList2” on Sundays from 7:00 AM to 7:30 AM, schedule 976 corresponds to deploying the playlist entitled “Mylist1” on Tuesdays from 6:00 AM to 6:30 AM, and so forth. Accordingly, each respective element included in table 972 can be configured to deploy a respective playlist. For instance, by actuating an element, such as element 978, various implementations display a list of available playlists to assign to the corresponding day and time slot (e.g., lists 940 of FIG. 9e). In turn, a user can select a desired playlist to assign to element 978, and the respective schedule is updated with the change.

Returning to user interface 906, now consider the upper portion of FIG. 9i in which user 904 actuates control 908-4 to manage the content management devices included in the respective organization profile. While described in the context of content management devices, it is to be appreciated that alternate or additional implementations provide various user interfaces associated with managing other devices associated with the respective organization profile, examples of which are provided herein. In response to the actuation of control 908-4, various implementations display and/or expose controls associated with modifying, adding, and/or removing content management devices to/from the respective organization profile. In this example, computing device 114 displays example user interface 980 as illustrated in the lower portion of FIG. 9i.

User interface 980 displays summary information associated with the various content management devices. Here, the summary information is displayed in a table format, where each respective row of the table corresponds to a respective content management device. Accordingly, row 982 corresponds to the content management device associated with the description “2^{nd} Floor West Device”, while row 984 corresponds to the content management device associated with the description “Lobby Device”. Each row also includes controls and supplementary information. For example, controls 986 provide the ability to edit various parameter settings associated with the respective content management device and/or delete the respective content management device from the respective organization profile. Row 984 also includes version field 988 that indicates version information associated with the content management device, while communication field 990 shows when the last communication from the respective content management device was received, such as an “alive message” that indicates the content management device is working and in communication with the system. Here, communication field 990 includes a warning symbol 992 that notifies the user of a potential issue. In this example, the issue corresponds to a lack of communication from the content management device. For instance, some implementations determine that the received last communication occurred at a time period longer than a predetermined threshold, and signal to the user that communication has been lost or stalled.

User interface 980 also includes control 994 that provides the ability to link a new content management device to the organization profile as further described herein. To further demonstrate, consider now the upper portion of FIG. 9j where user 904 actuates control 994 to add a new content management device. In response to the actuation process, the organization information distribution system initiates the process to link the content management device to the organization, such as by sending authentication to the content management device. In turn, the content management device renders the authentication on a corresponding display device that user enters to authenticate and link the content management device to the respective organization profile (not illustrated here).

In response to the actuation of control 994, computing device 114 also renders example user interface 996 as illustrated in the lower portion of FIG. 9j. Here, user interface 996 includes a text entry field 998 that receives the authentication information provided to the content management device. For example, a user in view of the associated display device of the content management device can view the authentication information and manually provide this information into text entry field 998 as a way to add the content management device to the organization profile. In turn, and in response to receiving the proper authentication information, the organization information distribution system adds the new content management device to the system.

In the examples described with respect to FIGS. 9a-9j, computing device 114 communicates with a system server (such as server 112 of FIG. 1) to configure user-preferences on what content and/or actions are deployed to various devices throughout an organization. Alternately or additionally, this can include adding, removing, and/or modifying the devices in the organization. However, computing device 114 can alternately or additionally be used to invoke a trigger event, such as through a software control displayed on a mobile phone as further described herein. Accordingly, while computing device 114 is illustrated as a desktop computer in FIG. 9a-9d, other types of computing devices can be utilized to configure an organization profile and/or invoke a trigger event.

To further demonstrate, consider now FIG. 10 that illustrates different types of devices in accordance with one or more implementations. In various scenarios, FIG. 10 represents a continuation of one or more examples described with respect to FIGS. 1-9d. FIG. 10 includes mobile phone 114a, tablet 114b, laptop 114c, smart watch 114d, invocation device 114e, and home assistant device 114f as example devices that can be used to implement one or more functionalities described with respect to computing device 114. Each of mobile phone 114a, tablet 114b, laptop 114c, and smart watch 114d can include a stand-alone application and/or web browser application to access a user interface provided by a system server (e.g., one or more user interfaces described with respect to FIGS. 9a-9d). Alternately or additionally, mobile phone 114a, tablet 114b, laptop 114c, and smart watch 114d display a control button associated with invoking a trigger event through a single-user interaction that actuates the control button.

To further explain, consider again the scenario in which school personnel invoke a trigger event associated with deploying an immediate view to various content management devices using a single user-interaction. The phrase “single user-interaction” is used here to indicate the ability to actuate the control button without navigating through multiple menus and/or layers of an application. Now consider an example in which school personnel invoke the trigger event by actuating a software control displayed on a smart watch. Various implementations of the smart watch can include text entry fields on the display that receive content which is then forwarded to various devices in the organization as supplementary content. By providing a control button associated with invoking the trigger event and/or the text entry field on a display of a smart watch, etc., school personnel can wear the smart watch and carry the ability to invoke trigger events and provide real-time updates with them. This improves the communication across an organization by providing mobility to, and simplifying, the actuation process.

As another example of using a single user-interaction to invoke a trigger event, invocation device 114e includes a mechanical button 1000 that, when pressed by a user, causes the invocation device to notify the system server of a trigger event, examples of which are provided herein. Alternately or additionally, various implementations of home assistant device 114f include a microphone that captures audible input. In turn, the audible input can be converted into text using speech-to-text algorithms that is then analyzed by the system server to determine when to trigger an input event as further described herein. While described in the context of a single user-interaction, other implementations employ multiple user actions to invoke a trigger event, such as through menu navigation.

FIG. 11 illustrates a method 1100 that presents immediate views at a content management device. The method can be performed by any suitable combination of hardware, software, and/or firmware. In at least some embodiments, aspects of the method can be implemented by one or more suitably configured hardware components and/or software modules, such as content management module 108, organization profiles 116, and/or organization action module 118 of FIG. 1. While the method described in FIG. 11 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At 1102, various implementations connect to a server associated with an organization information system, such as by using a communication network. To successfully connect with the server, some implementations provide authentication information to the server. This can include a username/password, an organization ID, a security key, and so forth.

In response to connecting to the server, one or more implementations receive a first notification to present default content associated with a first immediate view at 1104. For instance, the server can send configuration information that includes the default content and/or commands to operate in a default mode. Alternately or additionally, various implementations provision the content from the server using cloud-based services provided by the server. The first notification can alternately or additionally be included in a startup process during an initial configuration process that is launched in response to connecting to the server. The default content can include any combination of media, images, audio, address information, examples of which are provided herein.

At 1106, some implementations present the default content, such as by displaying a playlist of still images in combination with audio, displaying the playlist in a continuous looping mode, applying text-to-speech algorithms to generate synthesized speech corresponding to the default content, and so forth. Various implementations present the default content for a finite duration, while other implementations present the default content for an indefinite duration of time that is bounded by state transitions as further described herein.

While presenting the default content, various implementations receive a second notification to present different content associated with a second immediate view at 1108. For example, a content management device can receive a notification message from the server over the network and/or subscribe to a notification service provided by a cloud-based platform. Similar to the first notification, the second notification can include any type of information, content, messaging, and so forth.

Accordingly, in response to receiving the second notification, various implementations present the different content at 1110. Similar to that described with respect to the default content, the different content can persist for an indefinite time that is bounded by a state transition and/or can be presented for a finite duration. The different content can include receiving real-time updates over an arbitrary amount of time, where the updates are added to the presentation of the different content, such as through the use of a scrolling marquee. Alternately or additionally, the different content can include audio alerts, timing mechanisms, synthesized speech using text-to-speech algorithms, and so forth.

FIG. 12 illustrates a method 1200 that deploys actions to devices across an organization in accordance with one or more implementations. The method can be performed by any suitable combination of hardware, software, and/or firmware. In at least some embodiments, aspects of the method can be implemented by one or more suitably configured hardware components and/or software modules, such as content management module 108, organization profiles 116, and/or organization action module 118 of FIG. 1. While the method described in FIG. 12 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At 1202, the system receives a notification associated with a trigger event over a communication network from a remote device. In various implementations, the remote device is associated with a particular organization that is registered to an organization information distribution system. The notification can be received from, and/or originated by any suitable device, such as an invocation device, a mobile phone, a smart watch, a desktop computer, a detector included in an invocation device and/or external from an invocation device, and so forth. Alternately or additionally, the notification can include location information, identification information, timing information, authentication information, audio files and/or content, video content, still images, and so forth. Further, the notification and/or information included with the notification can be received in a single communication exchange and/or over multiple communication exchanges. Some implementations receive the notification and/or information through the invocation of a cloud-based service as further described herein.

Various implementations analyze an organization profile based on the notification to determine the action(s) to deploy to device(s) associated with the organization information distribution system at 1204. The organization profile can be implemented in any suitable manner, such as a metadata file, a text-based file, and/or configuration parameters applied to various devices. The analysis can include determining whether the trigger event is associated with an alarm or event such that the deployed actions for alarms and events have different duration properties as further described herein. Alternately or additionally, the analysis can identify sub-groups of devices, where each respective sub-group is associated with a different response action to the trigger event.

In response to analyzing the organization profile, various actions are deployed to organization device(s) and/or non-organization devices that are associated to receive communications from the organization information distribution system. Any type of action can be deployed over the communication network to any suitable type of device. Some implementations deploy an action associated with configuring an electronic switch and/or relay, such as an electronic relay that enables or disables video capture, an electronic lock associated with locking and/or unlocking a door, etc. Alternately or additionally, an action can include deploying an immediate view, an audio clip, a still image, etc. Any combination of actions can be deployed to any combination of devices, sub-groups, and so forth, examples of which are provided herein.

Having described various aspects of deploying an immediate view and/or other actions across an organization, consider now a discussion of hardware invocation of a trigger event in accordance with one or more implementations.

Hardware Invocation of a Trigger Event

Trigger events can be used in an organization information distribution system as notifications of when to deploy various actions and/or content across the organization. While software controls can be used to generate trigger events, alternate or additional implementations utilize hardware mechanisms. To demonstrate, consider now FIG. 13 that illustrates an example environment 1300 in accordance with one or more implementations. The environment described with respect to FIG. 13 can represent a continuation of one or more examples described with respect to FIGS. 1-12. Environment 1300 includes content management device 102, display device 104, and server 112 of FIG. 1, as well as invocation device 1302. Content management device 102, server 112, and/or invocation device 1302 are communicatively coupled to one another through communication cloud 110 of FIG. 1. Accordingly, these devices can send messages and/or data between one another, invoke functionality across the communication cloud, and so forth.

Invocation device 1302 provides a user with the ability to invoke a trigger event. The invocation device 1302 can range from simple hardware implementations, such as a system with minimal processing power that includes a mechanical button and/or switch and is connected to a communication network, to more complex systems that include processors, display devices, software applications, etc. Invocation device 1302 includes actuation mechanism 1304 in the form of a hardware control button as a user-interface that can invoke a trigger event via a single user-interaction. Accordingly, in response to identifying that the hardware control button has been pressed, the invocation device transmits a notification of the trigger event to server 112 using communication module 1306.

As in the case of communication module 106 of FIG. 1, communication module 1306 generally represents any suitable combination of hardware, software, and/or firmware used to facilitate the exchange of information with one or more other devices, Communication module 1306 can include one or more protocol stacks associated with communicating over communication cloud 110, firmware that drives hardware to generate signals and/or process messages used in maintaining the communication session, and so forth. Communication module 1306 can alternately or additionally include various computer networking ports, examples of which are provided herein.

Invocation device 1302 also includes identification data 1308 that describes various characteristics of the invocation device. For example, identification data 1308 can include a unique identification (ID) value associated with a particular instance of an invocation device, an organization ID number, location information, revision information, communication addressing information, date information, time information, and so forth. Some implementations of invocation device 1302 allow the user to configure the identification data, such as by logging on to server 112 and configuring the information through a user interface similar to those described with respect to FIGS. 9a-9d. In turn, in response to generating the trigger event, various implementations transmit some or all of the identification data with the trigger event. This can be in a single message, or multiple messages. Alternately or additionally, the identification data and/or notification of the trigger event can be transmitted to sever 112 as an input parameter of a function being invoked across the network.

Invocation device 1302 optionally includes organization access module 1310 that provides the invocation device with the ability to invoke and/or receive functionality specific to an organization information distribution system. Alternately or additionally, organization access module 1310 equips the invocation device with an ability to communicate with the organization information distribution system, such as by providing message interpretation information, message formatting information, command information, invocation information, query information, etc. In some scenarios, invocation device 1302 use organization access module 1310 to invoke cloud-based services provided by server 112. Organization access module 1310 can also provide the invocation device with an ability to authenticate itself with, authenticate access to, and/or authenticate access from the organization information distribution system (using identification data and/or communication module 1306). Thus, while communication module 1306 provides invocation device 1302 with access to communication cloud 110, organization access module 1310 provides invocation device 1302 with access to the organization information distribution system and/or corresponding services.

In some implementations, the organization access module 1310 manages the assignment of the invocation device to an organization. To demonstrate, consider an example in which the organization access modules determines at the startup of the invocation device that no assignment to an organization exists. In response to this determination, the organization access module enables a local Wi-Fi access point via the communication module and assigns the local Wi-Fi access point with a name that corresponds to authentication information. For example, the organization access module can configure the Service Set Identifier (SSID) of the access point to an alphanumeric string that corresponds to the authentication information. In turn, a user can retrieve the SSID, and subsequently the authentication information associated with the invocation device, using a device that has visibility into the Wi-Fi access point. For instance, a mobile device that supports Wi-Fi can scan the surrounding area during startup of the invocation device as a way to detect the presence of the Wi-Fi access point. In response to detecting the presence of the Wi-Fi access point from the invocation device, the mobile device can retrieve and display the SSID information. A user can then retrieve the SSID information from the mobile device and submit the authentication information to server 112 as a way to assign the invocation device to a particular organization. Once the invocation device is assigned to an organization and/or the invocation device receives confirmation of the assignment from the organization information distribution system, the organization access module can disable the local Wi-Fi access point.

Now consider FIG. 14 that illustrates example communication exchanges between devices in accordance with one or more embodiments. In various implementations, FIG. 14 represents a continuation of one or more examples described with respect to FIGS. 1-13. FIG. 14 includes multiple instances of content management device 102 and server 112 of FIG. 1. In various implementations, the multiple instances of the content management devices belong to a same organization profile and are positioned at different locations from one another. FIG. 14 also includes invocation device 1302 of FIG. 13. The respective vertical lines underneath each device corresponds to actions performed at that device. Thus, the vertical line beneath content management device 102 corresponds to actions performed by various content management devices in an organization information distribution system, the vertical line beneath server 112 corresponds to actions performed by servers in the organization information distribution system, and the vertical line beneath invocation device 1302 corresponds to actions performed by an invocation device in the organization information distribution system. The horizontal action lines between the different devices represents communication across a network between the connected devices, such as through transmitting and receiving messages and/or the invocation of software functionality across devices using cloud-based services.

Assume that invocation device 1302 has been configured for an organization, such as by a user or operator configuring the invocation device using various techniques described herein. In response to activation in an organization information distribution system, various implementations of the invocation device send updates to server 112 to indicate that the invocation device is operational. These messages can be periodic, asynchronous, or any combination thereof. Accordingly, at 1400-1400n, the invocation device transmits an alive message to the server, where “n” represents an arbitrary value. While each alive message is illustrated as a single step, it is to be appreciated that this step can alternately or additionally entail multiple messages, including bi-directional messages between invocation device 1302 and server 112 and/or the invocation of software over the network using cloud-based services.

In various implementations, server 112 identifies when an alive message from invocation device 1302 has been delayed and/or fails to be received successfully. For example, server 112 can use a timer that is set to a predetermined time duration such that if the timer expires before an alive message is received, the server 112 can deploy a notification to various devices that it has lost contact with invocation device 1302. Conversely, if the server receives an alive message before the timer expires, the server determines that the connection to the invocation device is working properly and can reset the timer to the predetermined time duration to monitor the connection for the next alive message. This enables the organization information distribution system to identify when an invocation device has either stopped working and/or the communication path to the invocation device has deteriorated.

At a later point in time, the invocation device detects an activation of the actuation mechanism at 1402. This can include a user pressing a mechanical button and/or include the user actuating a software control. In response to detecting the actuation, the invocation device sends a notification of the event to server 112 at 1404. The notification can include any type of information, such as a unique identifier corresponding to a particular invocation device, location information, time stamps associated with when the activation occurred, and so forth. Various implementations include an organization identification number. While sending the notification is illustrated as a single step, it is to be appreciated that this step can alternately or additionally entail multiple messages, including bi-directional messages between invocation device 1302 and server 112. For example, the invocation device 1302 can send a notification that a mechanical button has been activated and then send a second message that includes identification data. Other examples include the server querying the invocation device for the identification data. Alternately or additionally, the transfer of information over the network can include the invocation of software via cloud-based services as further described herein.

At 1406, the server 112 determines that a trigger event that has occurred based upon receiving the notification. In turn, server 112 deploys various actions across the organization at 1408, such as deploying immediate views, toggling electronic switches and/or relays, transmitting marquee updates, etc. While deploying the actions is illustrated as a single step, it is to be appreciated that this step can alternately or additionally entail multiple messages, including bi-directional messages between server 112 and various content management devices, computing devices, etc. Various implementations base what actions are deployed by analyzing the associated organization profile. Accordingly, while FIG. 14 illustrates server 112 as deploying actions to multiple content management devices, other implementations can involve different devices of different types and/or various actions without departing from the scope of the claimed subject matter.

By using information included in a notification of a trigger event originating from an invocation device, server 112 can access an organization profile and deploy actions according to the desires of an organization. Server 112 can also provide more detailed information about the various events as they happen. To further illustrate, consider FIG. 15 that includes a non-limiting example of using various invocation devices in accordance with one or more implementations. The example described with respect to FIG. 15 can represent a continuation of one or more examples described with respect to FIGS. 1-14.

The upper portion of FIG. 15 includes an environment 1500 in which an organization information distribution system includes multiple invocation devices. Here, the environment includes a factory 1502 that spans an arbitrary area size which makes communication between different locations of the factory difficult. Accordingly, factory 1502 includes multiple invocation devices positioned in assorted areas. As one example, the invocation devices can be placed on different floors and/corners of the factory (e.g., invocation device 1504a at the northwest corner on the first floor, invocation device 1504b at the northeast corner on the second floor, invocation device 1504c at the southwest corner on the second floor, and invocation device 1504d at the southeast corner on the first floor). As further described herein, each invocation device includes a communication module that allows the devices to transmit and/or receive data over a communication network. When a respective invocation device is actuated, the actuated invocation device sends a notification to the server that can include information that enables the system to derive location data.

To further demonstrate, consider a scenario in which a user 1506 presses a mechanical button 1508 associated with invocation device 1504c. This action causes invocation device 1504c to send a notification over the communication network to server 112. Moving to the lower portion of FIG. 15, server 112 of FIG. 1 has received the notification generated by invocation device 1504c and determines to deploy various actions based on the corresponding organization profile. Some implementations additionally determine location and/or identification information, such as through information included in the notification, extracting location information from message headers, etc. In the lower portion of FIG. 15, the various actions deployed by server 112 include sending and/or invoking an immediate view 1510 to content management device 102 of FIG. 1, transmitting an audible message 1512 to telephone 1514, and transmitting an SMS message 1516 to mobile phone 1518. Note here that immediate view 1510 and audible message 1512 each include location information associated with the positioning of invocation device 1504c, while SMS message 1516 identifies the factory. As further described, server 112 can derive this content from the received notification and/or pull this content from the corresponding organization profile.

The various recipient devices illustrated in FIG. 15 (e.g., content management device 102, telephone 1514, and mobile phone 1518) can be located within proximity to one another and/or reside at different locations. For instance, content management device 102 can be located in a lobby of the factory and/or at a stage of a factory line, while telephone 1514 corresponds to a fire station. As another example, mobile phone 1518 can be associated with a factory manager away on a business trip. The organization information distribution system can provide real-time dissemination of information to varying devices in varying locations, thus allowing for synchronized communication across the organization.

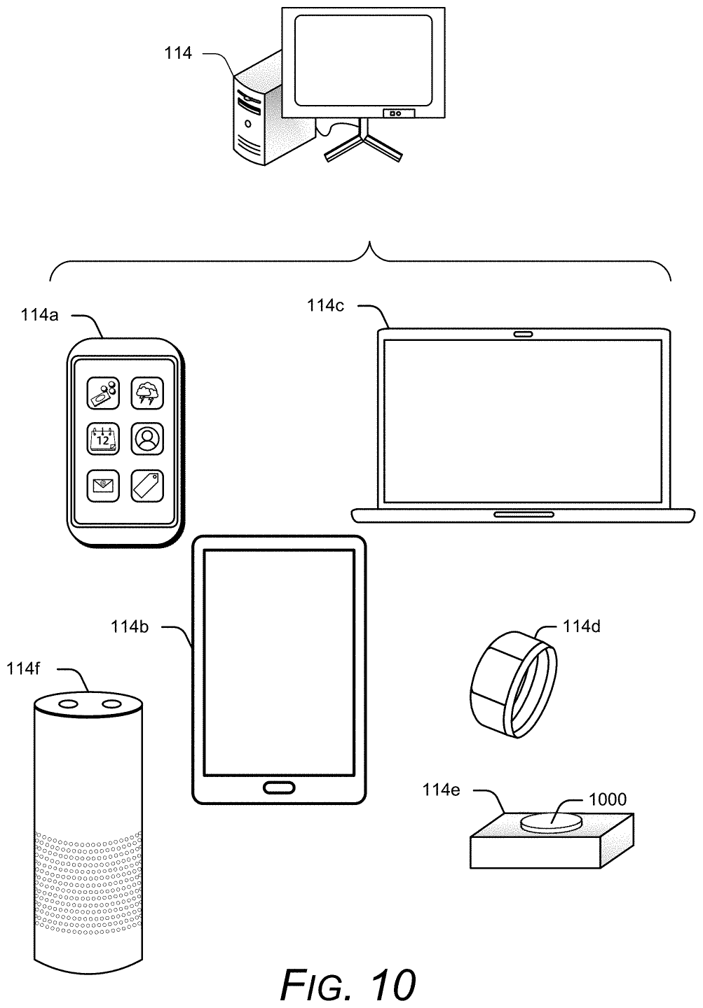

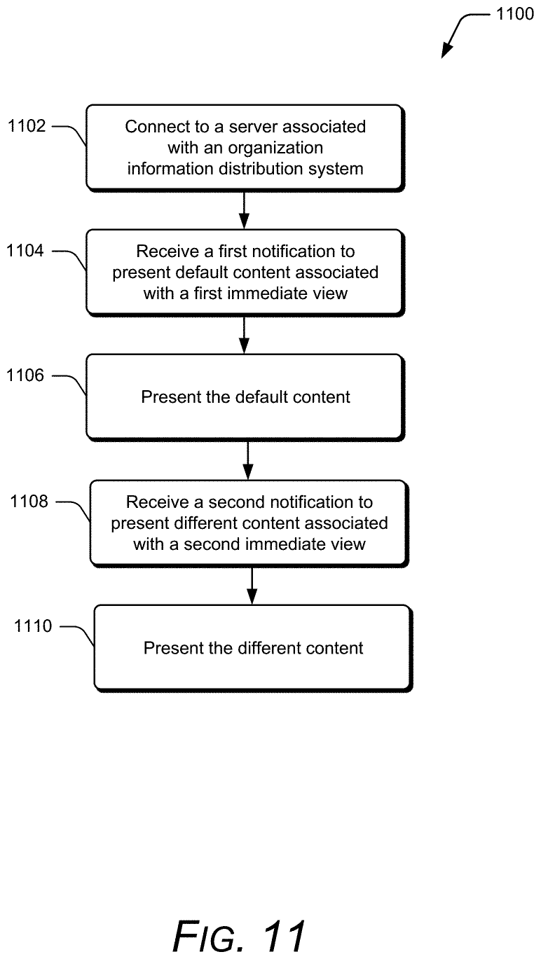

While an invocation device can include an actuation mechanism that the user can interact with to generate a trigger event and/or notification, other implementations alternately or additionally include other mechanisms to generate a trigger event. To demonstrate, consider now FIG. 16 that illustrates an example environment 1600 in accordance with one or more implementations. The example described with respect to FIG. 16 can represent a continuation of one or more examples described with respect to FIGS. 1-15. In one or more implementations, invocation device 1602 represents a non-limiting continuation of invocation device 1302. Accordingly, an invocation device can include varying combinations of sensors, actuation mechanisms, and/or sensors and actuation mechanisms as further described herein.

Environment 1600 includes server 112, content management device 102, and display device 104 of FIG. 1, as well as invocation device 1602. The inclusion of content management device 102 and display device 104 represents any suitable recipient device that can receive actions and/or content deployed by server 112. Thus, while environment 1600 includes the content management device/display device combination, other implementations can include other types of recipient devices, examples of which are provided herein. These devices are communicatively coupled through communication cloud 110, where invocation device 1602 includes communication module 1306, identification data 1308, and organization access module 1310 from FIG. 13. The communication module provides invocation device 1602 with the ability to exchange data over the communication cloud, while the identification data corresponds to organization information (e.g., unique identifiers, location information, and so forth). In environment 1600, invocation device 1602 includes sensors 1604.

Sensors 1604 represent any type of sensor that can detect changes and/or events occurring in a surrounding environment. For example, sensors 1604 can include any combination of a power detector, a motion detector, an optical sensor and/or camera, an audio sensor and/or microphone, a smoke detector, a radar detector, a radio frequency (RF) based detector, an infrared sensor, an accelerometer, a temperature sensor, a moisture sensor, a vibration sensor, a pressure sensor, a biometric sensor, and so forth. Invocation device 1602 uses sensors 1604 to detect and/or identify (without user-interaction) when an event of interest occurs such that the invocation device can send a notification of the trigger event a system server (e.g., server 112). As an example, a sensor detecting an event of interest can cause the system to send a notification of the trigger event that is interpreted by the system as an alarm, and then transition the alarm into a “triggered” state until the system is reset, thus causing the alarm to transition back to a “cleared” state.

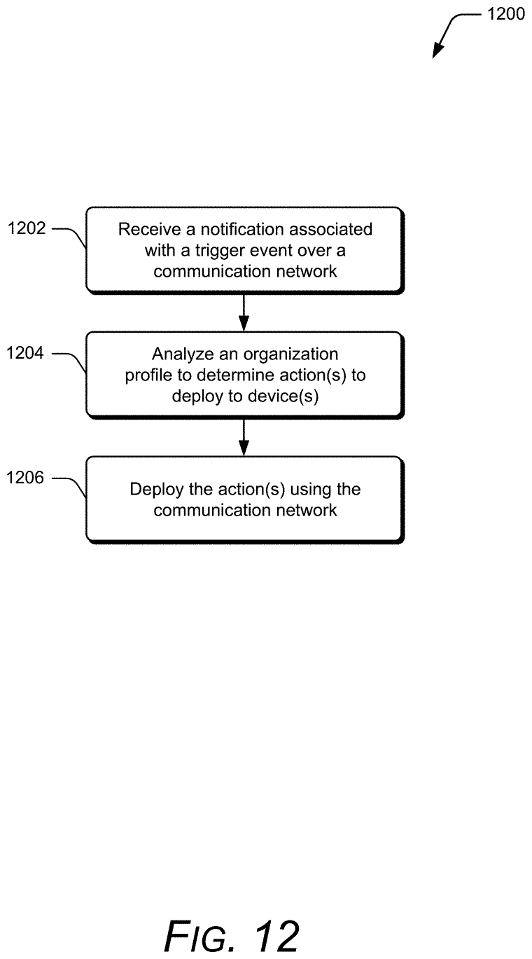

To demonstrate, consider now FIG. 17 that illustrates an example scenario in accordance with one or more implementations. The example described with respect to FIG. 17 can represent a continuation of one or more examples described with respect to FIGS. 1-16. The upper portion of FIG. 17 illustrates an example environment 1700 that employs invocation device 1602 of FIG. 16. Here, the sensors of the invocation device include a power detector to enable the detection of a power supply state (e.g., power ON, power OFF). In this scenario, invocation device 1602 is connected in series between a cooling unit 1702 and a power supply 1704, where power supply 1704 supplies the cooling unit with electricity. The placement of invocation device 1602 in series with the cooling unit and power supply is merely for discussion purposes, and alternate placements of the invocation device can be used without departing from the scope of the claimed subject matter.

In this example, the invocation device includes a power detector configured to identify when power has transitioned into an off state. Accordingly, through the use of the power detector, invocation device 1602 identifies when power supply 1704 transitions to an off state 1706. However, alternate implementations can use the power detector to identify when power surges above a predetermined threshold and/or detect an on state as well. In response to the identifying the transition of power supply 1704 to off state 1706, the invocation device transmits a notification of the trigger event to a system server.

Moving to the lower portion of that FIG. 17, server 112 of FIG. 1 represents the system server that receives the notification from invocation device 1602 and determines the actions and/or content to deploy based upon a corresponding organization profile. For example, the server can send and/or invoke immediate view 1708 at content management device 102 for presentation on display device 104. Alternately or additionally, server 112 can toggle an electronic switch 1710 to activate a backup generator 1712 that temporarily supplies cooling unit 1702 with power. Here, electronic switch 1710 generally represents an electronic device that includes an electronic switch and/or relay that is communicatively coupled to server 112 via a network. Since electronic switch 1710 is communicatively coupled to server 112, the server can send various commands that enable and/or disable the switch using the network. Accordingly, some implementations include electronic switch 1710 in an organization profile as an organization device and/or a non-organization device that can receive communications. As yet another example, server 112 can send an SMS message 1714 to mobile phone 1716 that indicates a power outage event has occurred.

The inclusion of sensors and/or detectors within an invocation device allows the device to automatically generate a notification corresponding to a trigger event without relying on user-interactions to generate the notification (e.g., user-interactions with a software control, user-interactions with a hardware button, etc.). This automatic generation provides real-time notifications of trigger events associated with a state of an environment which might otherwise go undetected and/or might be delayed when based on user-interactions. However, some implementations combine the use of sensors with user interaction.

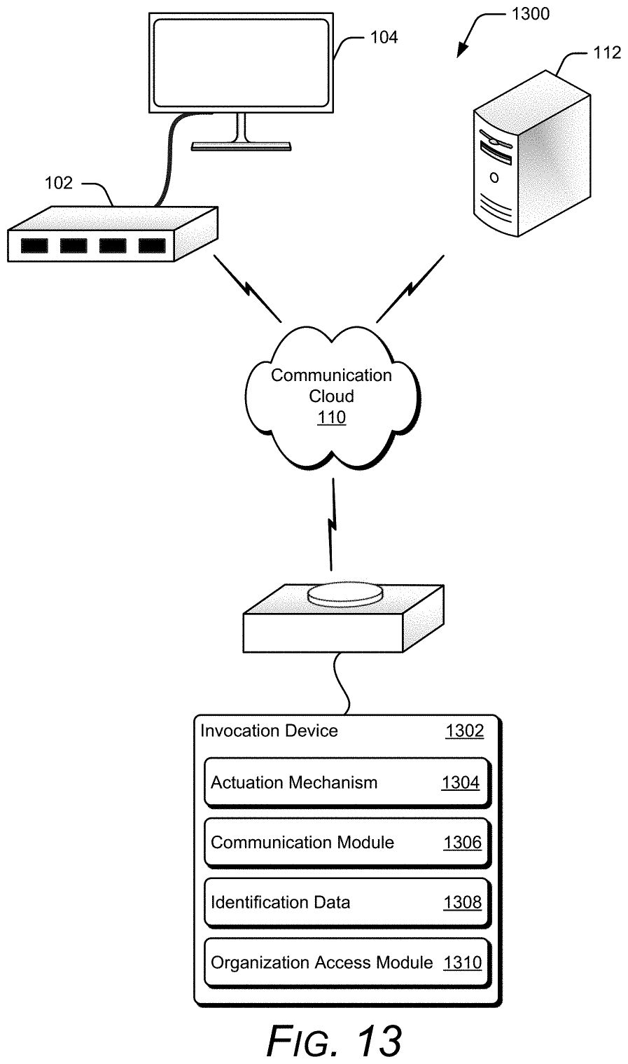

FIG. 18 that illustrates an example environment 1800 in accordance with one or more implementations. The example described with respect to FIG. 18 can represent a continuation of one or more examples described with respect to FIGS. 1-17. For example, invocation device 1802 includes sensors 1604 of FIG. 16, and actuation mechanism 1304, communication module 1306, and identification data 1308 of FIG. 13. Accordingly, invocation device 1802 represents a non-limiting example of invocation device 1602 and/or invocation device 1302 that includes at least one sensor and at least one actuation mechanism.

Environment 1800 includes server 112, content management device 102, and display device 104 of FIG. 1, as well as invocation device 1802. The inclusion of content management device 102 and a display device 104 represents any suitable recipient device that can receive actions and/or content deployed by server 112. Thus, while environment 1600 includes the content management device/display device combination, other implementations can include other types of recipient devices, examples of which are provided herein. These devices are communicatively coupled through communication cloud 110, where invocation device 1802 includes communication module 1306 of FIG. 13 to provide access to communication cloud 110, identification data 1308 of FIG. 13 to include data corresponding to organization information (e.g., unique identifiers, location information, and so forth), and organization access module 1310 of FIG. 13 to include the ability to access functionality specific to the organization information distribution system.

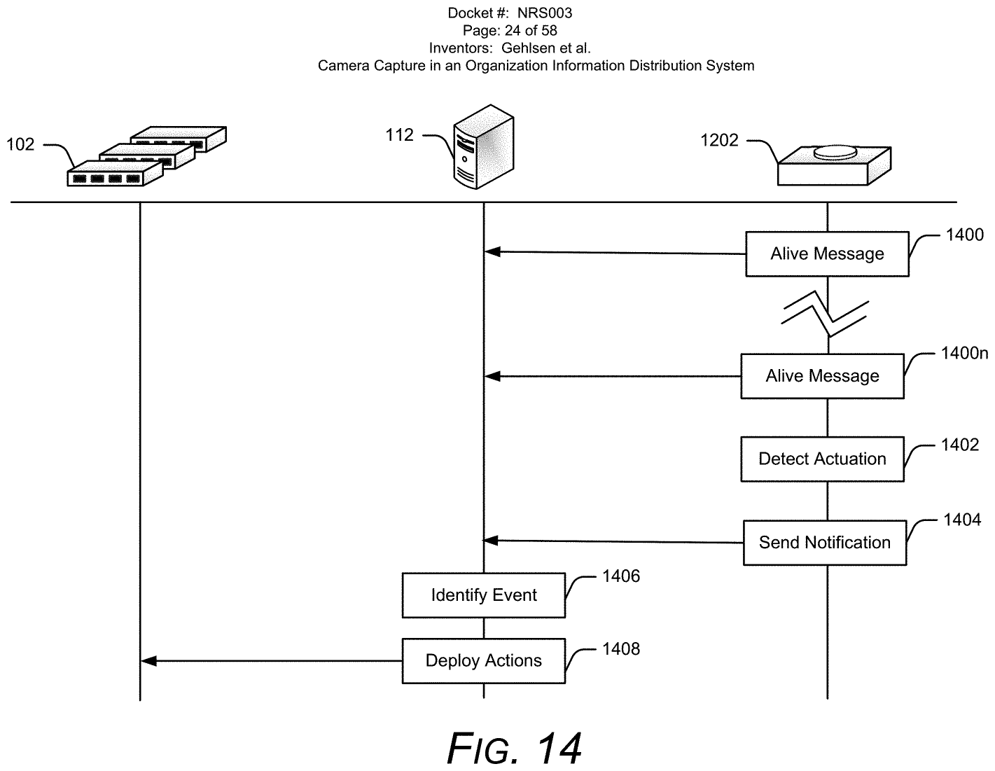

Now consider FIG. 19 that demonstrates an environment in which invocation device 1802 is employed in accordance with one or more implementations. The example described with respect to FIG. 19 can represent a continuation of one or more examples described with respect to FIGS. 1-18. The upper portion of FIG. 19 illustrates an example environment 1900 that includes invocation device 1802 of FIG. 18. Here, invocation device 1802 is configured as a doorbell associated with door 1902, where mechanical button 1904 provides a user interface for interactions with invocation device 1802. Accordingly, in environment 1900, user 1906 presses mechanical button 1904 to alert someone of his presence outside of door 1902.

Various implementations of invocation device 1802 send a notification to a system server to indicate that a trigger event has occurred based on user interactions with the invocation device (e.g., the actuation of mechanical button 1904 via user 1906). Alternately or additionally, invocation device 1802 can include a motion sensor, camera, and/or audio sensor as a way to automatically detect when the user 1906 approaches door 1902 without receiving direct user interactions. For instance, a motion sensor can detect when the user moves towards door 1902, an audio detector can detect noise associated with the user moving and/or talking, and so forth, and send a notification to a system server.

In some implementations, the invocation device uses integrated sensors to capture audio, video, still pictures, and so forth, which are then sent to the system server with the notification. Alternate or additional implementations can use external sensors as further described herein. To illustrate, when user 1906 presses the mechanical button 1904 in environment 1900, various implementations base audio and/or video capture around this user-interaction event. As one example, the invocation device can maintain a circular buffer of audio and/or video data such that when the user-interaction event occurs, the invocation device can obtain audio and/or video that occurred prior to the user-interaction event by accessing the circular buffer.

Consider a circular buffer that maintains 60 seconds of audio that continuously overwrites old audio data with new audio data. When the user-interaction event occurs, the invocation device can access the circular buffer at a time corresponding to the user-interaction event and acquire 30 seconds of audio occurring before the event. The invocation device can also acquire 30 seconds of data after the user-interaction event, such as user speech 1908, and combine the two 30-second clips together to generate a 60 second audio clip. In turn, the generated clip can be forwarded to the system server along with the notification. Other implementations forward a clip that includes data from the buffer and then stream real-time audio or video to the system server starting at a point in time corresponding to the user-interaction event. It is to be appreciated that the sizes of the buffers and content clips are used here for discussion purposes, and any other sizes can be used without departing from the scope of the claimed subject matter.

Moving to the lower portion of FIG. 19, server 112 of FIG. 1 receives the notification of the trigger event from the invocation device 1802 and/or the audio data that includes user speech 1908. Alternately or additionally, server 112 can receive identification data, video clips, still clips, and/or streaming data. Based on the received notification, server 112 deploys various actions. Here, server 112 deploys a video clip 1910 to content management device 102 that drives display device 104 with the images included in the video clip. Alternately or additionally, content management device 102 drives audible output 1912 on a corresponding speaker. The speaker can be integrated with the display device, integrated with the content management device, or be an external speaker communicatively coupled to the content management device or the display device.

Server 112 also transmits video clip 1910 to mobile phone 1914a, while mobile phone 1914b receives audible output 1912 that corresponds to user speech 1908. Thus, the organization information distribution system can distribute audio, video, still images, and/or any combination thereof across an organization. In response to user 1906 actuating mechanical button 1904, another user can alternately or additionally invoke a second trigger event that communicates with server 112 to toggle an electronic switch to unlock door 1902, such as through the use of a software control (not illustrated here) displayed on mobile communication device 1912a and/or mobile communication device 1912b.

Various implementations can alternately or additionally analyze audio files and/or content to search for various characteristics. For example, in response to receiving an audio clip, server 112 process the audio clip to search for key words, predetermined noises, tones, and so forth. Consider a scenario in which an organization has dispersed multiple invocation devices to various locations around a building, where each invocation device includes a microphone and a mechanical button. When a mechanical button of one invocation device is actuated, various implementations receive notification of the actuation trigger event, and deploy an action that enables the microphones of each of the multiple invocation devices to stream audio and/or to send audio clips, an action to send audio clips with content occurring before the trigger event and/or after the trigger event, and so forth. In turn, the server analyzes the received audio from each invocation device to search for the various characteristics. In response to identifying audio that includes a particular characteristic, the server can determine location information of the corresponding invocation device that generated the audio and forward the location information to other devices. For example, the server can search for a gunshot noise and discern a location corresponding to the gunshot noise based on which invocation device includes the noise and/or has the loudest audible capture of the gunshot noise. While described in the context of analyzing audio for various characteristics, alternate or additional implementations can analyze video and/or still images.

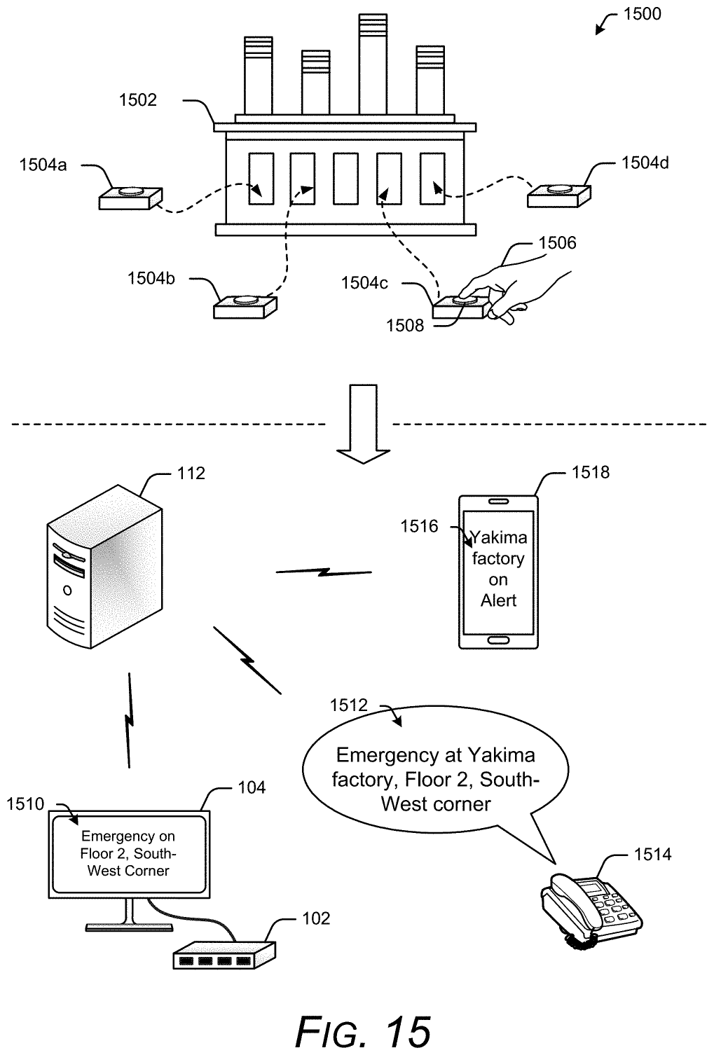

As another example of sensors triggering the enablement of other devices, consider now FIG. 20 that illustrates an example of activating an electronic relay and/or switch in accordance with one or more implementations. The example described with respect to FIG. 20 can represent a continuation of one or more examples described with respect to FIGS. 1-19. The upper portion of FIG. 20 illustrates environment 2000 that includes a door 2002 that includes an electronic lock 2004 and video camera 2006. Electronic lock 2004 includes circuitry that can discern various aspects about door 2002, such as when door 2002 is in a locked state, in an unlocked state, opening, closing, and so forth. In various implementations, electronic lock 2004 is registered as a device in a corresponding organization profile. Alternately or additionally, electronic lock 2004 can be integrated into an invocation device, such as invocation device 1302 of FIG. 13, invocation device 1602 of FIG. 16, and/or invocation device 1802 of FIG. 18. Accordingly, electronic lock 2004 can be communicatively coupled to a system server such that the system server can receive notifications from the electronic lock. As one example, electronic lock 2004 can discern an opening action 2008 of door 2004 when it is in a locked state and send a notification of a trigger event to a system server.

Moving to the lower portion of FIG. 20, server 112 of FIG. 1 receives the notification and determines what actions to deploy based upon an organization profile. Here, server 112 invokes an immediate view 2010 at content management device 102 and/or display device 104 of FIG. 1 that gives an indication door 2002 has been opened while in a locked state. The server also activates electronic switch 2012 that is associated with video camera 2006 to capture video associated with door 2004. The video captured by video camera 2006 can be any type of image, such a video clip that includes video images that occurred prior to the trigger event associated with detecting the door opening, real-time streaming images, and so forth. Various implementations capture still images, a video clip of a predetermined length, continuously until the event has cleared, and so forth. Since video camera 2006 is also communicatively coupled to server 112 via a network, various implementations transmit the captured video clip back to the server 112 for distribution. Accordingly, server 112 also transmits video 2014 to laptop 2016. While described in the context of triggering an image capture in response to sensing a locked door opening, it is to be appreciated that other types of sensors can be used to control alternate or additional devices. For instance, a smoke detector included in an invocation device, or a smoke detector external to an invocation device, can be configured to send a notification to the system server in response to detecting smoke. In turn, the organization information distribution system can send immediate views to alert people of the alarm, activate an electronic relay coupled to sprinklers, and send an audible message to the fire station that includes location information on where the smoke was detected.

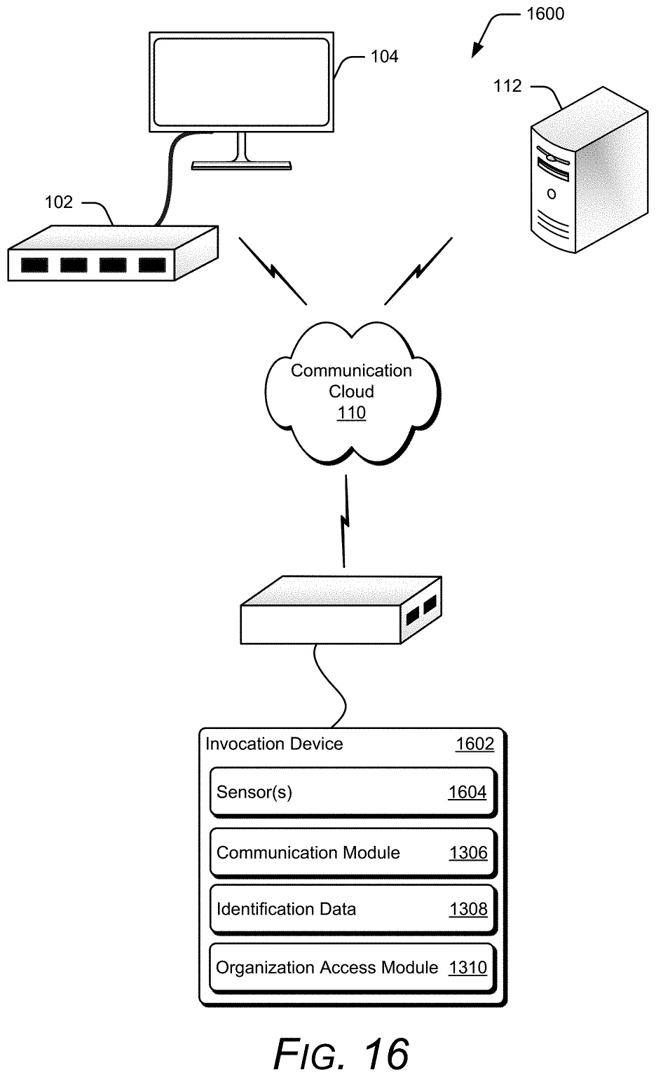

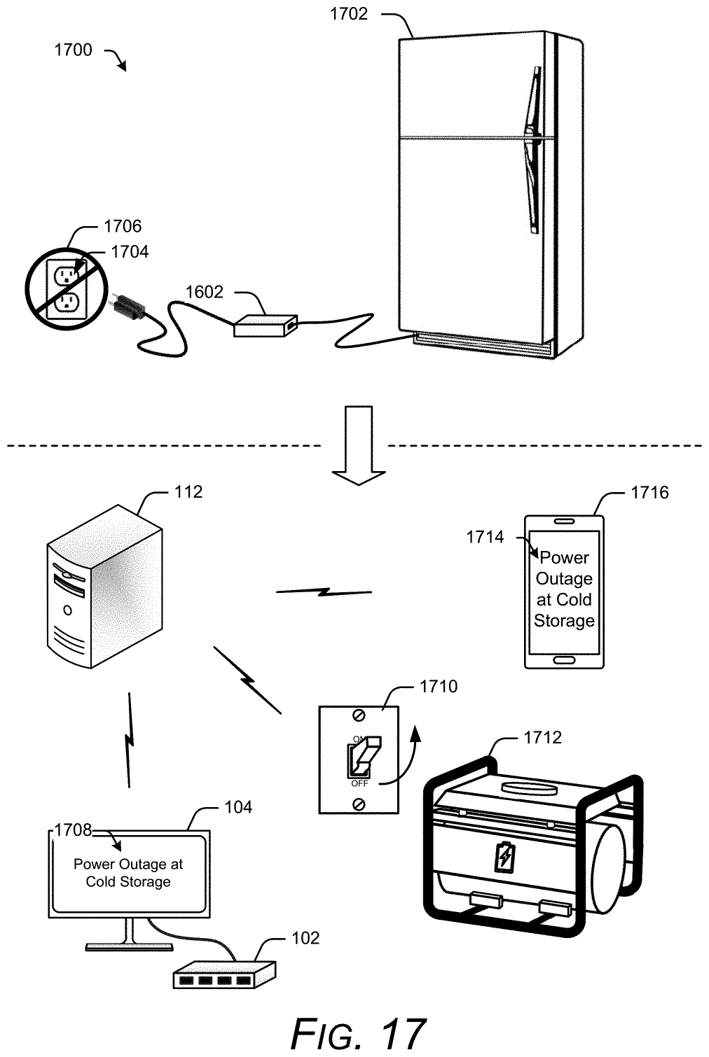

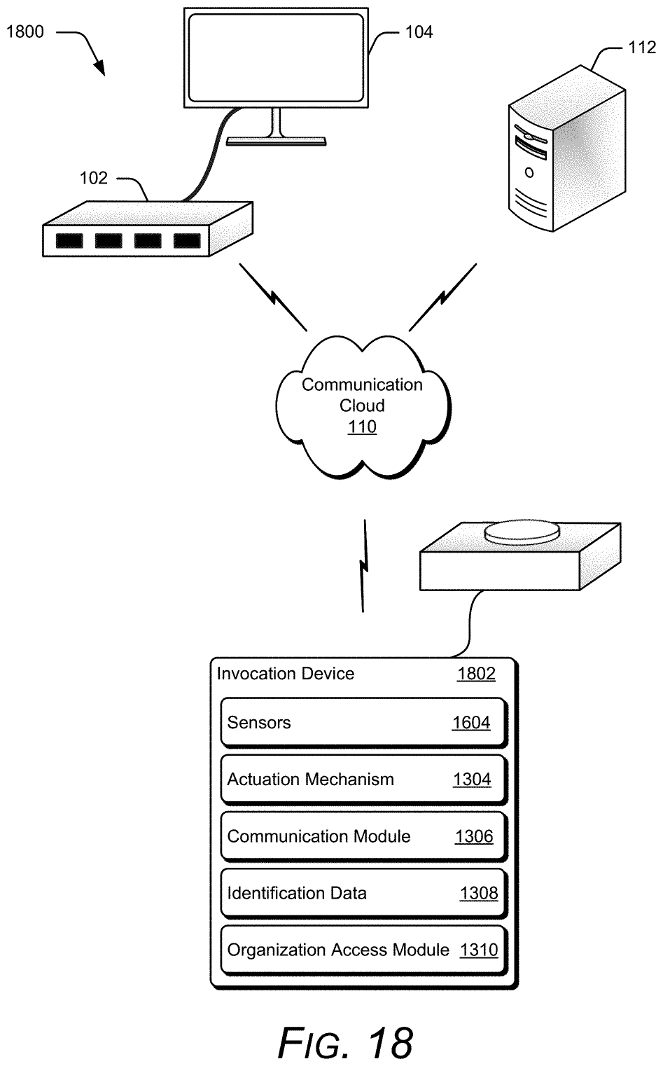

Various implementations alternately or additionally apply a tiered deployment process in response to receiving a trigger event. To further demonstrate, consider now FIGS. 21a and 21b that illustrate an example of a tiered deployment process in accordance with one or more implementations. The example described with respect to FIGS. 21a and 21b can represent a continuation of one or more examples described with respect to FIGS. 1-20. Collectively, FIGS. 21a and 21b demonstrate an example progression of events, where the progression begins in the upper portion of FIG. 21a, then moves to the lower portion of FIG. 21a. The progression then proceeds to the upper portion of FIG. 21b, followed by the lower portion of FIG. 21b. It is to be appreciated that the progression of events described with respect to FIGS. 21a and 21b are for discussion purposes, and that any other ordering, omission, and/or addition to the events can occur without departing from the scope of the claimed subject matter.

The upper portion of FIG. 21a includes home assistant device 2100 that functions as an invocation device. In this example, home assistant device 2100 receives an audible input 2102 from a user 2104 via a microphone (not illustrated here). Various implementations analyze the audible input and identify keywords associated with invoking a trigger event. For example, the home assisted device can include speech-to-text algorithms that generate text content from audible input 2102, and then analyze the text content for keywords, such as “help”. In turn, the home assistant device sends a trigger event notification to server 112.

Moving to the lower portion of FIG. 21a, server 112 consults organization profile 2106 to determine which actions to deploy in response to receiving the trigger event notification from home assistant device 2100. In this example, organization profile 2106 defines a tiered deployment plan that describes the actions to deploy at various stages in the trigger event response. For example, the actions and/or devices included in the grouping labeled “Tier 1” correspond to actions deployed and/or devices communicated with when operating in first stage of the trigger event response. Similarly, the actions and/or devices in the grouping labeled “Tier 2” correspond to actions deployed and/or devices communication when operating in a second stage, the grouping labeled “Tier 3” correspond to a third stage, and so forth. While illustrated here as a three-tiered deployment response, any other number of tiers and/or stages can be utilized. Here, server 112 initially deploys the “Tier 1” actions in response to the trigger event, which is further indicated here by arrow 2108. The deployed actions of the “Tier 1” grouping include sending audible messages to landline phone 2110 (e.g., “Wes Home Phone”) and landline phone 2112 (e.g., “Mary Lee Home Phone”), but other types of action can be deployed, examples of which are provided herein. In turn, the server monitors for responses to determine whether or not to move to a next stage of the tiered deployment plan.

Moving to the upper portion of FIG. 21b, server 112 determines that no responses have been received in response to the actions deployed in the “Tier 1” stage, further denoted here with indicators 2114. To determine that no responses have been received, some implementations set a timer for a predetermined length of time when deploying actions for a particular stage, such as the “Tier 1” actions. If the timer expires before any response is detected, the devices and/or actions are marked as non-responsive, and the system proceeds to the next stage of the deployment process. In this example, server 112 moves to the “Tier 2” stage, which is further denoted by arrow 2116.

Moving to the lower portion of FIG. 21b, server 112 deploys various actions based upon the stage definitions included in organization profile 2106. For instance, server 112 can deploy an SMS message to device 2118 (e.g., Wes Cell Phone), deploys an audible message to device 2120 (e.g., Mary Lee Cell Phone), an SMS message followed by an audible message to device 2122 (e.g., Jon Cell Phone), and an audible message to device 2124 (e.g., Lobby). It is to be appreciated that the combination of actions and/or content deployed in this example is for discussion purposes, and alternate or additional implementations can deploy any combination of content, such as audible messages, immediate views, text-based content, and so forth. If server 112 identifies a response based on “Tier 2” deployment, there is no further advancement in the deployment process stages. However, if the devices fail to respond, various implementations move to the next stage of the tiered deployment process (e.g., “Tier 3”).

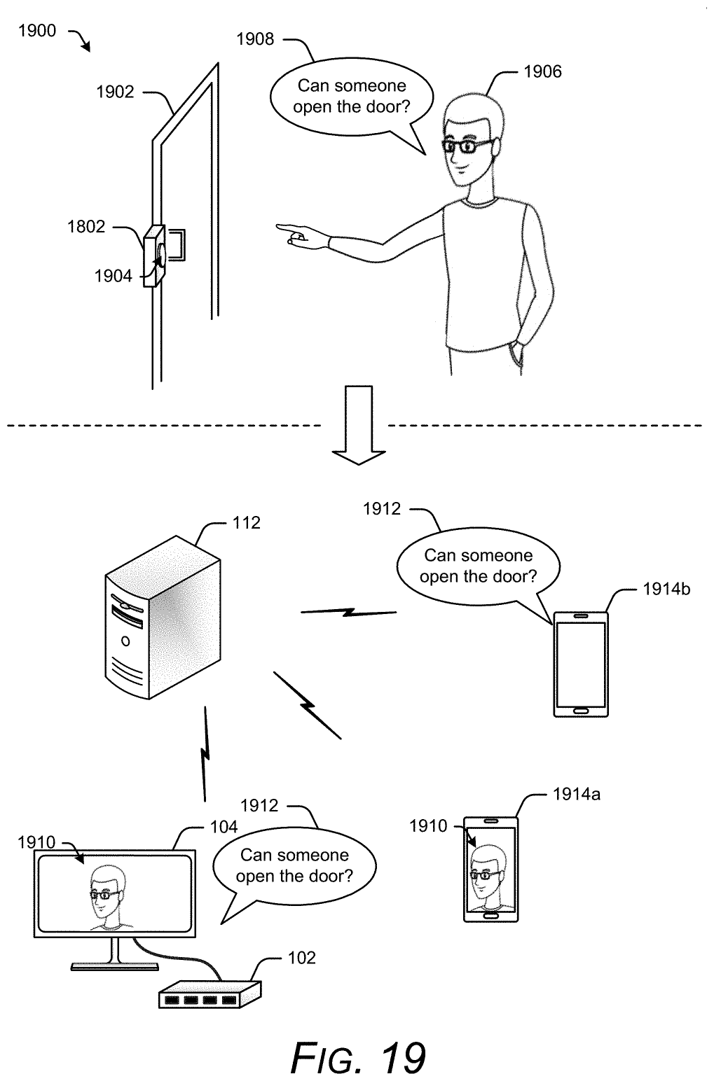

FIG. 22 illustrates an example method 2200 that deploys a trigger event using invocation device(s) and/or sensor(s) in accordance with one or more implementations. The method can be performed by any suitable combination of hardware, software, and/or firmware. In at least some embodiments, aspects of the method can be implemented by one or more suitably configured hardware components and/or software modules, such as various hardware and/or software modules of invocation device 1302 of FIG. 13, invocation device 1602 of FIG. 16, and/or invocation device 1802 of FIG. 18. While the method described in FIG. 22 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At 2202, various implementations connect to a server associated with an organization information distribution system. The connection can be initiated by the server and/or the invocation device. For example, the invocation device can include a stored address to the server that causes the invocation device to attempt to connect to the server at power up. Some implementations perform authentication techniques to validate the connections, such as a public/private key exchange, username and passwords, and so forth. The authentication process can be automated without user-intervention and/or can include user-interactions.

In response to connecting to the server, various implementations detect a trigger event occurring at 2204, such as the actuation of a hardware mechanism included in the invocation device and/or the detection of the trigger event through a sensor. The sensors can be integrated with the invocation device and/or can be an external sensor that is communicatively coupled to the invocation device. The trigger event can involve user-interactions, such as a single user-interaction that presses the hardware mechanism, or can be automatic and without user-interactions, examples of which are provided herein.

At 2206, various implementations optionally capture content in response to detecting the trigger event. The capture content can be any suitable type of content, such as a still image captured around a point in time corresponding to detecting the trigger event, an audio clip or video clip that includes content captured prior to the trigger event, real-time streaming audio and/or video, and so forth.

At 2208, the notification of the trigger event is forwarded to the server. In scenarios in which content is captured, the content can be forwarded with the notification. Various implementations transmit messages over the communication network that include the notification and/or content, while other implementations invoke cloud-based services provide by the server.

Having described an example of hardware invocation of trigger events, consider now a discussion of trigger event-based camera captures in accordance with one or more implementations.

Trigger Event-Based Camera Captures

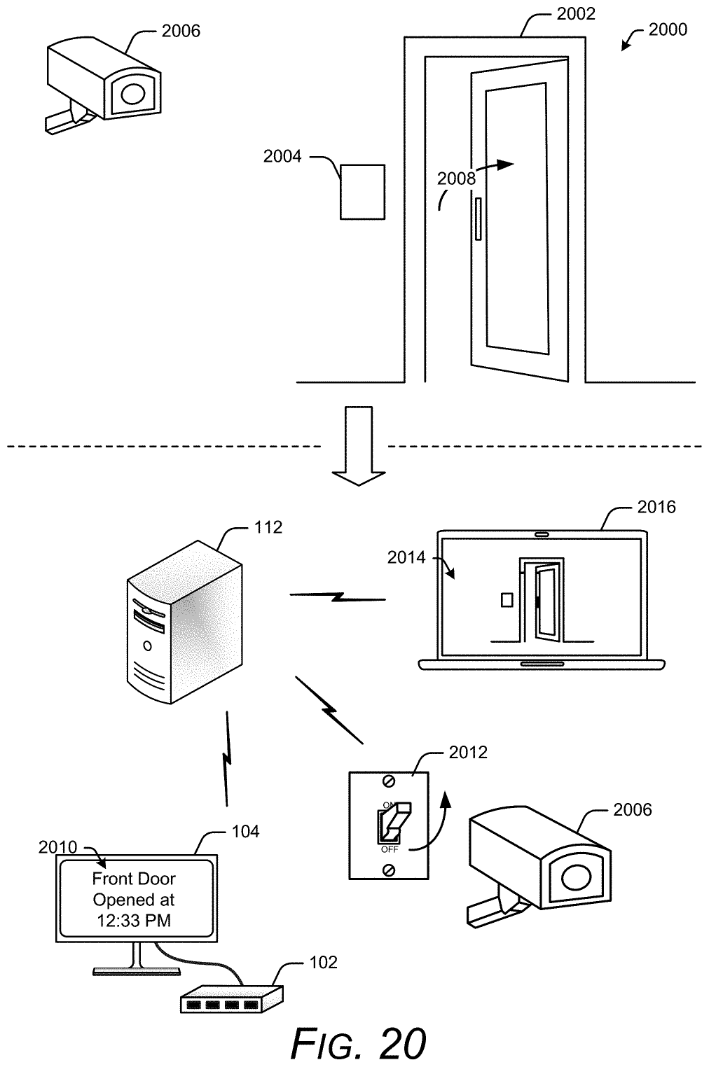

In various implementations, trigger events can be used in an organization information distribution system to extract a video clip from a network-based camera at a designated point in time. To demonstrate, consider now FIG. 23 that illustrates an example environment 2300 in which features of trigger event-based camera captures can be utilized in accordance with one or more implementations. The environment described with respect to FIG. 23 can represent a continuation of one or more examples described with respect to FIGS. 1-22. Environment 2300 includes content management device 102, display device 104, and server 112 of FIG. 1 that are communicatively coupled via communication cloud 110.

Environment 2300 also includes a camera 2302 that is communicatively coupled to communication cloud 110. In implementations, camera 2302 captures and streams live video to recipient devices. For example, camera 2302 can represent an Internet Protocol (IP) camera that connects to a recipient device, such as video monitoring device 2304, to distribute images. Thus, camera 2302 represents an ability to capture a live video stream, and video monitoring device 2304 represents an ability to receive the live video stream from the camera over a network and to distribute the video to the remote devices.

Video monitoring device 2304 that can communicate over the communication cloud to camera 2302, server 112, and/or content management device 102. In implementations, the video monitoring device monitors live video streams captured by the camera 2302 over communication cloud 110. The video monitoring device can receive trigger events from the server 112 and/or generate trigger events as further described herein. A trigger event can include timestamp information that designates a point in time to use in extracting a video clip from a circular buffer as further described herein. In response to receiving or generating a trigger event, the video monitoring device generates a video clip from the video stream, such as by extracting video date from the circular buffer, where the video clip includes at least some video data captured prior to the point in time.

The video monitoring device 2304 includes communication module 1306 of FIG. 13 to provide access to communication cloud 110, identification data 1308 of FIG. 13 that corresponds to organization information (e.g., unique identifiers, location information, and so forth), and organization access module 1310 of FIG. 13 to include the ability to access functionality specific to the organization information distribution system.

Video monitoring device 2304 also includes a video management module 2306 and storage device 2308. Generally, video management module 2306 accesses live video streams generated by the camera 2302. For instance, the video management module can obtain the live video stream from the camera over the communication cloud. Implementations of the video management module maintain a circular buffer of video data in storage device 2308. The storage device 2308 generally represents a physical device that enables data storage, examples of which include random access memory (RAM), non-volatile memory (e.g., read-only memory (ROM), flash memory, EPROM, EEPROM, etc.), and a disk storage device. In implementations, the video management module receives configuration parameters from the server 112, such as circular buffer configuration parameters, video stream configuration parameters, and so forth.

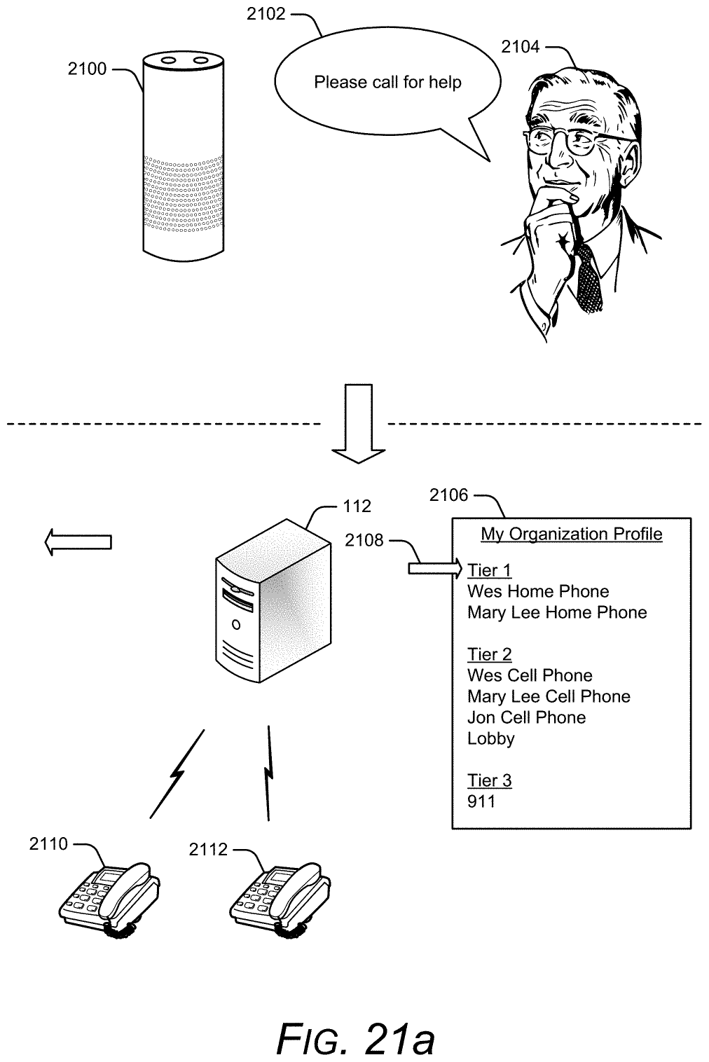

Now consider FIG. 24 that illustrates an example environment 2400 that can be utilized to implement aspects of generating a video clip based upon a trigger event in accordance with one or more embodiments. In various implementations, FIG. 24 represents a continuation of one or more examples described with respect to FIGS. 1-23. FIG. 24 includes camera 2302 and video monitoring device 2304 of FIG. 23, where the camera and the video monitoring device are communicatively coupled over the communication cloud 110 of FIG. 1. The environment 2400 also includes a user device 2402, generally represented here as a display device, where the user device 2402 receives and displays a live video stream 2404 from the camera 2302 and/or the video monitoring device 2304 over the communication cloud.

In the environment 2400, the video monitoring device 2304 implements features of the video management module 2306 of FIG. 23, such as through any combination of software, hardware, and/or firmware. The video monitoring device establishes a connection to the camera, and server 112, respectively, over the communication cloud 110. This allows the video monitoring device to obtain a live video stream 2404, and to distribute video clips generated from the live video stream throughout an organization information distribution system.

In some implementations, the video monitoring device can be included in an organization profile managed by the server 112 of FIG. 1 (not illustrated here), where the video monitoring device is registered as a device that can receive and/or generate trigger events, and the camera is registered as an associated device. Based on information in the organization profile, such as address information, server 112 can send commands over the communication cloud 110 that direct the video monitoring device to connect to the camera. The server can alternately or additionally provide the video monitoring device with an address and/or authentication information to use to establish the connection to the camera.

In some implementations, a user manually configures the video monitoring device, such as through input/output devices provided by the video monitoring device, by connecting peripheral input/output devices to the video monitoring device, by accessing a configuration application resident at the video monitoring device, by sending commands over the communication cloud, etc. Upon establishing a connection, the video monitoring device obtains video data from the camera. The video data can include any suitable combination of information, such as images, audio, timestamps, location information, user IDs, organization IDs, and so forth

In implementations, the video monitoring device maintains a circular buffer 2406 to store the video data from the video stream 2404. This can include storing the circular buffer on a storage device local to the video monitoring device 2304, such as the storage device 2308 of FIG. 23. Various implementations of the circular buffer generate dynamic endpoints to store and access video data in the circular buffer. The phrase “dynamic endpoint” signifies an endpoint that moves (e.g., a starting endpoint, a stopping endpoint, etc.) Thus, the circular buffer can include a dynamic starting endpoint that signifies the start of a stored video clip and a dynamic stopping endpoint that signifies the end of the stored video clip, where each endpoint dynamically shifts as new video data is added to the circular buffer.

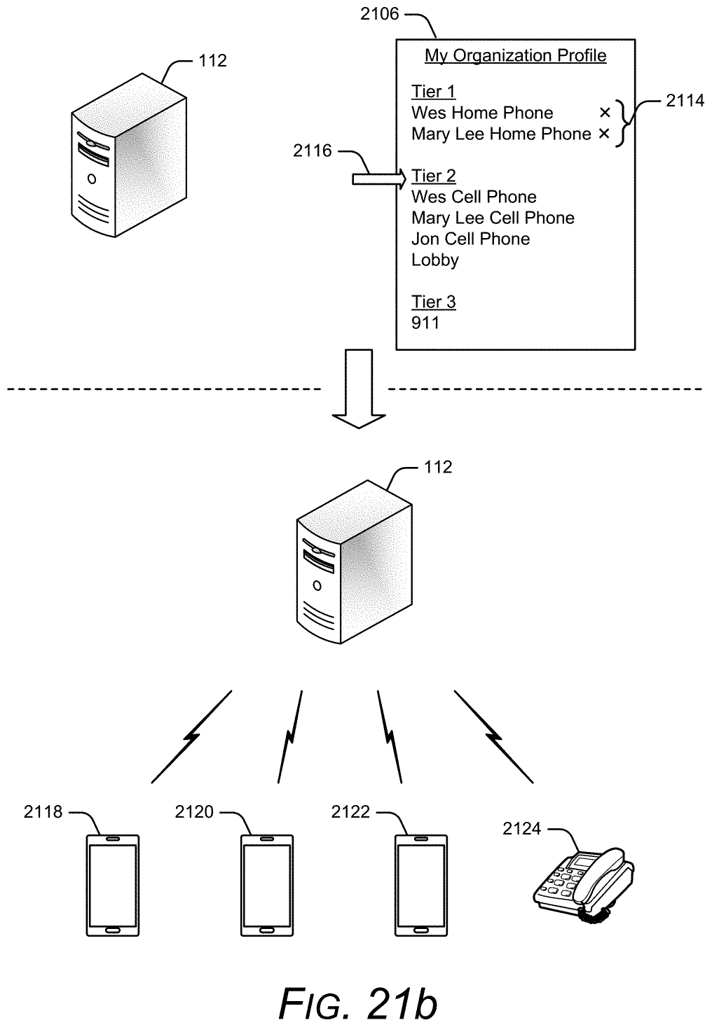

To illustrate, consider now FIG. 25 that illustrates an example circular buffer 2500 with dynamic endpoints in accordance with one or more implementations. Circular buffer 2500 is illustrated at two separate points in time, where circular buffer 2500-1 corresponds to the circular buffer 2500 at a first point in time, and circular buffer 2500-2 corresponds to the circular buffer 2500 at a second point in time. Collectively, circular buffer 2500-1 and circular buffer 2500-2 embody the circular buffer 2500. Accordingly, FIG. 25 demonstrates an example progression of events, where the progression begins in the upper portion of FIG. 25, then moves to the lower portion of FIG. 25.

In the upper portion of FIG. 25, the circular buffer 2500-1 includes “N” video elements, respectively labeled here as video element 2502-1, video element 2502-2, and so forth, up to video element 2502-N, where N is an arbitrary number. Collectively, the video elements progress over time to form a video clip. For example, in some implementations, each video element of the circular buffer 2500 corresponds to an instance of video data acquired by the video monitoring device 2304 from camera 2302 of FIG. 23. Thus, the progression of the video elements stored in the circular buffer 2500 correspond to an excerpt from a video stream generated by the camera 2302 of FIG. 23. Circular buffer 2500-1 has a dynamic starting endpoint 2504 that corresponds to video element 2502-1 and a dynamic stopping endpoint 2506 that corresponds to video element 2502-N. In other words, with respect to the video data stored in circular buffer 2500-1, the video starts with video element 2502-1 and ends with video element 2502-N.

Generally, a video stream corresponds to video data that is continuously delivered. In turn, video monitoring device 2304 can continuously receive and/or extract video data from the camera 2302. As the video monitoring device obtains new video data, various implementations replace old video data in the circular buffer with the new video data. For example, in the upper portion of FIG. 25, video data 2508 corresponds to new video data received by the video monitoring device 2304 from the camera 2302. In implementations, the video monitoring device 2304 replaces the oldest video data in the circular buffer with the newest. With respect to circular buffer 2500-1, video element 2502-1 corresponds to the oldest video data in the circular buffer, and video element 2502-N corresponds to the newest video data in the circular buffer. Accordingly, the video monitoring device replaces the video data content within video element 2502-1 with the video data 2508, such as through the use of the video management module 2306 of FIG. 23.

Moving to the lower portion of FIG. 25, circular buffer 2500-2 includes video data 2508. In circular buffer 2500-2, the content in video element 2502-1 corresponds to the newest video data, and the content in the video element 2502-2 corresponds to the oldest video data. In implementations, the dynamic endpoints of the circular buffer shift and/or move based upon the addition of the newest video data. Here, circular buffer 2500-2 has a dynamic starting endpoint 2510 and a dynamic stopping endpoint 2512. This process repeats itself as new video data is acquired. For instance, the next video data received after video data 2508 will replace the content of the video element 2502-2, and the dynamic starting and stopping endpoints will shift to reflect the new starting and ending positions, etc.

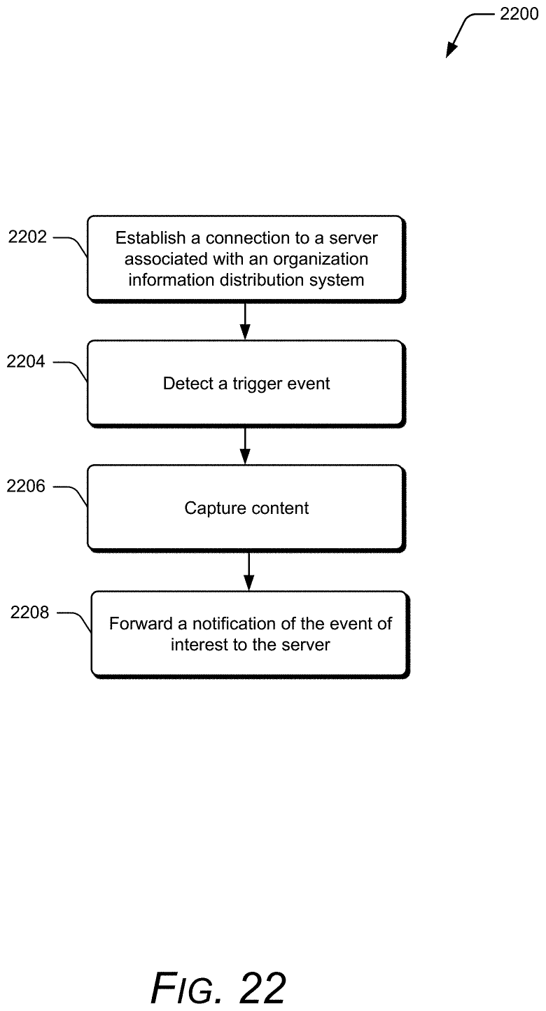

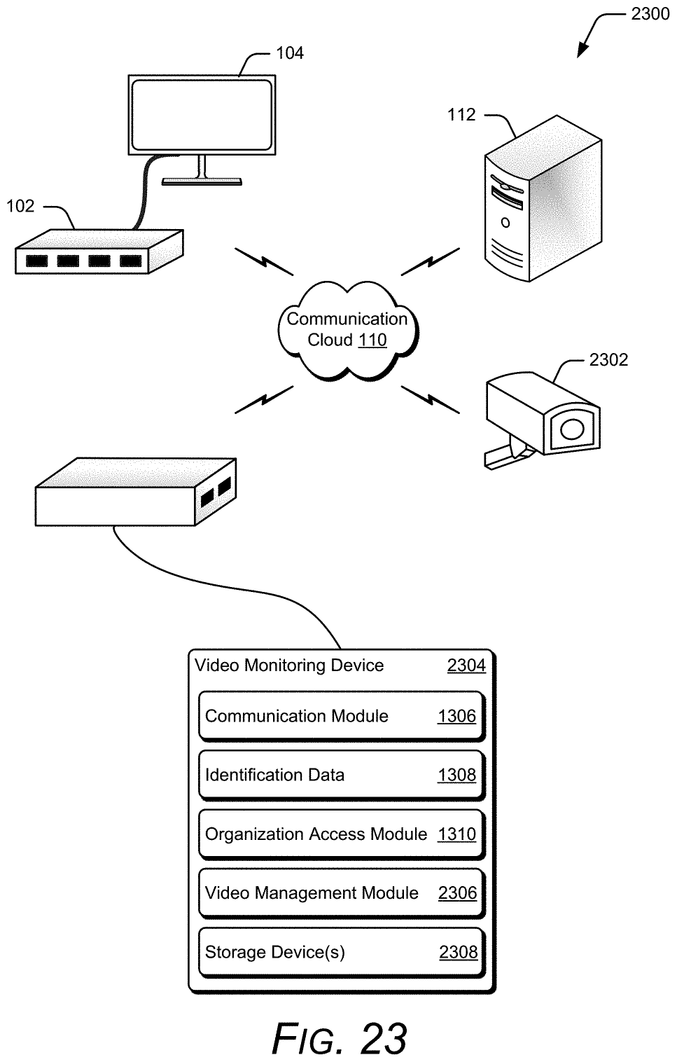

In implementations, the video monitoring device transmits a video clip to the organization information distribution system based upon a trigger event. To demonstrate, consider now FIG. 26 that illustrates an example environment 2600 in which a progression of events implements various aspects of trigger event-based camera captures. The example environment 2600 is represented at two arbitrary points in time that are labeled as example environment 2600-1 and example environment 2600-2. The upper portion of FIG. 26 corresponds to the environment 2600-1, while the lower portion of FIG. 26 corresponds to the environment 2600-1. Collectively, the example environments 2600-1 and 2600-2 embody the example environment 2600.

Environment 2600 includes server 112 of FIG. 1 and video monitoring device 2304 of FIG. 23, where the video monitoring device implements features of the video management module 2306 of FIG. 23. The server and the video monitoring device are communicatively coupled over communication cloud 110 such that the server and the video monitoring device can exchange data with one another, such as trigger events and video clips as further described herein. In environment 2600-1, the video monitoring device 2304 maintains a circular buffer 2602 that corresponds to video data from a live video stream generated by a camera, such as the circular buffers described with reference to FIGS. 24 and 25.

As further described herein, server 112 can provide organization information distribution services across communication cloud 110. In one or more implementations, the server triggers devices to perform actions, such as triggering the video monitoring device 2304 to generate a video clip from the video data stored in circular buffer 2602. In environment 2600-1, server 112 sends a trigger event 2604 to video monitoring device 2304 over communication cloud 110. Trigger event 2604 can be associated with any suitable type of event. For instance, the server 112 can send trigger event 2604 to the video monitoring device in response to receiving a notification of a locked door opening (e.g., FIG. 20), a notification from a motion sensor, (e.g., FIG. 19), a notification of an invocation device being actuated (e.g., FIG. 15), a notification of a power outage (e.g., FIG. 17), and so forth. As further described herein, trigger event 2604 can include any suitable type of information, such as a video stream identifier, a timestamp, a location identifier, a clip duration parameter, and so forth.

In response to receiving trigger event 2604, the video monitoring device extracts an excerpt of video data from circular buffer 2602 to generate a video clip. For example, trigger event 2604 can include a timestamp that indicates the time of an event of interest. Alternately or additionally, the video monitoring device uses a receipt time of the trigger event as a basis for the video clip extraction. In turn, the video monitoring device locates video data in the circular buffer that corresponds to the timestamp. Video element 2606 of the circular buffer 2602 represents the video element in the circular buffer that corresponds to the trigger event timestamp (e.g., a point in time that correlates to an event of interest). The video monitoring device, by way of video management module 2306, locates video element 2606, and extracts video data both prior to video element 2606 and after video element 2608. For example, in response to locating video element 2606, video management module 2306 extracts “M” video elements 2608 prior to the trigger event timestamp, and “N” video elements 2610 after the trigger event timestamp, where “M” and “N” correspond to arbitrary numbers.

In some implementations, the video management module extracts default amounts of video data prior and after the trigger event timestamp, such as default values that specify to extract 10 seconds prior to the trigger event timestamp and 40 seconds after the trigger event timestamp. Alternately or additionally, the video management module can use user-defined and/or customized values, such as through user input to the video monitoring device and/or commands from the server 112. For instance, the video management module can receive a command from the server to update a value of a first extraction amount that designates the number of video elements to extract prior to the trigger event timestamp. Alternately or additionally, the video management module can receive a command from the server to update a value of a second extraction amount that designates the number of video elements to extract after the trigger event timestamp. In turn, the video management module updates the first extraction value and/or the second extraction value, and generates the video clip using the updated extraction values.

By maintaining a circular buffer of video data, the video management module can extract video data that occurs at points in time prior to a trigger event timestamp, thus providing additional information in the resultant video clip relative to conventional techniques that fail to maintain a history of video data. Basing the video clip extraction around a trigger event timestamp also allows the video monitoring device to automatically extract video data relevant to a particular point in time. This automatically provides the user with relevant video clips and alleviates the user from searching through vast amounts of video footage as employed by conventional techniques.

Moving to the lower portion of FIG. 26, the video monitoring device 2304 communicates the video clip 2612 to the server 112 over the communication cloud 110, where the video clip represents a video clip generated from video elements 2608 and video elements 2610. In turn, the server 112 can distribute the video clip 2612 to various devices across an organization information distribution system as further described herein.

While environment 2600 illustrates an example in which the video monitoring device generates and forwards a video clip based on receiving a trigger event, in alternate or additional implementations, the video monitoring device can generate the trigger event that causes generation and/or communication of the video clip. For example, the video monitoring device can include facial recognition algorithms that are used to analyze the video data. The facial recognition algorithms can identify the presence of a person in the video data and/or identify of the person, which can then trigger the generation of a trigger event (and/or the corresponding video clip) that is subsequently communicated to the server 112. For example, the video management module can compare an identity determined by the facial recognition algorithms to a list of authorized personnel for a particular location associated with the video data. In response to determining that an unauthorized person has been identified in the video data, the video management module can generate a trigger event and extract a video clip around the corresponding trigger event timestamp. As another example, the video management module can generate a trigger event-based upon detecting the presence of a person. Alternately or in addition, the video management module can analyze the video data to identify motion that is captured in the images of the video data, and generate the trigger event in response to identifying the motion. Thus, the video monitoring device can generate trigger events based on an analysis of video data.

In some implementations, the video management module can automatically forward video data based upon detecting a disconnected network. Consider an example where the video monitoring device loses connectivity with the communication cloud 110. In implementations, the video monitoring device can determine that a network connection has been disconnected, such as by sending a request for a reply that times out (e.g., a ping). In response to detecting the disconnect, the video management module can cache the video data in the circular buffer to generate stored video data. Thus, the video monitoring device stores video data that has been captured at a time associated with the network connection being disconnected. At an arbitrary point in time later, the video monitoring device can determine that the network connection has been reconnected, and forward the stored video data to the server 112 and/or any other destination computing device that has been designated to receive the video data.

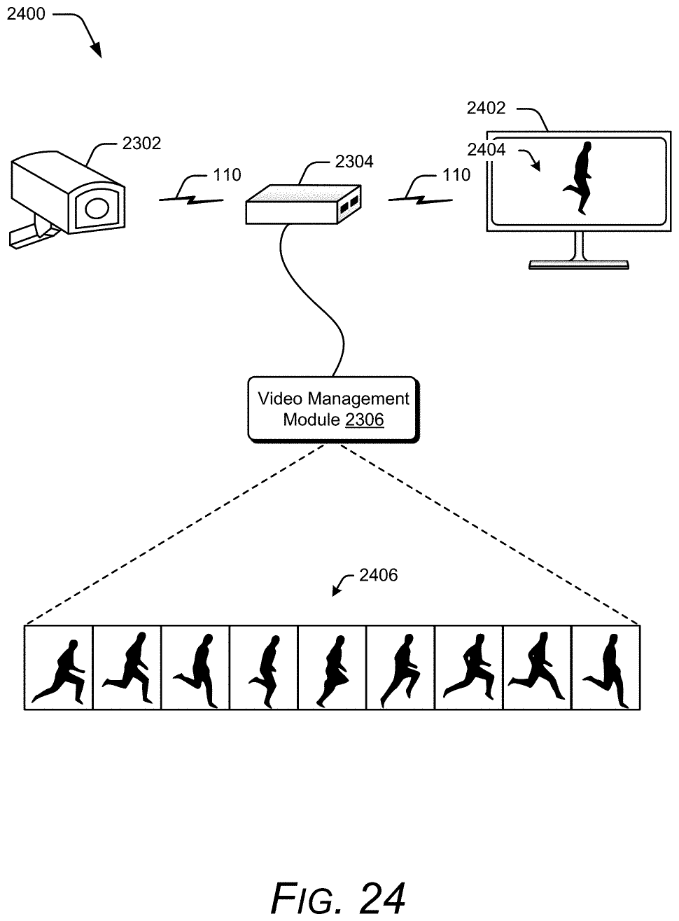

Now consider FIG. 27 that illustrates an example 2700 that illustrates features of trigger event-based camera captures in accordance with one or more implementations. Example 2700 includes content management device 102 and display device 104 of FIG. 1. In implementations, content management device 102 is communicatively coupled to an organization information distribution system as further described herein. Accordingly, the content management device can receive commands and/or content from the organization information distribution system. In this example, the content management device displays two video images: video clip 2702 and live stream 2704. Video clip 2702 generally represents a video clip generate based on a trigger event, such as video clip 2612 as described with reference to FIG. 26. For instance, in receiving video clip 2612, server 112 can distribute the video clip to content management device 102 with a command to continuously play the video clip, such as in a repeating loop.

In some implementations, the content management device can alternately or additionally receive the live stream 2704 from the server 112 and display the live video stream concurrently with the video clip. For example, in response to receiving a trigger event, the video management module 2306 can not only generate a video clip, but also forward live stream video data received, from camera 2302 of FIG. 23, after the trigger event timestamp to the server 112 until a termination command is received. Alternately or additionally, the video management module can forward live stream video data for a predetermined time period and/or until a timeout occurs. Thus, the video monitoring device can forward video clips and live stream data to the organization information distribution system.

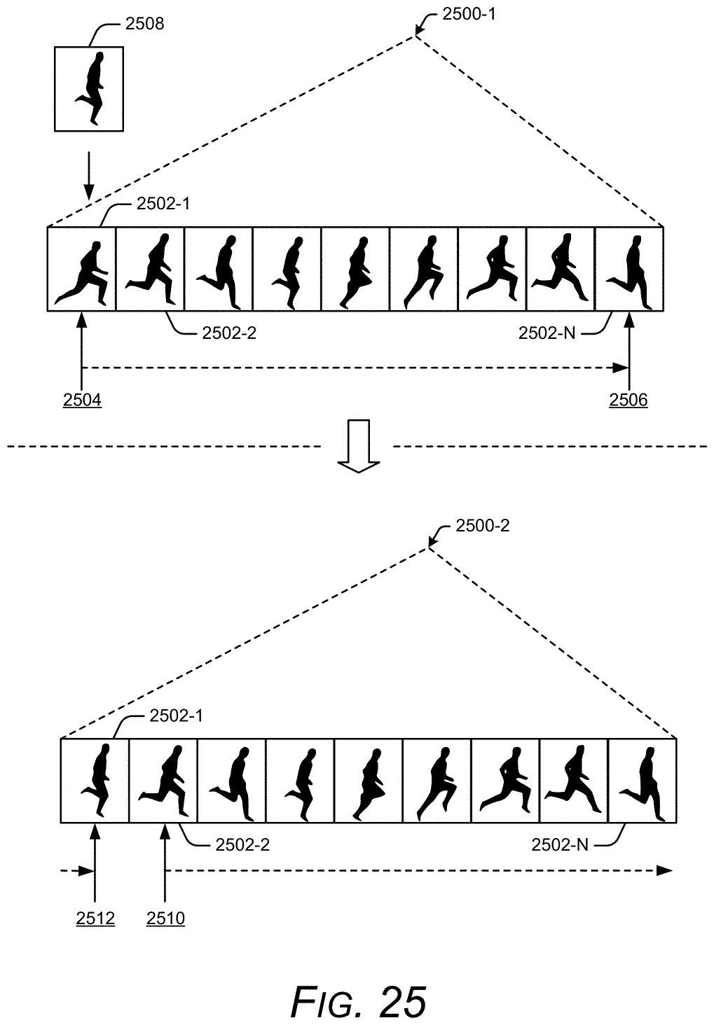

FIG. 28 illustrates an example method 2800 for generating video clips based on trigger events in accordance with one or more implementations. The method can be performed by any suitable combination of hardware, software, and/or firmware. In at least some embodiments, aspects of the method can be implemented by one or more suitably configured hardware components and/or software modules, such as the video management module 2306 of FIG. 23. While the method described in FIG. 28 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 2802, various implementations connect to a camera via a video monitoring device. For example, the video monitoring device 2304 connects to the camera 2302 over the communication cloud 110. In implementations, the video monitoring device 2304 wirelessly communicates with the camera over the communication cloud. Alternately or additionally, the video monitoring device communicates over a wired connection to the camera.

At 2804, video data is obtained from the camera, where the video data is associated with a live video stream. For example, the video monitoring device 2304 obtains video data 2508 of FIG. 25 from the camera 2302 over the communication cloud 110, where the video data 2508 corresponds to the live video stream captured by the camera.

In response to obtaining the video data, various implementations store the video data in a circular buffer at 2806. For example, the video management module 2306 of FIG. 23 maintains circular buffer 2500 of FIG. 25. The video management module 2306 receives the video data 2508 as input, and updates the circular buffer 2500 such that the video data replaces a video element of the circular buffer that stores the oldest video data in the circular buffer. In turn, the video management module 2306 dynamically adjusts the starting endpoint and/or the stopping endpoint of the circular buffer as further described herein.

At 2808, a trigger event is received, where the trigger event is associated with an organization information distribution system. For example, the video management module 2306 of FIG. 23 receives a trigger event 2604 from server 112. In some implementations, the trigger event indicates a point in time that is of interest, such as through a timestamp. As further described herein, the trigger event can correspond to any suitable type of event, such as a switch closure, a door opening, motion detection, etc. Alternately or additionally, the video management module 2306 analyzes the video data 2508 and/or video data stored in the circular buffer 2500 of FIG. 25, and generates the trigger event based upon the results of the analysis (e.g., facial recognition, motion detection, etc.).

In response to receiving the trigger event, various implementations generate a video clip from the video data based on the trigger event at 2810, where the video clip includes video data obtained prior to receipt of the trigger event. For example, the video management module 2306 of FIG. 23 extracts video elements 2608 and video elements 2610 of the circular buffer 2602, where video elements 2608 occur prior to the trigger event and/or a timestamp included in the trigger event, and where video elements 2610 occur at and/or after the trigger event and/or a timestamp included in the trigger event.

At 2812, various implementations transmit the video clip to a destination computing device via an organization information distribution system. For instance, the video monitoring device 2304 of FIG. 23 transmits the video clip 2612 to server 112. In turn, the server 112 distributes the video clip to other devices in the organization, examples of which are provided herein.

Having described aspects of trigger event-based camera captures, consider now a discussion of vape detection trigger events in an organization information distribution system that is in accordance with one or more implementations.

Vape Detection Trigger Events

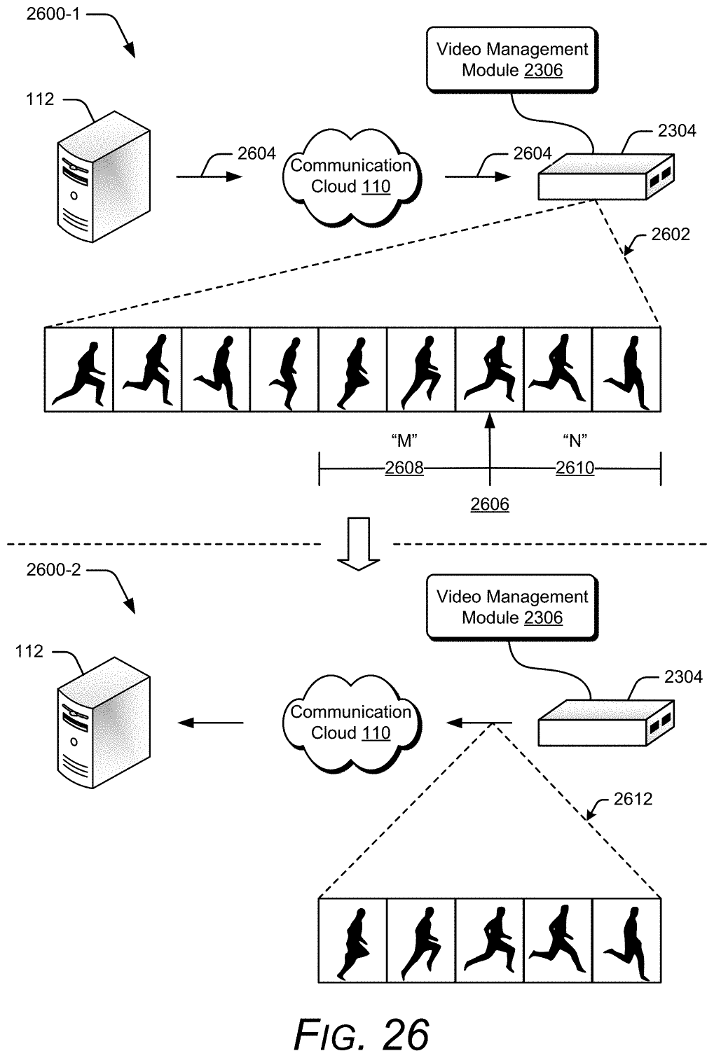

In various implementations, vape detection trigger events can be used in an organization information distribution system to distribute notifications of a vape detection event. To demonstrate, consider now FIG. 29 that illustrates an example environment 2900 that implements aspects of vape detection in an organization information distribution system in accordance with one or more embodiments. The environment described with respect to FIG. 29 can represent a continuation of one or more examples described with respect to FIGS. 1-28. Environment 2900 includes content management device 102, display device 104, and server 112 of FIG. 1 that are communicatively coupled over communication cloud 110.

Environment 2900 also includes a vape detection device 2902 that is communicatively coupled to an organization information distribution system through communication cloud 110. In implementations, the vape detection device 2902 monitors a surrounding area to detect vapors, such as vapors emitted by an e-cigarette. The vape detection device 2902 includes communication module 1306 of FIG. 13 to provide access to communication cloud 110, identification data 1308 of FIG. 13 to include data corresponding to organization information (e.g., unique identifiers, location information, and so forth), and organization access module 1310 of FIG. 13 to include the ability to access functionality specific to the organization information distribution system.

Vape detection device 2902 includes sensor(s) 2904 that generally represent any combination of sensors that can be used to detect chemicals and/or characteristics about an environment surrounding the vape detection device. The detected chemicals and/or characteristics can then be analyzed to determine a type of vapor and/or smoke in the environment (e.g., cigarette, vapor, aerosol, etc.). For instance, sensors 2904 can include any combination of a temperature sensor, a humidity sensor, a volatile organic compound (VOC) sensor, a carbon dioxide (CO2) sensor, a formaldehyde sensor, a metal-oxide sensor, a particle sensor, a nicotine sensor, and so forth. Each sensor can generate sensor data that corresponds to measurements and/or metrics that characterize an environment surrounding the vape detection device. For example, a particle sensor and/or nicotine sensor can use light reflection to identify the presence and/or an amount of various particles included in the surrounding environment. As another example, a humidity sensor can measure a capacitance or resistance of air samples to determine a relative humidity of the environment. In turn, the sensor data generated by the sensors can be analyzed by a vape detection module 2906 to determine when particular vapors are present and/or when the environment matches a particle profile as described herein.

Vape detection device 2902 includes a vape detection module 2906 that can be implemented using any combination of software, firmware and/or hardware. In implementations, vape detection module 2906 collects sensor data generated by the sensors and forwards the sensor data to server 112 for an analysis that determines whether particular vapors, particular smokes, particular aerosols, and so forth, are present, such as an analysis of the sensor data that determines what particles are present in a surrounding area. Alternately or additionally, vape detection module 2906 can analyze the sensor data to determine what particles are present, and forward particle information to the server. As yet another example, vape detection module 2906 can access particle profiles, each of which provides profiles of a respective vapor type, smoke type, aerosol type, and so forth, and determine what particular vapors are present based on the particle profiles.

A particle profile generally corresponds to a profile of a particular vapor type, particular smoke type, particular aerosol type, etc., that identifies a combination of particles and particle amounts that are indicative of the chemical emissions corresponding to the particular vapor type, smoke type, aerosol type, etc. (e.g., vapor X includes 15% humidity, Y particles of chemical A, Z particles of chemical B, etc.). In other words, a particle profile provides a composition profile for a respective vapor type, smoke type, aerosol type, and so forth. The particle profile can list any suitable combination of particles and/or chemicals with a corresponding metric and/or threshold to describe a respective vapor and/or smoke type. This can include using different metrics for the characteristics in the particle profile, such as a particle profile that specifies a percentage for humidity, a number of particles within a specific volume of air for chemical A, a number of particles within the specific volume of air that are greater than a predetermined size (e.g., greater than 2.5 micron, greater than 3.5 micron, etc.) for chemical B, and so forth. In turn, the vape detection module 2906 can compare sensor data from multiple different sensors to the particle profiles as a way to identify the presence of particular vapors and/or smoke. Alternately or additionally, server 112 can access particle profiles in a similar manner, either locally or remotely, to determine the particular vapor type, smoke type, aerosol type, etc. that is present based on identified particles in a surrounding area. By analyzing data from multiple sensors, the vape detection device 2902 can not only detect when particular vapors, but additionally reduce false positives relative to single sensor detection as further described herein.

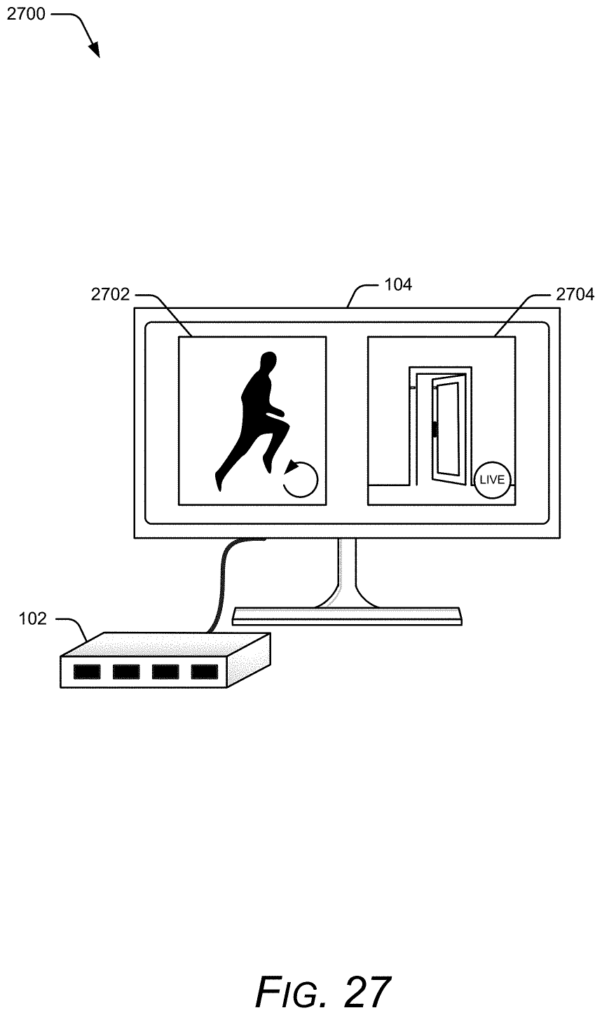

To illustrate, consider now FIG. 30 that illustrates features of vape detection in an organization information distribution system that are in accordance with one or more implementations. The features are illustrated through a progression of events. The upper portion of FIG. 30 illustrates an environment 3000 that corresponds to a first point in time, while the lower portion of FIG. 30 illustrates an environment 3002 that corresponds to a second, arbitrary, point in time later.

Environment 3000 includes the vape detection device 2902 of FIG. 29. In environment 3000, the vape detection device 2902 establishes a connection to the server 112 through the communication cloud 110 of FIG. 1. In implementations, vape detection device 2902 is included in an organization profile, where the vape detection device is registered as a device that sends data and can generate detection events. Accordingly, server 112 can establish a connection to the vape detection device based upon information included in the organization profile. Alternately or additionally, a user can manually configure the vape detection device to access server 112 as further described herein.

The vape detection device 2902 implements features of the vape detection module 2906, such as through any combination of software, hardware, and/or firmware, to detect the presence of vapors and/or smoke, such as vapor from an e-cigarette. For example, some of the sensors 2904 can collect samples of air in a surrounding area, and analyze the samples for particle content. In turn, the sensors generate measurement and/or metrics that characterize various properties of the collected sample, such as temperature, humidity, pressure, particle content, particle amount, etc. Generally, a surrounding area corresponds to a span of space that is accessible to the vape detection device such that sensors can collect a sample of air from that span of space. While FIG. 30 describes an implementation in which vape detection device 2902 and/or vape detection module 2906 detect particle content and/or identify particular vapor types, smoke types, aerosol types, and so forth, alternate implementations can forward sensor data and/or identified particle content to the organization information distribution system for analysis as further described herein.

In environment 3000, the vape detection module 2906 distinguishes between different types of vapor, and generates trigger events in response to detecting particular types of vapor, such as by comparing sensor data to particle profiles. Alternately or additionally, the particle profiles can be used to prevent falsely identifying a particular vapor and/or smoke. Consider a scenario in which the vape detection module 2906 includes a humidity sensor, and detects the presence of water through the humidifier sensor. By analyzing sensor data from particle sensors in addition to sensor data from the humidity sensor, the vape detection module can detect that the environment surrounding the vape detection device does not include any additional particles above threshold values included in a particle profile, and refrains from generating a detection event and/or trigger event.

As another example, the vape detection module can receive sensor data from a formaldehyde sensor that indicates the presence of formaldehyde and/or an amount of formaldehyde present. In turn, the vape detection module can compare the amount of formaldehyde to a threshold value in a particle profile to determine if the surrounding area includes an aerosol-based vapor (e.g., the formaldehyde amount is above the threshold value), or a different type of vapor is present (e.g., the formaldehyde amount is below the threshold value). By analyzing sensor data from a formaldehyde sensor in combination with other sensors, the vape detection module can avoid falsely identifying an aerosol-based vapor as an e-cigarette vapor, thus improving vapor detection accuracy.

In a similar manner, the vape detection module can receive a combination of sensor data from various sensors, and reference a particle profile that indicates what combination and/or amounts of particles correspond to e-cigarette vapor. This can include identifying what particles are not present in the e-cigarette vapor, such as a lack of formaldehyde as further described herein. In response to detecting that particles corresponding to an e-cigarette vapor are present, and/or that there is a lack of a particular particle (e.g., formaldehyde), the vape detection module then generates a trigger event to indicate the detection of the e-cigarette vapor. Thus, the combination of sensor data from multiple sensors, and the use of a particle profile, can not only identify the presence of a particular vapor and/or smoke type, but alternately or additionally prevent falsely identifying other vapor and/or smoke types as the particular vapor and/or smoke type.

In environment 3000, e-cigarette 3004 emits vapor 3006. In turn, the vape detection module 2906 can detect the presence of the vapor by identifying any combination of particles that are present, and/or identifying a lack of particular particles being present, that correspond to e-cigarette vapor. The vape detection module 2906 then generates a trigger event 3008 that is communicated to the server 112 over the communication cloud. The trigger event 3008 can include any suitable type of information, such as date information, time information, location information, a vapor detection device ID, and so forth. In implementations, trigger event 3008 corresponds to a vape detection trigger event.

Moving to environment 3002, the server 112 distributes a notification of the trigger event 3008 across the organization information distribution system. In the environment 3002, this corresponds to distributing an immediate view 3010 to the content management device 102 and/or the display device 104 of FIG. 1. The server 112 also sends an audible alert 3012 to telephone 3014 and an SMS message 3016 to mobile device 3018. In implementations, the server 112 accesses an organization profile to determine which devices receive the notification and/or in what format. This can include identifying particular devices designated to receive vape detection trigger events.

While not illustrated here, the server 112 can alternately or additionally trigger actions from devices, such as triggering a camera capture similar to that described with reference to FIGS. 23-28 by communicating with a video monitoring device that is at a same location as the vape detection device. For instance, the server 112 can extract timestamp information from the trigger event 3008, and request a video clip from a video monitoring device based on the timestamp information. Alternately or additionally, the server 112 can arm a door-camera near the vape detection device to trigger video capture when the door opens as further described herein. By communicating vape detection via an organization information distribution system, users can automatically obtain notifications of when vaping is occurring, obtain location information on where the vaping is occurring, and/or obtain video clips of an area surrounding the location. This can help deter undesired behavior in undesired locations by automating not only the detection process, but the data collection process as well (e.g., a video clip). By triggering a video capture that includes video data prior to a trigger event timestamp, and/or arming an IP camera to capture video on a switch closure as further described herein, users can also automatically obtain information that provides insight into events occurring prior to and/or after the vape being detected (e.g., by a vape detection device and/or via the server). For example, the organization information distribution system can arm a camera outside a bathroom door based on vape being detect inside the bathroom to capture video of persons exiting the bathroom, where video capture can be triggered on motion detection, switches, etc. In some implementations, the organization information distribution system can deploy different trigger events and/or alerts based upon the identified vapor type, smoke type, aerosol type, etc. For instance, a user can configure the organization information distribution system to capture video based on detecting a vapor type, deploy an immediate view based on detecting a spray paint aerosol type, contact a fire department based on detecting a smoke type, etc.

While described in the context of detecting e-cigarette vapors, other vapors and/or smoke can be detected by selecting the corresponding particle profile. For instance, consider a scenario in which a vape detection device includes a first particle profile corresponding to marijuana smoke, a second particle profile corresponding to e-cigarette vapors, a third particle profile corresponding to cigarette smoke, and so forth. In implementations, the vape detection device can be dynamically reconfigured from detecting a first smoke or vapor type to detecting a second smoke or vapor type by selecting different particle profiles as a basis for generating a detection trigger event.

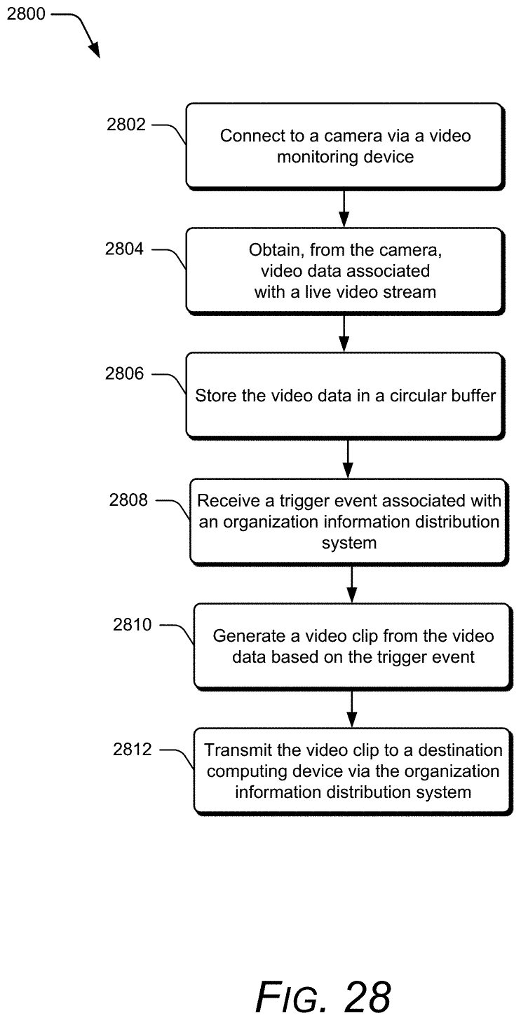

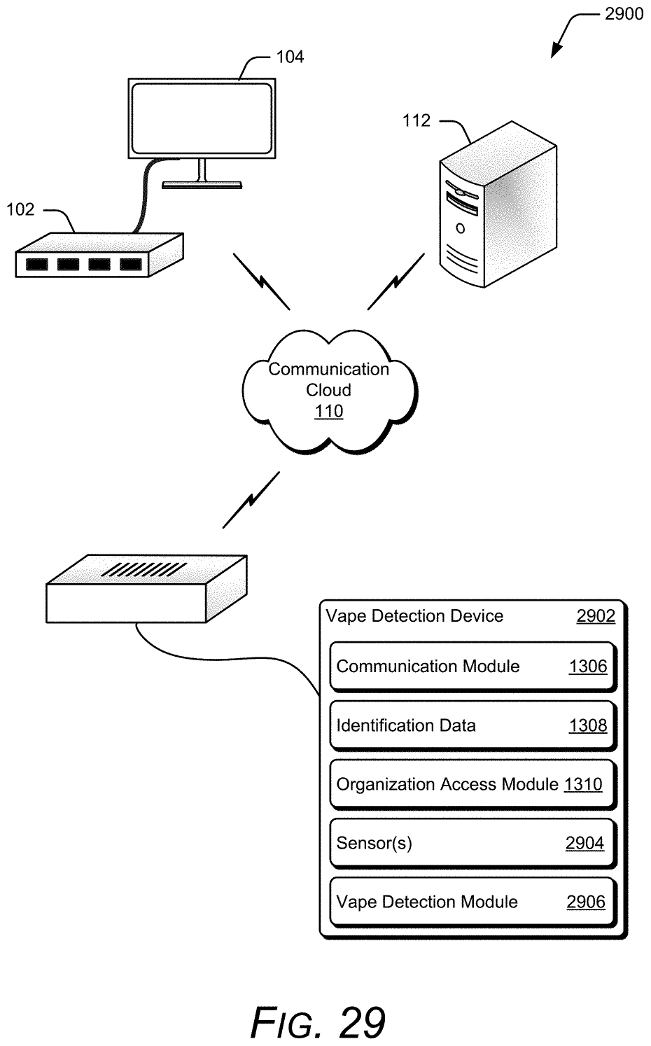

FIG. 31 illustrates an example method 3100 for vape detection trigger events in an organization information distribution system in accordance with one or more implementations. The method can be performed by any suitable combination of hardware, software, and/or firmware. In at least some embodiments, aspects of the method can be implemented by one or more suitably configured hardware components and/or software modules, such as the vape detection device 2902 of FIG. 29. While the method described in FIG. 31 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 3102, a vape detection device is connected to an organization information distribution system. For example, vape detection device 2902 of FIG. 29 connects to server 112 over communication cloud 110 of FIG. 1. In some implementations, the vape detection device can be manually configured to connect to the server, such as through a user manually configuring the vape detection device by connecting input/output peripheral devices to the vape detection device, by accessing a configuration application resident at the video monitoring device, by sending commands over the communication cloud, etc. Alternately or additionally, a user can add a network address of the vape detection device to an organization profile managed by server 112, and server 112 can establish a connection with the vape detection device based on the organization profile.

In response to connecting the vape detection device to the organization information distribution system, various implementations monitor, via the vape detection device, a surrounding area for vapor at 3104. For example, the vape detection device 2902 can utilize vape detection module 2906 to sample and test a surrounding area by collecting air samples, and analyzing the air samples to determine a particle content of the air. Accordingly, at 3106, various implementations detect the vapor, such as a particular vapor identified as being associated with an e-cigarette. For instance, the vape detection device 2902 utilizes vape detection module 2906 to detect vapor 3006 of FIG. 30, and determines that vapor 3006 originates from e-cigarette 3004 based on a particle analysis. In some implementations, the vape detection module 2906 performs the detection analysis that identifies a type of vapor, smoke, aerosol, etc. through an analysis of particle content and/or particle profile at the vape detection device. Alternately or additionally, the vape detection device 2902 forwards the particle detection information to a remote server, such as server 112, to perform the detection analysis.

In response to detecting the vapor, a trigger event is generated at 3108, such as the vape detection device 2902 generating trigger event 3008. The trigger event can include any suitable type of information associated and/or utilized by an organization information distribution system, examples of which are provided herein. In implementations, the trigger event corresponds to a vape detection trigger event. At 3110, the trigger event is communicated to the organization information distribution system, such as by vape detection device 2902 communicating trigger event 3008 to server 112 over communication cloud 110.

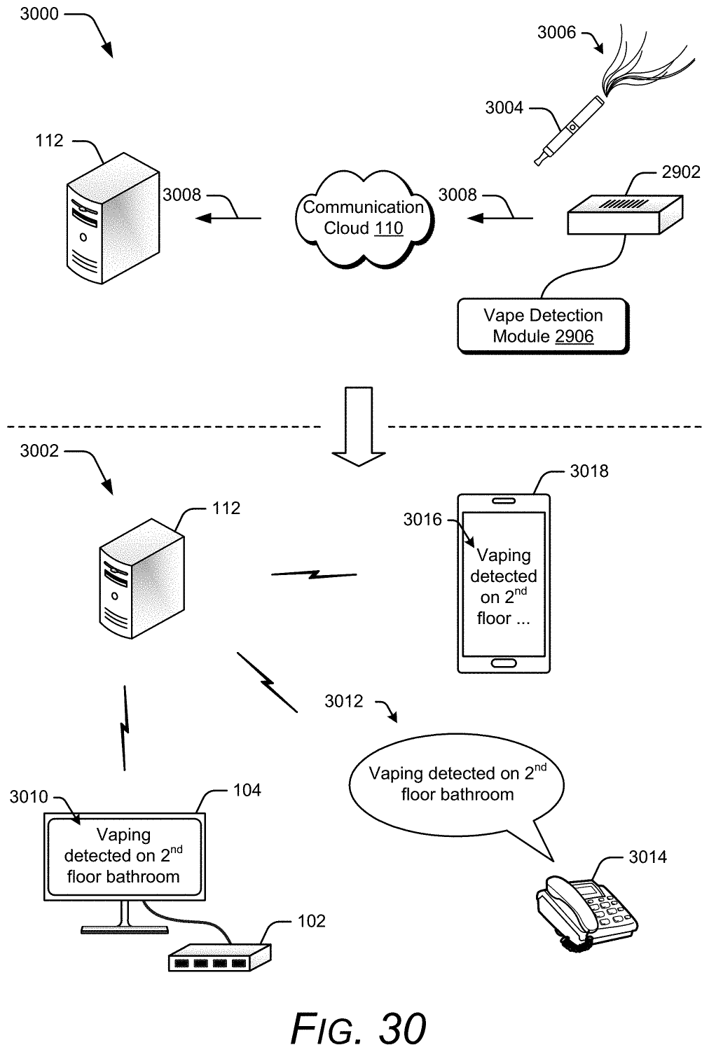

FIG. 32 illustrates an example method 3200 for vape detection trigger events in an organization information distribution system in accordance with one or more implementations. The method can be performed by any suitable combination of hardware, software, and/or firmware. In at least some embodiments, aspects of the method can be implemented by one or more suitably configured hardware components and/or software modules, such as server 112 of FIG. 1. While the method described in FIG. 32 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 3202, a connection between a vape detection device and an organization information distribution system is established. For example, server 112 can establish a connection to vape detection device 2902 of FIG. 29 over communication cloud 110 of FIG. 1. In some implementations, a user adds a network address of the vape detection device to an organization profile managed by server 112, and server 112 establishes a connection with the vape detection device based on the organization profile. Alternately or additionally, the user manually configures vape detection device 2902 to connect to server 112, such as by connecting input/output peripheral devices to the vape detection device, by accessing a configuration application resident at the video monitoring device, by sending commands over the communication cloud, etc.

In response to establishing a connection between the vape detection device and the organization information distribution system, various implementations receive a vape detection trigger event from the vape detection device at 3204 and/or a service performing the detection analysis. For example, server 112 receives trigger event 3008 from the vape detection device 2902 over communication cloud 110, where trigger event 3008 corresponds to a vape detection trigger event.

In response to receiving the trigger event, a notification of the vape detection trigger event is deployed across the organization distribution information system at 3206. Server 112, for instance, deploys immediate view 3101 to content management device 102, audible alert 3012 to telephone 2014, and/or SMS message 3016 to mobile device 3018. Thus, deploying the notification includes deploying notifications in multiple formats. In some implementations, server 112 analyzes an organization profile to determine what devices to deploy the notification to and/or what format to deploy as further described herein. Alternately or additionally, the server 112 extracts information from the vape detection trigger event, such as location information, and includes the extracted information in the notification.

Having described aspects of vape detection trigger events, consider now a discussion of deploying real-time messaging in an organization information distribution system that is in accordance with one or more implementations.

Real-Time Messaging in an Organization Information Distribution System

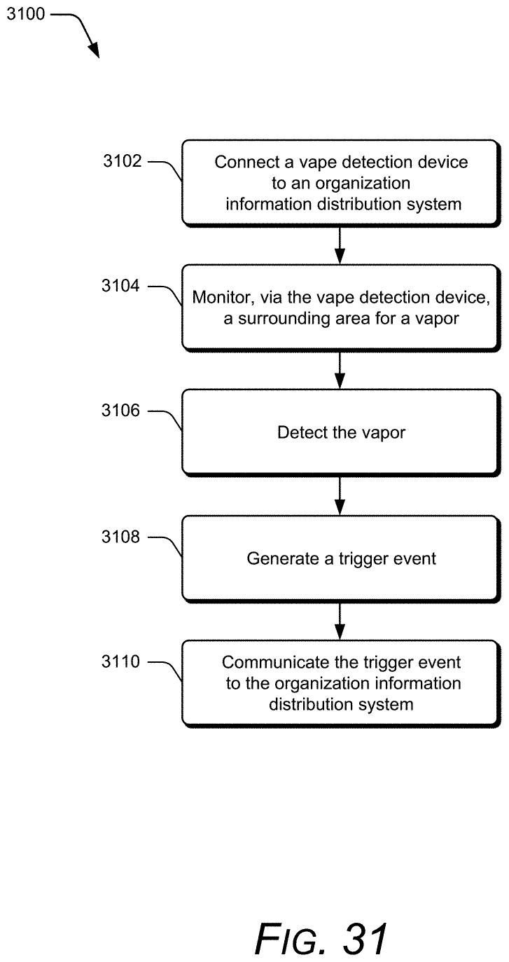

In various implementations, real-time messaging can be deployed across an organization information distribution system through the use of a navigation module and/or application at a remote device. To demonstrate, consider now FIG. 33 that illustrates an example environment 3300 in which features of real-time messaging are implemented in accordance with one or more embodiments. The environment described with reference to FIG. 33 can represent a continuation of one or more examples described with respect to FIGS. 1-32. Environment 3300 includes content management device 102, display device 104, and server 112 of FIG. 1 that are communicatively coupled over communication cloud 110.

Environment 3300 also includes a computing device 3302 that is communicatively coupled to an organization information distribution system through communication cloud 110. While illustrated in environment 3300 as a laptop, it is to be appreciated that computing device 3302 can be other types of computing devices as well, such as a desktop computer, a smart watch, a tablet, a mobile phone, and so forth. In implementations, the computing device 3302 can be used to propagate real-time messaging across the organization information distribution system. The computing device 3302 includes communication module 1306 of FIG. 13 to provide access to communication cloud 110.

The computing device 3302 also includes a navigation module 3304 that generally represents an ability to navigate across a network via the computing device. In one or more implementations, the navigation module 3304 represents a web browser that can receive destination network addresses, and navigate to the destination network addresses. Alternately or additionally, the navigation module 3304 corresponds to a stand-alone application, such as a client control application that can access a particular organization information distribution system.

Navigation module 3304 renders a user interface 3306 that includes control 3308. In environment 3300, the navigation module has navigated to a web page corresponding to a communication page of a particular organization information distribution system. Some implementations provide the user with access to the communication page after the user has entered the proper authentication information (e.g., a username, a password, etc.). On the user interface 3306, control 3308 represents a text field in which a user can enter text data. When actuated, control 3308 causes the text data to be communicated to server 112 over the communication cloud 110. In turn, server 112 distributes the text data across the organization information distribution system as further described herein, such as to content management device 102 and/or display device 104.

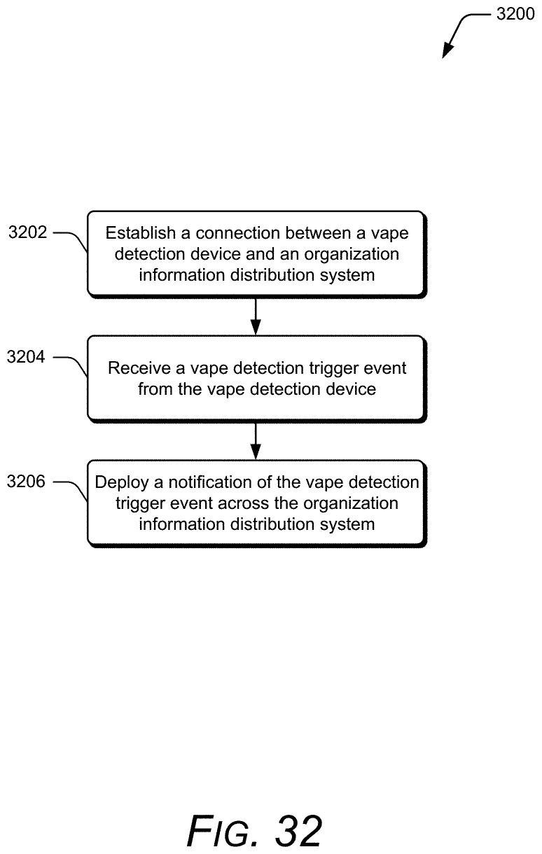

To illustrate, consider now FIG. 34 that illustrates an environment 3400 in which features of real-time messaging in an organization information distribution system can be implemented in accordance with one or more embodiments. The environment described with reference to FIG. 34 can represent a continuation of one or more examples described with reference to FIGS. 1-33.

Environment 3400 includes computing device 3302 of FIG. 33, where the computing device implements features of navigation module 3304 through any combination of software, firmware, and/or hardware. In environment 3400, the computing device has navigated to a web page 3402 via the navigation module, where the web page establishes a connection to a particular organization information distribution system. However, in alternate or additional implementations, the connection can be established through a client control application as further described herein. Computing device 3302 generally represents an arbitrary computing device that may, or may not, be listed in an organization profile of the organization information distribution system. Thus, various implementations provide an unregistered computing device (e.g., not identified in an organization profile of the organization information distribution system) with access to various features of the organization information distribution system. This access can be controlled access, such as through the use of authentication procedures. For example, the web page 3402 can include controls associated with a username and a password, where a user enters corresponding input. The computing device 3302 can communicate the username and password to server 112. In turn, the organization information distribution system can authenticate the username and password to grant or deny computing device 3302 access to the organization information distribution system via the web page 3402. However, it is to be appreciated that other types of authentication information can be employed without departing from the scope of the claimed subject matter.

The web page 3402 includes control 3404 that corresponds to a text field where, similar to that described with reference to control 3308 of FIG. 33, a user can enter text data to distribute across an organization information distribution system in real-time. The phrase “real-time” is used to indicate that the text data is transmitted by the system upon initiation, which can include some real-word delays due to hardware and/or network efficiencies. In the environment 3400, a user has entered text data 3406 into control 3404.

The web page 3402 also includes control 3408 and control 3410, each of which provide access to configuring who receives the real-time message in the organization information distribution system. For example, in response to receiving input that actuates control 3408, the computing device 3302, by way of navigation module 3304, can forward a real-time message trigger event 3412 to server 112 over communication cloud 110. The real-time message trigger event can include any type of information, such as text data 3406 and an indication to distribute the text data to every device in the corresponding organization profile.

Control 3410 allows a user to selectively distribute the real-time message to particular devices in the organization information distribution system. In response to receiving input that actuates control 3410, various implementations can display a list of devices that can be selected and/or deselected to receive the real-time message. In turn, the computing device 3302, by way of navigation module 3304, generates and transmits real-time message trigger event 3412, where the real-time message trigger event includes the text data 3406 and an indication or list of recipient devices of the real-time message. In implementations, the web page 3402 can also include a control 3414 that allows a user to cancel out of sending a real-time message across the organization.

In response to receiving the real-time message trigger event 3412, server 112 distributes the real-time message across the organization information distribution system. For example, the server 112 can deploy the text data as an immediate view 3416 to content management device 102 and/or display device 104. As another example, the server 112 can use text-to-speech algorithms to generate audible alert 3418, and deploy the audible alert to a telephone 3420. Alternately or additionally, the server 112 deploys an SMS text message 3422 to a mobile device 3424. In various implementations, the server 112 determines which devices to communicate the real-time message to based on an organization profile. Alternately or additionally, the real-time message trigger event can designate the recipients as further described herein.

The deployment of real-time messages throughout an organization information distribution system allows a user to quickly disseminate accurate information to multiple devices. By providing web access, the organization information distribution system provides the user with an ability to communicate real-time messages across the organization information distribution system using generic applications (e.g., applications not associated with the organization information distribution system). This provides additional flexibility to the user, which can be paramount in times of urgency.

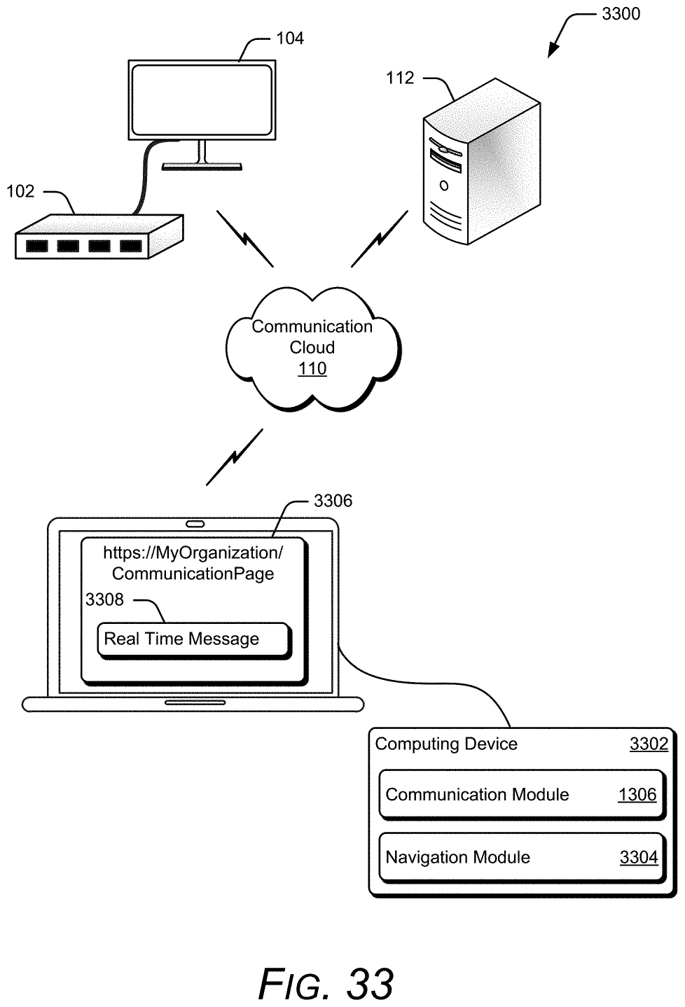

FIG. 35 illustrates an example method 3500 for deploying real-time messages in an organization information distribution system in accordance with one or more implementations. The method can be performed by any suitable combination of hardware, software, and/or firmware. In at least some embodiments, aspects of the method can be implemented by one or more suitably configured hardware components and/or software modules, such as the server 112 of FIG. 1. While the method described in FIG. 35 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 3502, a request for remote access to an organization information distribution system is authenticated. For example, the server 112 of FIG. 1 can host web page 3402 of FIG. 34 to provide remote access into the organization information distribution system. Alternately or additionally, the server 112 hosts a default authentication web page that is provided to unauthorized computing device. In implementations, the server 112 stores and delivers markup language files that are consumable by generic applications and/or web browsers to render web page 3402, the default authentication web page, etc. The server 112 receives authentication information over communication cloud from a remote computing device, such as the username and password, and authenticates the combination to verify that the remote computing device (e.g., computing device 3302) has authority to access the organization information distribution system. In response to authenticating the request, various implementations provide the remote access to the organization information distribution system at 3504, such as by providing a variation of web page 3402 that includes controls associated with features of the system, such as real-time messaging. For example, server 112 distributes the markup files associated with web page 3402 in response to authenticating the request as being valid.

At an arbitrary point in time later, a real-time message trigger event is received at 3506. For example, a user enters text data 3406 into control 3404 of web page 3402 as illustrated and described with referenced to FIG. 34. Computing device 3302, by way of navigation module 3304, receives input that actuates control 3408 and/or control 3410. In response to the input, the computing device communicates the text data to server 112 through the use of real-time message trigger event 3412. In turn, the server 112 receives the real-time message trigger event, such as over communication cloud 110.

At 3508, the real-time message is distributed to devices of the organization information distribution system. The server 112, for instance, distributes the real-time message to content management device 102, telephone 3420, and mobile device 3424. Thus, distributing the real-time message can include distributing the real-time message in varying formats, such as an audible version of the real-time message to a first device, an SMS text message version to a second device, an immediate view to a third device, and so forth.

Having described aspects of deploying real-time messaging in an organization information distribution system, consider now a discussion of test modes in accordance with one or more implementations.

Test Modes in an Organization Information Distribution System

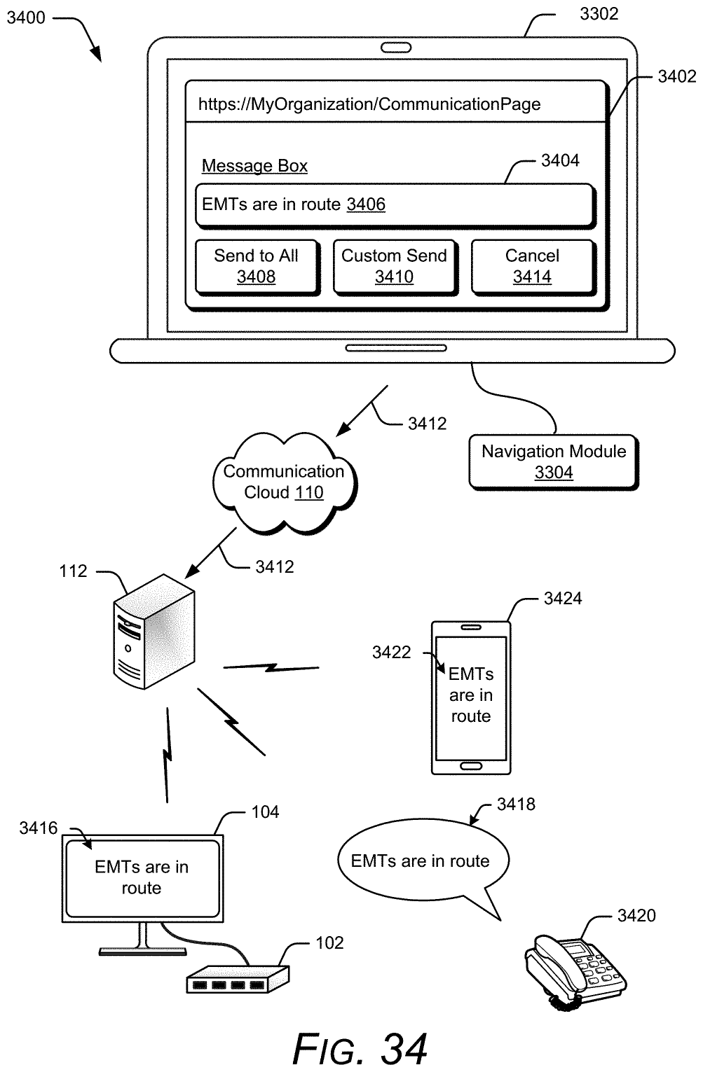

In various implementations, an organization information distribution system can selectively place devices within the organization information distribution system into a test mode. To demonstrate, consider now FIG. 36 that illustrates an example environment 3600 in which features of test modes in an organization information distribution system are implemented in accordance with one or more embodiments. The features are illustrated through a progression of events. The upper portion of FIG. 36 illustrates an environment 3600 that corresponds to a first point in time, while the lower portion of FIG. 36 illustrates an environment 3602 that corresponds to a second, arbitrary, point in time later. The features described with reference to FIG. 36 can represent a continuation of one or more examples described with respect to FIGS. 1-35.

Environment 3600 includes computing device 3202 of FIG. 32 that renders user interface 3604. In environment 3600, the user interface generally represents access to the organization information distribution system. In at least one implementation, user interface 3604 corresponds to a remote administrator user interface that accesses administrator functionality of the organization information distribution system (e.g., restricted functionality provided to an administrator and not others). Here, the phrase “remote administrator user interface” signifies a user interface that exposes administrative access and is rendered on computing devices that are remote from, and/or without specific software applications associated with, the organization information distribution system, such as through the use of a generic web browser. However, it is to be appreciated that user interface 3604 can alternately or additionally be rendered by software applications specific to the organization information distribution system and/or by a computing device that is part of the organization information distribution system. In implementations, the user interface 3604 exposes the corresponding functionality to additional users that are not administrator users.

User interface 3604 provides access to test mode functionality within the organization information distribution system. When operating in a test mode, the organization information distribution system disseminates information using test mode procedures. For instance, various implementations operating in test mode append additional information, such as “This is a test message”, to the disseminated information. Alternately or additionally, various implementations disable functionality while operating in test mode. For example, when operating in test mode, the organization information distribution system can disable sending messages to first responders, disable cloud-based services, disable real-time messages, disable sending action commands (e.g., enable/disable switches, arming a camera, etc.).

In environment 3600, user interface 3604 presents controls that enable and disable test mode functionality based on zones. Zones generally correspond to a particular grouping of devices, such as grouping by location, grouping by owner, grouping by discipline (e.g., marketing, R&D, manufacturing), and so forth. In various implementations, an administrator can define and/or create the zones such that zones are user-defined. For discussion purposes, user interface 3604 displays two zones: Zone A and Zone B, each of which correspond to a respective grouping of devices, but alternate implementations can include any number of zones and/or include controls to define the zones.

User interface 3604 also includes respective controls for each zone that can be used to enable and disable test modes. For example, radio button 3606 has been selected, thus designating that Zone A is configured to operate in active mode. Conversely, radio button 3608 has been selected, thus designating that Zone B is configured to operate in test mode. In various implementations, a user interface can include more controls to configure how the organization information distribution system operates when in test mode, such as individual device selection controls, select-all devices controls, what functionality to operate in test mode, and so forth. In turn, computing device 3302 can communicate the test mode configurations to the organization information distribution system, examples of which are provided herein.

Moving to the lower portion of FIG. 36, environment 3602 includes server 112 of FIG. 1 that is used to disseminate information as further described herein. In response to the test mode configuration changes made in environment 3600, the server 112 communicates with devices in the organization information distribution system differently. To illustrate, the organization information distribution system groups mobile device 3610 and content management device 3612 into Zone A, and telephone 3614 and content management device 3616 into Zone B. Since Zone A has been configured to operate in active mode, the server 112 transmits an active mode message 3618 that represents an example communication transmitted across the organization information distribution system. Conversely, server 112 transmits test mode message 3620 to Zone B since Zone B has been designated to operate in test mode. Thus, in this example, test mode message 3620 includes additional information that indicates the message is a test mode message: “*** THIS IS A TEST MESSAGE ***”. Accordingly, telephone 3614 receives an audible alert that includes the content of test mode message 3620, while content management device 3616 renders the content on a display.

In implementations, the content management device alters how content is rendered for test mode messages and/or when operating in test mode. For instance, content management device 3612 renders the content of active mode message 3618 while content management device renders test mode message 3620. The active mode message 3618 and the test mode message 3620 each include main content (e.g., “March Madness Party in the Cafeteria”) that is rendered on a respective display. The test mode message 3620, however, includes additional test mode content (e.g., *** THIS IS A TEST MESSAGE ***”). While the test mode message is illustrated as a message that appends the test mode content to the main content, it is to be appreciated that alternate formats can be utilized to indicate a test mode message. For instance, in lieu of, or in addition to, appending test mode content to main content, the test mode message can include a message identifier and/or flag that the content management device 3616 uses to determine that the received message is a test mode message. In response to identifying the received message as a test mode message, content management device 3616 can render the main content in a manner similar to the main content rendered by content management device 3612, and overlay the test mode content on the main content. For example, the overly of the text mode content can be partially opaque to provide additional visual indications that the displayed content corresponds to test mode content. This allows the organization information distribution system to test select devices, and notify potential recipients of the messages when the message is a test.

Having described aspects of test modes in an organization information distribution system, consider now a discussion of client control applications in accordance with one or more implementations

Client Control Applications

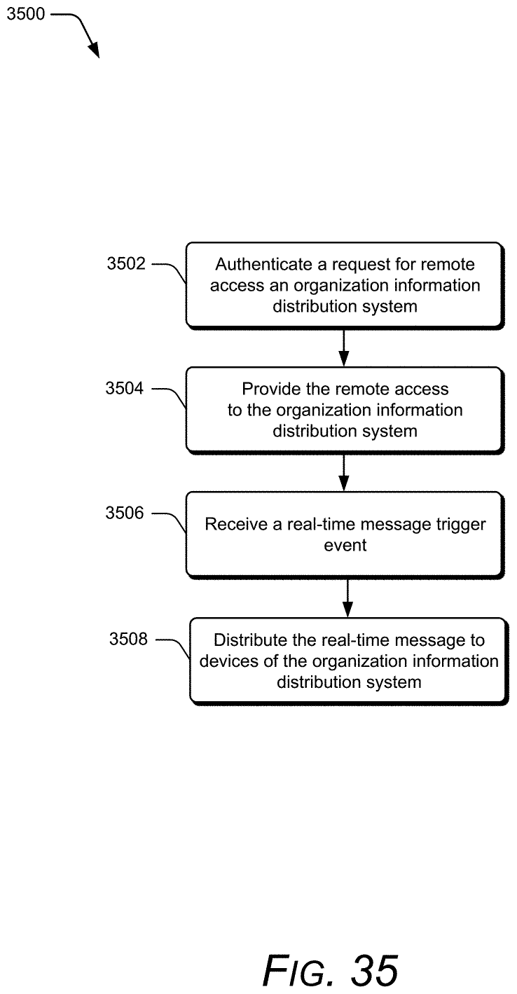

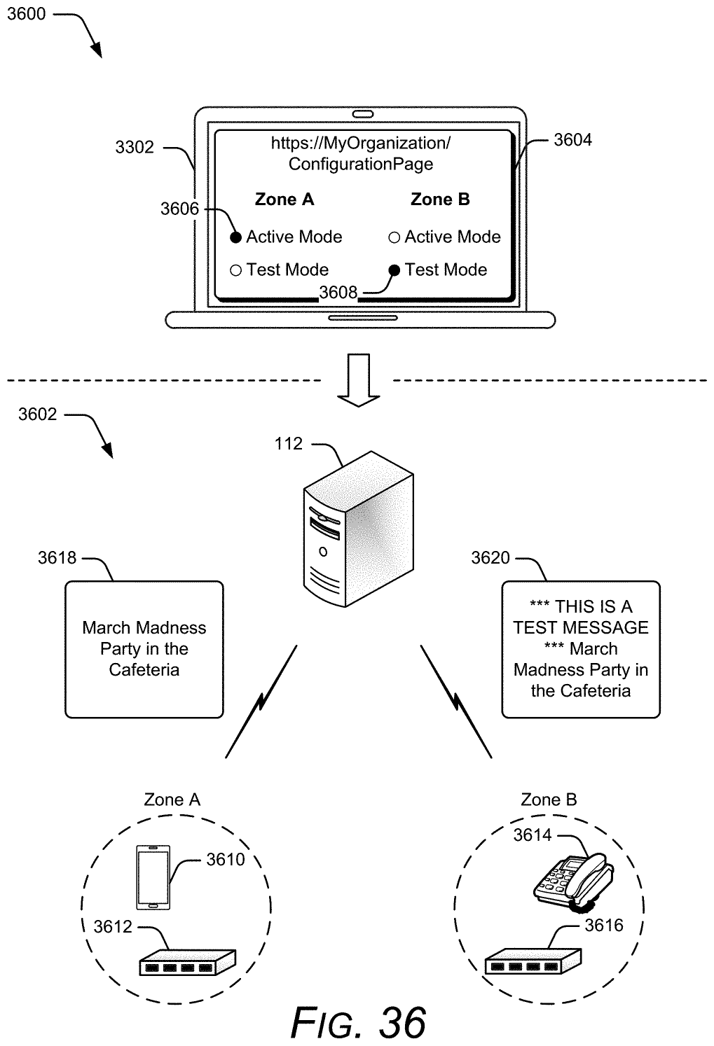

In various implementations, a client control application provides remote control of an organization information distribution system. To demonstrate, consider now FIG. 37 that illustrates an example environment 3700 that can be used to implement features of client control applications in accordance with one or more embodiments. The environment described with reference to FIG. 37 can represent a continuation of one or more examples described with reference to FIGS. 1-36. Environment 3700 includes content management device 102, display device 104, and server 112 of FIG. 1 that are communicatively coupled over communication cloud 110.

Environment 3700 also includes computing device 3702 that generally represents any suitable type of user computing device, such as a desktop computer, a smart watch, a tablet, a laptop, and so forth. In environment 3700, computing device 3702 is represented as a mobile phone that is communicatively coupled to an organization information distribution system through communication cloud 110. The computing device 3702 includes communication module 1306 of FIG. 13 to provide access to communication cloud 110.

Computing device 3702 also include client control module 3704 that generally represents a client-side application that provides remote control of an organization information distribution system. For example, various implementations generate the client control module as a mobile phone application for a smart phone. In response to invocation by a user, the client control module can establish a connection with server 112 and/or provide authentication information over communication cloud 110. The user can manually enter authentication information once, at which point the client control module 3704 saves and reuses the authentication information at future points in time. Alternately or additionally, the client control module requests authentication at each invocation. Client control module 3704 can be implemented in software, hardware, firmware, or any combination thereof. In some implementations, the client control module 3704 is implemented as a stand-alone application that resides and executes at computing device 3702. Alternately or additionally, client control module 3704 can be implemented as part of a cloud-based application, where server 112 hosts server-side functionality that supports client-side functionality implemented by client control module 3704 as further described herein.

Client control module 3704 renders user interface 3706 on the computing device, where the user interface includes controls to provide access to various features of the organization information distribution system. For example, control 3708 provides a user with access to a feature that deploys a particular playlist across the organization information distribution system. Control 3710 provides access to playlist playback control features, such as the ability to pause, rewind, and/or forward playback of a playlist being deployed across the organization information distribution system. Control 3712 provides access to playlist configuration features, such as adding and/or removing content from a playlist. While user interface 3706 illustrates a particular combination of controls and features of the organization information distribution system, it is to be appreciated that any other combination of controls and/or features can be accessed via the client control module, such as the features and/or controls described with reference to at least FIGS. 9a-9j.

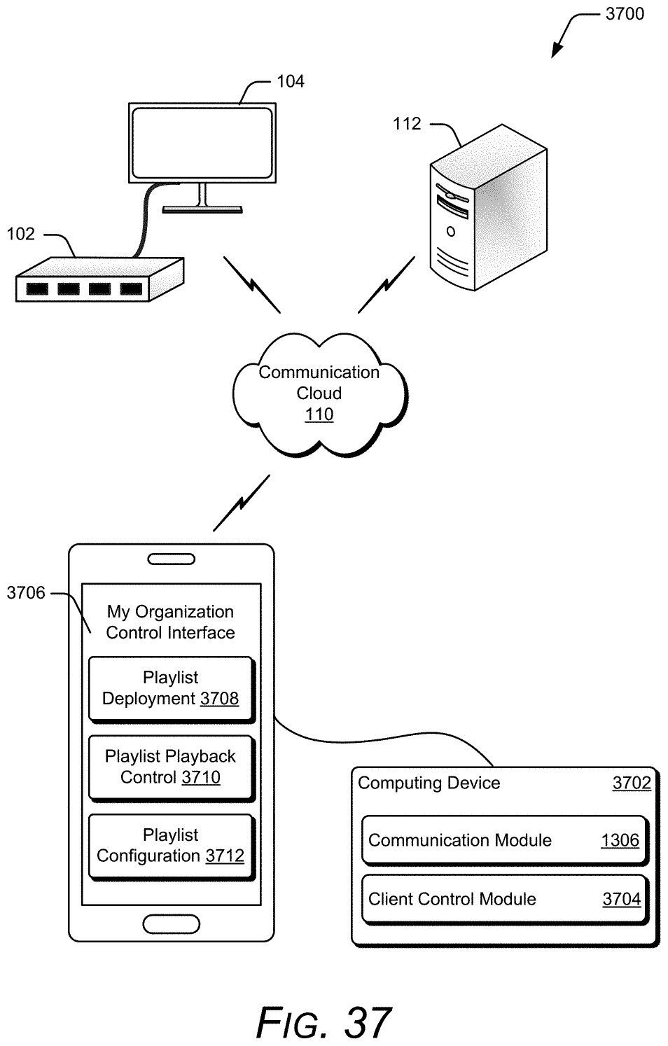

To demonstrate, consider now FIG. 38 that illustrates an example environment 3800 that can be used to implement features of a client control application that are in accordance with one or more implementations. In various implementations, the discussion with respect to environment 3800 can be considered a continuation of one or more examples described with respect to FIGS. 1-36. Environment 3800 includes computing device 3702 of FIG. 37 that is communicatively coupled to server 112 of FIG. 1 over communication cloud 110. In implementations, computing device 3702 implements features of client control module 3704, such as through software, hardware, firmware, or any combination thereof.

Client control module 3704 provides access into features of an organization information distribution system, where, in environment 3800, server 112 manages the organization information distribution system. Accordingly, client control module 3704 establishes a connection to the server and renders user interface 3802 to expose corresponding features supported by server 112. For example, control 3804 corresponds to deploying a playlist entitled “March Schedule” across the organization information distribution system, while control 3806 corresponds to deploying a “Sports Schedule” playlist. Similarly, control 3808 corresponds to deploying an “Academic Honors” playlist. The actuation of each control invokes a particular action at the organization information distribution system.

Various implementations provide a user with one-click remote access to the organization information distribution system. To demonstrate, consider user interface 3802 that renders control 3804, control 3806, and control 3808. A user can deploy a particular playlist by actuating one of these controls with a single user input. Implementations of the client control module 3704 automatically determine which controls to render and/or what features to expose. For instance, after authentication, the client control module can query the server 112 over communication cloud 110 for a list of features, such as the most often invoked features by a user within a predetermined threshold (e.g., top three, top five, etc. associated with a particular user profile). In turn, the server can determine and return each of the features in the list. Alternately or additionally, the client control module can track usage information locally by monitoring user interactions with the user interface 3802, and render controls based upon the usage information. However, a user can also manually navigate to control 3804, control 3806, and/or control 3808 to access desired features.

In this example, the user interface 3802 of client control module 3704 renders three controls, each of which corresponds to deploying a respective playlist across the organization. In turn, a user can enter a single action, e.g., actuating control 3804, control 3806, or control 3808, to deploy a playlist. The client control module can alternately or additionally determine to expose other types of features as well, such as playlist configuration, real-time messaging controls, scheduling configuration, view creation, device management, and so forth. Similar to controls 3804, control 3806, and control 3808, the client control module can select the types of actions to expose in user interface 3802 based on a user history and/or actions preferred by the user based on statistical analysis. Alternately or additionally, the client control module provides a user with an ability to navigate to particular features.

In response to user 3810 actuating control 3806, the client control module communicates a control request 3812 to the server 112 over the communication cloud, where the control request indicates the “Academic Honors” playlist and the control action “deploy playlist”. However, other types of information can be included in the control request as well (e.g., timestamp, location, user identification, computer identification, etc.). In implementations, the client control module generates control request 3812 as a trigger event as further described herein. Alternately or additionally, the control request 3812 can correspond to client control module 3704 invoking an API at the server to initiate deployment of a particular playlist. In implementations, the client control module passes parameter(s) into the API that specify a particular playlist to deploy. In yet another example, the control request 3812 can correspond to the client control module invoking cloud-based services hosted at a server.

In response to receiving the control request, server 112 deploys the corresponding playlist to devices across the organization information distribution system, such as immediate view 3814 at content management device 102-1 and/or display device 104-1, and immediate view 3816 at content management device 102-2 and/or display device 104-2.

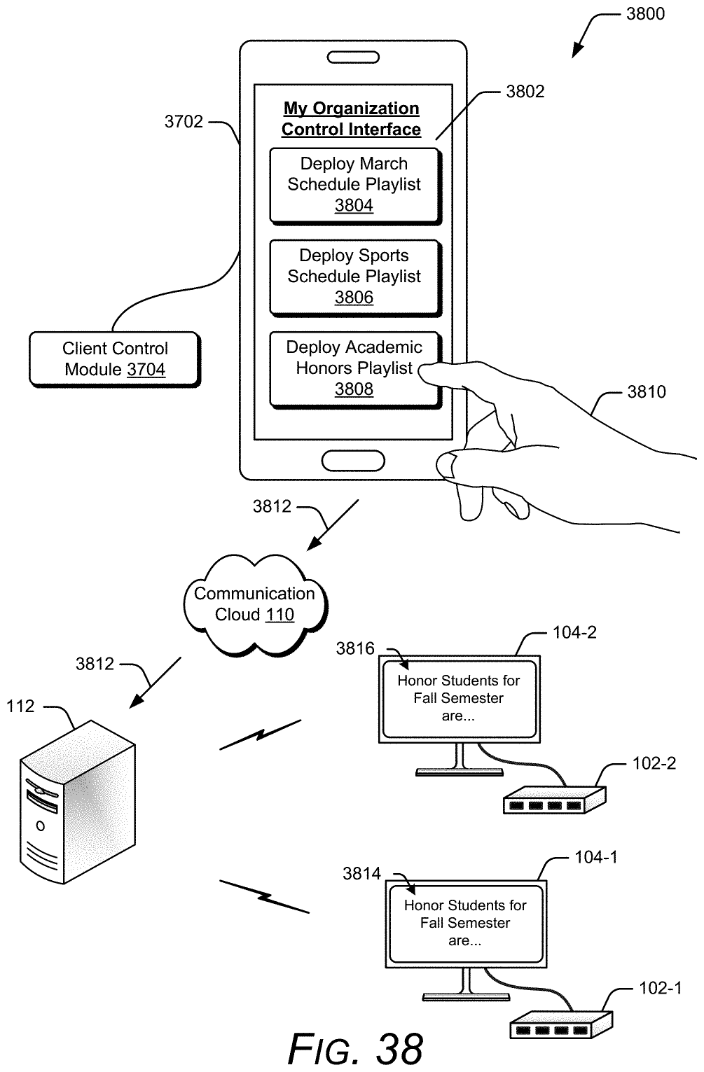

Now consider FIG. 39 that illustrates an example environment 3900 that can be used to implement a client control application that remotely exposes features of an organization information distribution system in accordance with one or more embodiments. In various implementations, the discussion with reference to environment 3900 can be considered a continuation of one or more examples described with reference to FIGS. 1-37. Environment 3900 includes computing device 3702 of FIG. 37 that is communicatively coupled to server 112 of FIG. 1 over communication cloud 110. In implementations, computing device 3702 implements features of client control module 3704, such as through software, hardware, firmware, or any combination thereof. This can include implementing client control module 3704 as a stand-alone application and/or as a client-side application that communicates with a server-side application using cloud-based techniques.

In environment 3900, computing device 3702 renders user interface 3902 by way of client control module 3704. User interface 3902 includes playback controls 3904, each of which corresponds to a playlist playback action (e.g., rewind, play, forward, stop, pause, record, etc.). Here, the playback controls 3904 correspond to controlling playback of a particular playlist identified as “Academic Honors”. The client control module can automatically determine what playlist(s) are active at the organization information distribution system, such as by querying server 112 over the communication cloud 110. In turn, the control module 3704 can automatically associate playback controls 3904 with an active playlist based on information received from server 112. Alternately or additionally, a user can manually select a playlist, such as through a drop-down menu control rendered on user interface 3902 (not illustrated here). The drop-down menu can include active playlists and inactive playlists.

User interface 3902 receives user input via a touch screen of computing device 3702 that corresponds to actuation playback controls 3904, but alternate forms of user input can be received, such as through a keyboard, a stylus, audible input, etc. Here, user 3906 enters touch input that actuates a pause playback control to pause playback of playlist “Academic Honors”. In turn, the client control module communicates a control request 3908 to server 112. Similar to that described with reference to action request 3812 of FIG. 38, the client control module can configure control request 3908 as a trigger event. Alternately or additionally, the control request 3908 can correspond to client control module 3704 invoking an API at the server that pauses playback of a playlist and/or a client-side control application invoking cloud-based services that are hosted by server 112.

In response to receiving the control request, the server deploys the action across the organization information distribution system. Here, the server forwards a command to content management device 102-1 and content management device 102-2 that pauses playback of the playlist active at each respective content management device. This is further illustrated by display device 104-1 and display device 104-2 each rendering an indication that playback has been paused.

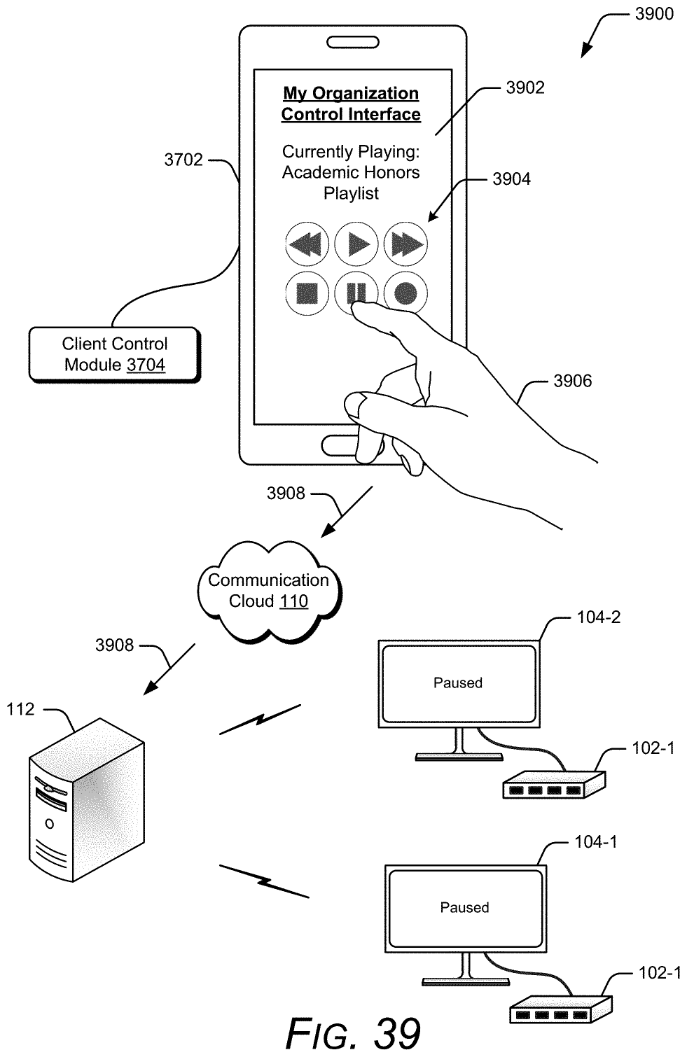

Consider now FIG. 40 that illustrates an example environment 4000 in which cloud-based services can be utilized to provide client control of an organization information distribution system accordance with one or more implementations. In various implementations, the example described with respect to FIG. 4000 can be considered a continuation of one or more examples described with respect to FIGS. 1-39. While example environment 4000 illustrates implementations that utilize cloud-based services, it is to be appreciated that other implementations, such as stand-alone applications, can alternately or additionally be employed.

Environment 4000 includes server 112 of FIG. 1 and computing device 3702 of FIG. 37 that are communicatively coupled via communication cloud 110 of FIG. 1. Computing device 3702 includes a processing system 4002, and one or more computer-readable media 4004. Processing system 4002 is representative of functionality to perform one or more operations using hardware. Accordingly, the processing system 4002 is illustrated as including hardware elements 4006 that may be configured as processors, functional blocks, and so forth. This may include implementations in hardware as an application specific integrated circuit or other logic device formed using one or more semiconductors. The hardware elements 4006 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 4004 is illustrated as including memory/storage 4008. The memory/storage 4008 represents memory/storage capacity associated with one or more computer-readable media. The memory/storage 4008 may include volatile media (such as random-access memory (RAM)) and/or nonvolatile media (such as read only memory (ROM), Flash memory, optical disks, magnetic disks, and so forth). The memory/storage 4008 may include fixed media (e.g., RAM, ROM, a fixed hard drive, and so on) as well as removable media (e.g., Flash memory, a removable hard drive, an optical disc, and so forth). The computer-readable media 4004 may be configured in a variety of other ways as further described below. Here, a client-side control module 4010 is illustrated as residing within memory/storage 4008, but alternate or additional implementations implement client-side control module 4008 using combinations of firmware, hardware, and/or software without departing from the scope of the claimed subject matter, such as hardware elements 4006.

Example environment 4000 enables multiple devices to be interconnected through server 112, where server 112 can be local to the multiple devices, remote from the multiple devices, or any combination thereof. In one or more implementations, server 112 is configured as a cloud of one or more server computers that are connected to the multiple devices through a network, the Internet, or other data communication link. This interconnected architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices.

In various implementations, the interconnected architecture allows the server 112 of the organization information distribution system to increase a quality of services provided by the organization information distribution system by implementing workload management optimizations based on observed data, performing dynamic operations on different servers, basing the dynamic operations on a flow of requests through the system to offload work to idle servers, etc. Alternately or additionally, the interconnected architecture allows the organization information distribution system to scale and/or manage resources to optimally tailor experiences to all client devices receiving cloud-based services. Here, “optimally tailor experiences” denotes the organization information distribution system balancing how the cloud-based services are provided to each client device based on meeting the needs of each client device using the resources available through the cloud.

In at least one embodiment, a class of target devices is created and experiences are tailored to the generic class of devices. A class of devices may be defined by physical features, types of usage, or other common characteristics of the devices. In various implementations, scaling and/or managing the resources includes measuring the available resources of the organization information distribution system to make a determination on how to distribute the resources. Various implementations utilize a workload layer of the cloud-based services to provide functionality of the organization information distribution system, such as remote access and/or remote control of the organization information distribution system.

The cloud 4012 includes and/or is representative of a platform 4014 for resources 214. The platform 4014 abstracts underlying functionality of hardware (e.g., servers) and software resources of the cloud 4012. Resources 4016 may include applications and/or data that can be utilized while computer processing is executed on servers that are remote from the computing device 3702. For example, resources 4016 can include a server-side control module 4018 to provide various functionality corresponding to remote access and/or remote control of the organization information distribution system.

The platform 4014 may abstract resources and functions to connect computing device 3702 with other computing devices. The platform 4014 may also serve to abstract scaling of resources to provide a corresponding level of scale to encountered demand for the resources 4016 that are implemented via the platform 4014. Accordingly, in an interconnected device embodiment, implementation of functionality described herein may be distributed throughout the system. For example, the functionality may be implemented, in part, on the computing device 3702 as well as via the platform 4014 that abstracts the functionality of the cloud 4012.

Here, the phrase “cloud-based services” is used to generally to denote any suitable type of cloud-based service and/or deployment mechanism across a network, such as cloud-based services that follow, by way of example and not of limitation, a Software as a Service (SaaS) model, a Platform as a Service (PaaS) model, an Infrastructure as a Service (IaaS) model, and so forth. Accordingly, the various implementations described herein can be deployed and/or implemented using any one or combination of these models to provide various aspects of remote control of an organization information distribution system. In some scenarios, the cloud-based services utilize different types of stack architectures that employ multiple interconnected layers (e.g., application layers, networking layers, workload layers, hardware layers, software layers, management layers, virtualization layers, etc.). Various implementations can integrate aspects of the organization information distribution system into any one and/or combination of layers utilized by the cloud-based services.

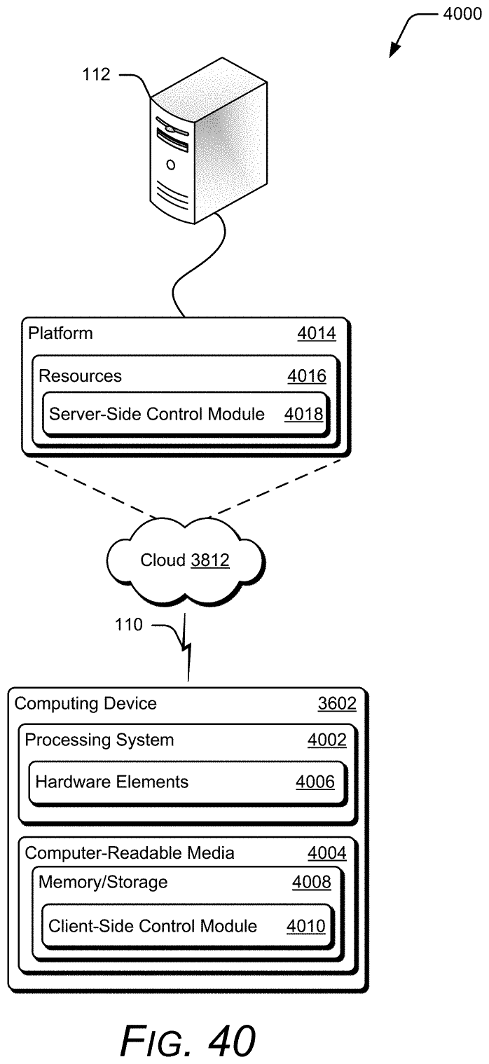

FIG. 41 illustrates an example method 4100 for remotely controlling an organization information distribution system via a client control application in accordance with one or more implementations. The method can be performed by any suitable combination of hardware, software, and/or firmware. In at least some embodiments, aspects of the method can be implemented by one or more suitably configured hardware components and/or software modules, such as the server 112 of FIG. 1. While the method described in FIG. 41 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 4102, a connection between to a remote computing device and an organization information distribution system is established. For example, server 112 establishes a connection with computing device 3702 over communication cloud 110. In some implementations, server 112 hosts server-side control module 4018 that establishes a connection with client-side control module 4010 executed by computing device 3702, where the server-side control module and the client-side control module correspond to features associated with remotely controlling an organization information distribution system. Alternately or additionally, the server 112 receives a request from a stand-alone client control application at the computing device 3702 to establish the connection, such as client control module 3704. In establishing the connection, various implementations authenticate the computing device. This can include authenticating through the use of a username and password pair, a public/private key pair, a digital certificate, a token, symmetric keys, digital identity authentication, etc.

In response to establishing the connection, one or more implementations receive a control request from the remote computing device at 4104. For instance, computing device 3702 communicates control request 3812 to server 112 over communication cloud 110, where the control request corresponds to deploying a particular playlist across the organization information distribution system. In implementations, the control request corresponds to a trigger event, and can include any suitable combination of information, such as location information, date information, device identification, playlist identification, etc. As another example, computing device 3702 communicates control request 3908 to server 112 over communication cloud 110, where the control request corresponds to controlling playback functionality of a playlist as further described herein. However, any other suitable type of control request can be sent via the client control module, examples of which are described with reference to at least FIGS. 1-39. Similar to control request 3812, control request 3908 can be configured as a trigger event.

At 4106, an action corresponding to the control request is deployed to one or more devices of the organization information distribution system. For example, in response to receiving control request 3812, server 112 deploys and/or invokes a playlist to content management device 102-1 and content management device 102-2. As another example, in response to receiving control request 3908, server 112 pauses playback of a playlist at content management device 102-1 and content management device 102-2.

Having described aspects of client control applications that provide remote control of an organization information distribution system, consider now a discussion of security monitoring devices in an organization information distribution system in accordance with one or more implementations.

Monitoring Security Systems with Organization Information Distribution Systems

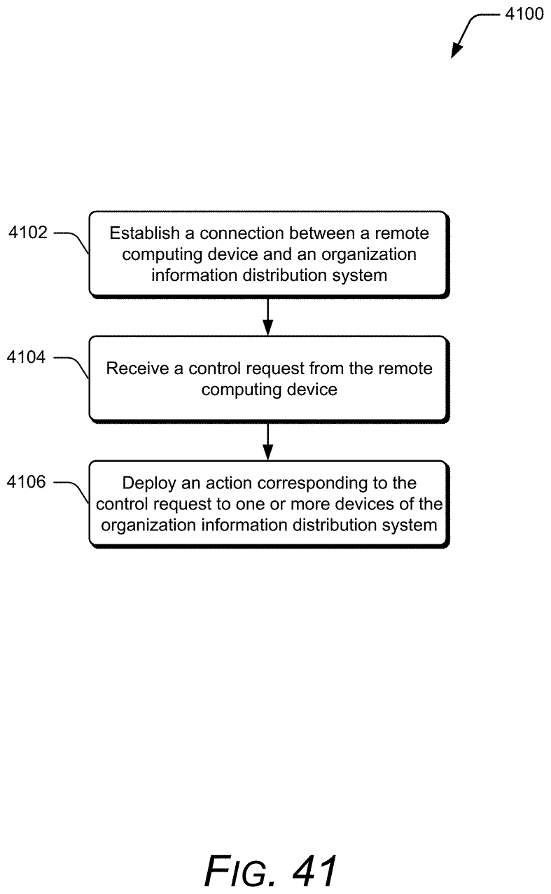

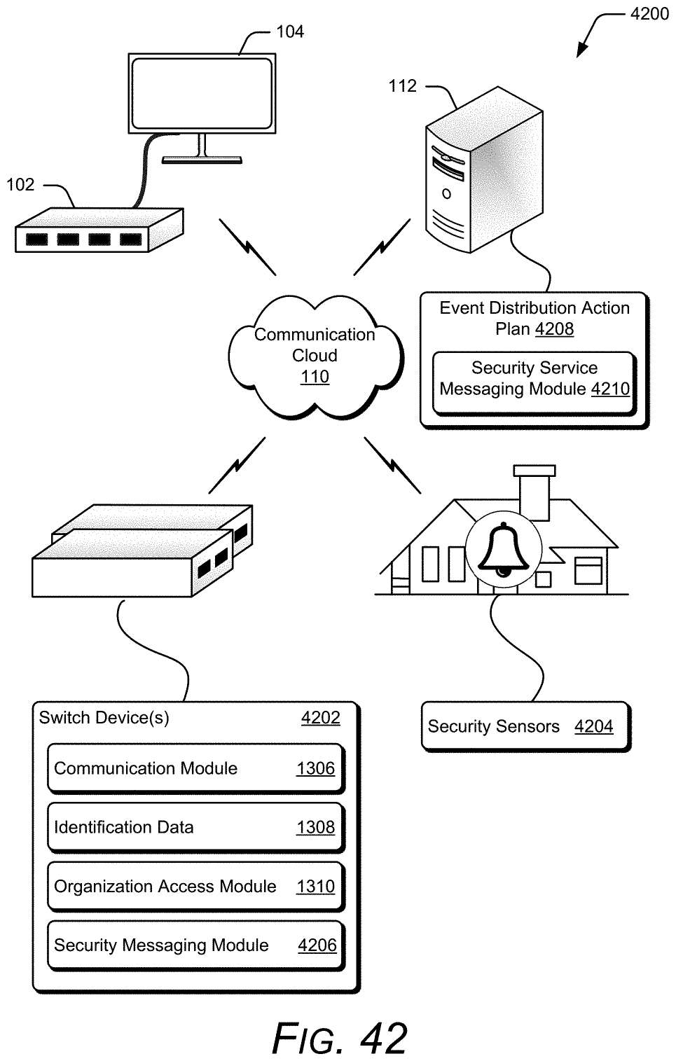

In various implementations, a security monitoring device can interface with security systems and an organization information distribution system to monitor and communicate security breaches. To demonstrate, consider now FIG. 42 that illustrates an example environment 4200 in accordance with one or more implementations. The environment described with reference to FIG. 42 can represent a continuation of one or more examples described with reference to FIGS. 1-41. Environment 4200 includes content management device 102, display device 104, and server 112 of FIG. 1 that are communicatively coupled over communication cloud 110.

Environment 4200 also includes switch devices 4202 that are communicatively coupled to server 112 via communication cloud 110. The switch devices can be implemented using any combination of hardware, firmware, and/or software, such as a daughter board that connects to a motherboard. In implementations, switch devices 4202 receive notifications from security system sensors, such as security sensors 4204. For example, switch devices 4202 can receive messages from any type of sensor included in security sensors 4204, such as cameras, door switches, smoke detectors, and so forth, over communication cloud 110, where the messages from the sensors indicate that a sensor event has occurred. In turn, the switches forward a notification to the organization information distribution system of the security event, such as by sending a message to server 112. In some implementations, there is a one-to-one relationship between a switch device and a security sensor (e.g., a first switch device corresponds to a door sensor, a second switch corresponds to a smoke detector, etc.). Alternately or additionally, there can be a many-to-one relationship between a switch device and multiple sensor devices.

The switch devices 4202 include communication module 1306 of FIG. 13 to provide access to communication cloud 110, identification data 1308 of FIG. 13 to include data corresponding to organization information (e.g., unique identifiers, location information, and so forth), and organization access module 1310 of FIG. 13 to include the ability to access functionality specific to the organization information distribution system. Alternately or additionally, the switch devices can access these features via a motherboard, such as in implementations where the switch devices are daughter boards that connect to a motherboard.

The switch devices 4202 also includes a security messaging module 4206 that receives incoming sensor event notifications from a security sensor, such as security sensors 4204, and signals and/or communicates a security event message to the organization information distribution system. The security messaging module 4206 can be implemented in any suitable manner, such as software, hardware, firmware, or any combination thereof. As on example, the security messaging module can receive a sensor event message from a motion sensor device that motion has been detected in a secured room. In turn, the security messaging module can generate and forward a security event message that is consumable by the organization information distribution system to server 112.

Sensor devices 4204 generally represent security devices that can detect and communicate security events. This can include any combination of motion detectors, smoke detectors, door sensors, window sensors, proximity sensors, security cameras, glass break sensors, shock sensors, garage door sensors, and so forth. Accordingly, sensor devices 4204 can include sensors, processors, hardware, software, firmware, and/or any combination thereof to detect and communicate security events. In implementations, the sensor devices can communicate detected security events over communication cloud 110 to switch devices 4202.

As further described herein, server 112 generally corresponds to an organization information distribution system. In some implementations, switch devices 4202 can be included in an organization profile managed by the server 112 of FIG. 1, where the switch devices are registered as devices that can receive and/or generate trigger events (e.g., security event messages). Based on information in the organization profile, such as address information, server 112 can connect to the switch devices over communication cloud 110.

In environment 4200, server 112 includes an event distribution action plan 4208 that specifies an action plan to execute based upon identified security events. For instance, the event distribution action plan can specify a tiered approach that indicates where and when to distribute notifications of a corresponding event, such as an incoming security event from security messaging module 4206. Alternately or additionally, event distribution action plan 4208 can invoke a security service messaging module 4210 that generates messages in a format consumable by a remote security provider. In other words, the event distribution action plan can include sending a notification to the remote security provider in a format that is unique to the remote security provider. This allows a user to access security monitoring services provided by the organization information distribution system without using a security panel associated with the remote security provider.

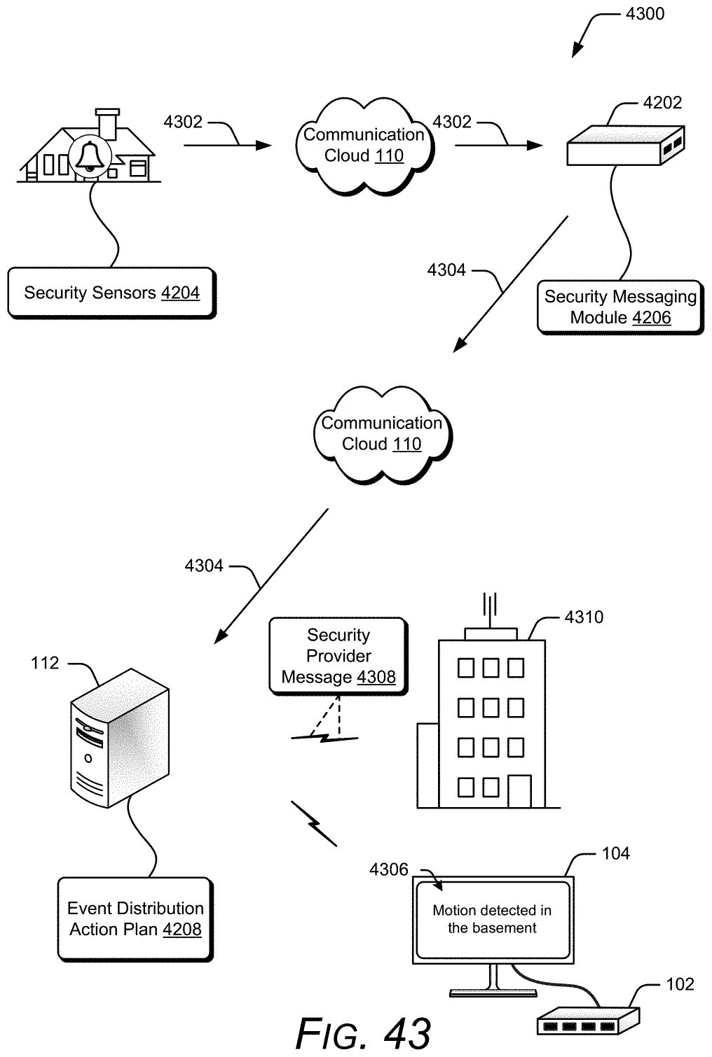

To demonstrate, consider now FIG. 43 that illustrates an example environment 4300 that can be used to implement features of security monitoring in an organization information distribution system in accordance with one or more implementations. In various implementations, the discussion with reference to environment 4300 can be considered a continuation of one or more examples described with reference to FIGS. 1-42. Environment 4300 includes switch devices 4202 and security sensors 4204 of FIG. 42 that are communicatively coupled over communication cloud 110 of FIG. 1. Environment 4300 also includes server 112 of FIG. 1 that is communicatively coupled to the switch devices over the communication cloud effective to receive signals and/or communications from the switch devices. In implementations, server 112 includes event distribution action plan 4208.

In implementations, at least one sensor of sensor devices 4204 communicates a sensor event message 4302 to the switch devices in response to a detection event. For instance, consider a scenario in which a sensor device detects glass breaking. The sensor device can communicate a sensor event message 4302 to a switch device that indicates broken glass has been detected. Sensor event message 4302 can include any suitable type of information, such as location information, timestamp information, and so forth. In some implementations, the sensor event message from the sensor device includes sensor event type information (e.g., smoke detected event, broken glass detected event, motion detected event, etc.). Alternately or additionally, the sensor event message from the sensor devices 4204 includes a sensor identifier (e.g., smoke alarm 1, smoke alarm 2, glass detector 3, etc.). The sensor devices can broadcast the sensor event message 4302 to any listening devices and/or direct the sensor event message 4302 to a particular switch device of the switch devices 4202. In some implementations, sensor event message 4302 is a simple message, such as an electronic signal toggling from high-to-low, or vice versa that triggers an action. Thus, sensor event message 4302 can range in complexity and scope, from a simple line toggle to complex messages. Sensor devices 4204 can communicate the sensor event message 4302 to the switch devices 4202 in any suitable manner, such as wirelessly over any type of wireless network using the corresponding messaging protocols, over via a wired connection, such as a direct wired connection between a sensor device and a switch device, etc.

In response to receiving sensor event message 4302, switch devices 4202 can forward a security event message 4304 to server 112. In implementations, security messaging module 4206 receives and interprets security event messages from various sensors, each of which has different formatting from one another. For instance, a smoke alarm sensor can communicate a “smoke detected event” message in a first format, a glass sensor can communicate a “broken glass detected event” message in a second format, etc. Thus, the security messaging module 4206 can interface with varying types of sensor devices that communicate in varying formats from one another. The security messaging module 4206 can alternately or additionally distinguish between simple messages from various sensor devices.

In implementations, the security messaging module 4206 generates a trigger event, and communicates the trigger event as security event message 4304. This can include translating the sensor event message 4302 from a format that is specific to a particular sensor device into a format that is consumable by the organization information distribution system (e.g., into a trigger event). Any suitable type of information can be included in the security event message, such as location information, timestamp information, sensor device identification, security event type, and so forth. Alternately or additionally, security event message 4304 includes a switch identifier and/or a motherboard identifier associated with the switch that received the sensor event message, such as “Switch X that corresponds to Motherboard Y has been activated”, where X and Y are arbitrary values. As further described herein, some implementations of the switch devices couple to a motherboard. In turn, the organization information distribution system can generate a map that identifies which switch on which motherboard corresponds to a particular security sensor. In response to receiving a switch identifier and/or a motherboard identifier (e.g., Switch X on Motherboard Y), the organization information distribution system can use the map to identify the particular sensor being tripped and/or activated.

In response to receiving the security event message 4304, server 112 can distribute security information related to the security event message across the organization information distribution system. In environment 4300, server 112 includes event distribution action plan 4208 of FIG. 42 that provides action instructions for various detected security events. For instance, event distribution action plan 4208 can specify to, based on receiving security event message 4304, distribute the security information to select devices and/or to all devices within the organization information distribution system, such as by invoking an immediate view 4306 at content management device 102 that is rendered at display device 104. However other types of messages can be deployed across the organization information distribution system to other types of devices as well, examples of which are provided herein.

Event distribution action plan 4208 can alternately or additionally indicate to generate a security provider message 4308 that relays information pertaining to the security event message in a format that is consumable by a security provider 4310. Consider a scenario in which a user contracts the security provider 4310 for security services, such as notifying a police department, notifying a fire department, calling a phone for security checks, and so forth, when a security event is detected. The server 112, as directed by event distribution action plan 4208, can notify the security provider 4310 of security events by generating and communicating messages that are consumable by, and/or specific to, the security provider, such as by security service messaging module 4210 of FIG. 42. In turn, the security provider receives the security provider message 4310 and deploys the contracted services. Thus, an organization information distribution system can disperse information to security providers and/or invoke security services provided by the security providers. Alternately or additionally, the organization information distribution system disperses notifications of the security event to other devices within the organization. This can help improve response times to the security events insofar as multiple users can be notified of the security event, thus increasing the probability of someone seeing the security event and/or responding quickly.

Using an organization information distribution system to deploy action plans that include contacting a security provider also decouples the security sensors at the home to particular security providers by removing the need to install security panels associated with the security provider to monitor the sensors and communicate with the particular service provider. This decoupling enables the user to change security providers without changing the sensor devices and/or the switches that communicate to server 112. Instead, a user can change security providers and redirect server 112 to the new service provider. For example, a user may decide to terminate the security services provided by security provider 4310 in favor of another security provider. In turn, server 112 can be updated to redirect and/or format messages based on the new security provider without reconfiguring the sensor devices.

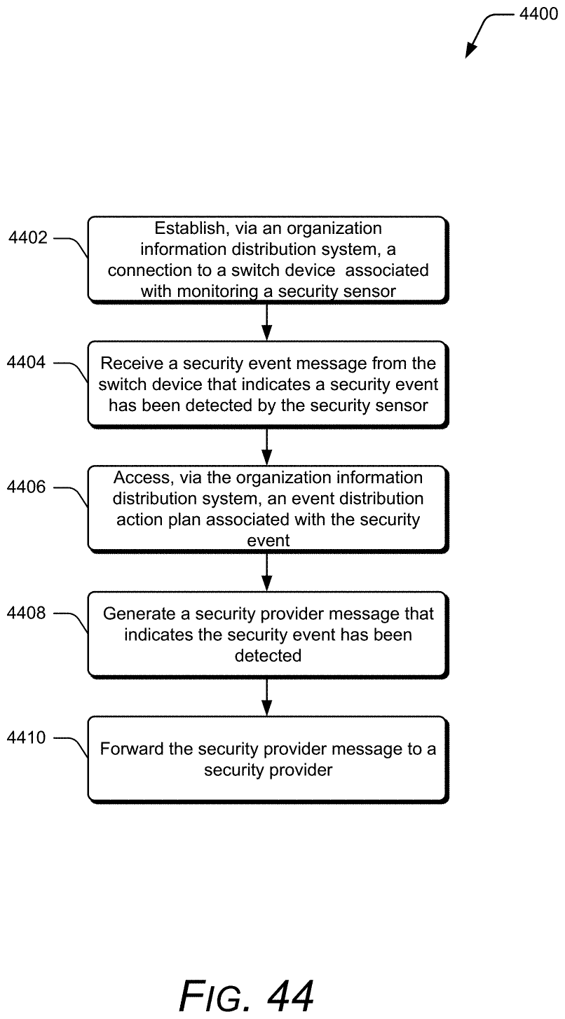

FIG. 44 illustrates an example method 4400 for monitoring security systems with an organization information distribution system. The method can be performed by any suitable combination of hardware, software, and/or firmware. In at least some embodiments, aspects of the method can be implemented by one or more suitably configured hardware components and/or software modules, such as by server 112 of FIG. 1. While the method described in FIG. 44 illustrates these steps in a particular order, it is to be appreciated that any specific order or hierarchy of the steps described here is used to illustrate an example of a sample approach. Other approaches may be used that rearrange the ordering of these steps. Thus, the order of the steps described here may be rearranged, and the illustrated ordering of these steps is not intended to be limiting.

At 4402, a connection to a switch device associated with monitoring a security sensor is established via an organization information distribution system. For example, server 112 establishes a connection to switch devices 4202 over communication cloud 110. In some implementations, server 112 accesses an organization profile to obtain address information associated with the switch devices, and uses the address information to establish the connection.

At 4404, a security event message that indicates a security event has been detected by the security sensor is received from the switch device. For instance, server 112 receives security event message 4304 over communication cloud 110 from switch devices 4202, where security messaging module 4206 generates the security event message in response to receiving sensor event message 4302 from security sensors 4202. The security event message sometimes includes a switch identifier and/or a motherboard identifier. Alternately or additionally, the security event message identifies a particular security sensor that detected the security event. Various implementations configure the security event message as a trigger event.

In response to receiving the security event message, one or more implementations access, via the organization information distribution system, an event distribution action plan associated with the security event at 4406. For example, server 112 accesses event distribution action plan 4208 that indicates how to disseminate an indication of the security event. Some implementations indicate to disseminate an indication to a security provider. Accordingly, in one or more implementations, a security provider message that indicates the security event has been detected is generated at 4408. For example, a security service messaging module 4210 generates the security provider message in a format that is particular to the security provider, such as security provider message 4308 that is in a format particular to security provider 4310.

In response to generating the security provider message, one or more implementations forward the security provider message to a security provider at 4410. Server 112, for instance, forwards security provider message 4308 to security provider 4310.

Having described various features of monitoring a security system via an organization information distribution system, consider now a discussion of example devices in which can be used for various implementations.

Example Devices

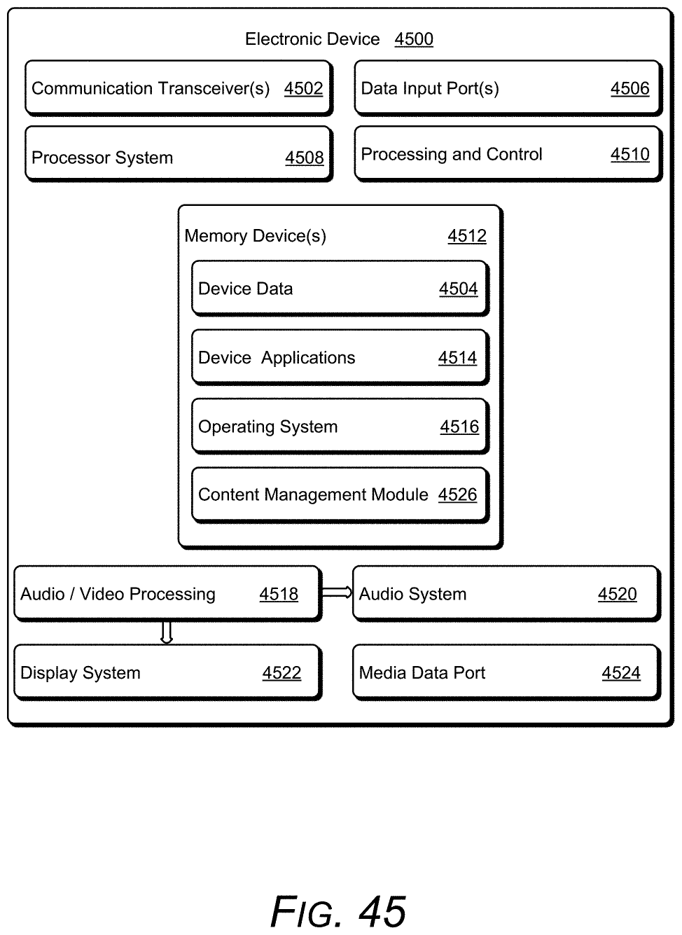

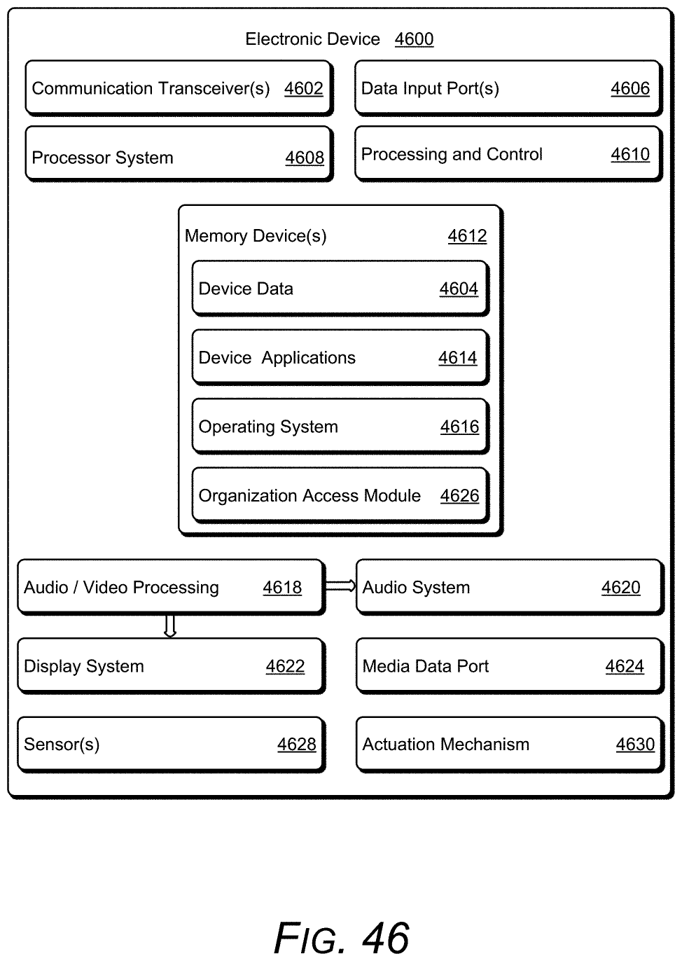

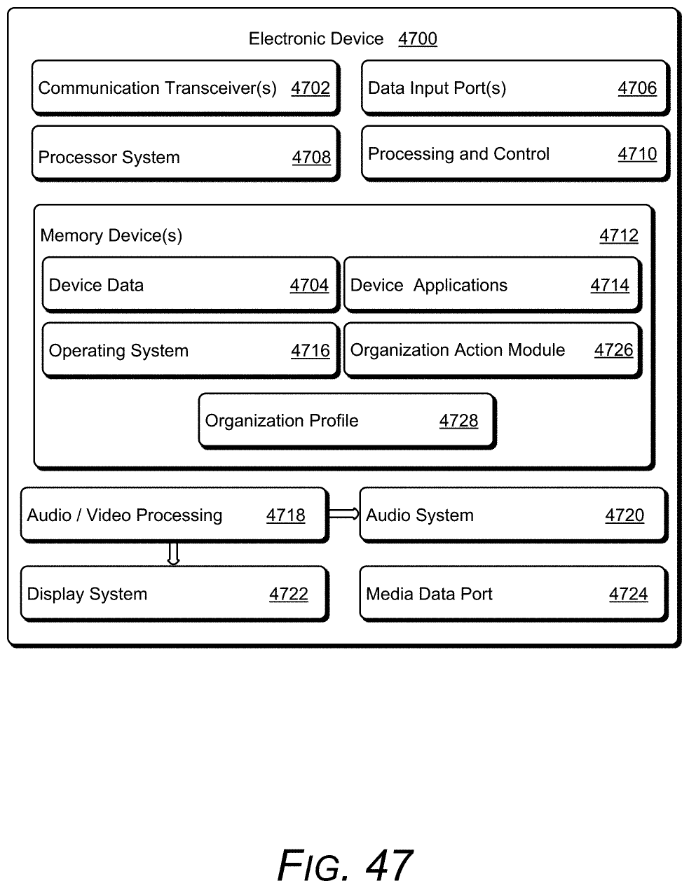

FIG. 45 illustrates various components of an example electronic device 4500, such as content management device 102 of FIG. 1, while FIG. 46 illustrates various components of an example electronic device 4600, such as invocation device 1302 of FIG. 13, invocation device 1602 of FIG. 16, invocation device 1802 of FIG. 18, video monitoring device 2304 of FIG. 23, vape detection device 2902 of FIG. 29 and/or switch device 4402 of FIG. 42. FIG. 47 illustrates various components of an example electronic device 4700, such as server 112 of FIG. 1, computing device 3302 of FIG. 33, computing device 3702 of FIG. 37. Accordingly, electronic device 4500, electronic device 4600, and/or electronic device 4700 can be utilized to implement various aspects of deploying actions and/or immediate views across an organization as further described herein. In some implementations, electronic device 4500, electronic device 4600, and electronic device 4700 have at least some similar components. Accordingly, for the purposes of brevity, FIGS. 45-47 will be described together. Similar components associated with FIG. 45 will be identified as components having a naming convention of “45XX”, components associated with FIG. 46 will be identified as components having a naming convention of “46XX”, and components associated with FIG. 47 will be identified as components having a naming convention of “47XX”. Conversely, components distinct to each device will be described separately and after the similar components.

Electronic device 4500/electronic device 4600/electronic device 4700 includes communication transceivers 4502/communication transceivers 4602/communication transceivers 4702 that enable wired or wireless communication of device data 4504/device data 4604/device data 4704, such as received data and transmitted data. While referred to as a transceiver, it is to be appreciated that communication transceivers 4502/communication transceivers 4602/communication transceivers 4702 can additionally include separate transmit antennas and receive antennas without departing from the scope of the claimed subject matter. Example communication transceivers include Wireless Personal Area Network (WPAN) radios compliant with various Institute of Electrical and Electronics Engineers (IEEE) 802.15 (Bluetooth™) standards, Wireless Local Area Network (WLAN) radios compliant with any of the various IEEE 802.11 (WiFi™) standards, Wireless Wide Area Network (WWAN) radios for cellular telephony (3GPP-compliant), wireless metropolitan area network radios compliant with various IEEE 802.16 (WiMAX™) standards, and wired Local Area Network (LAN) Ethernet transceivers.

Electronic device 4500/electronic device 4600/electronic device 4700 may also include one or more data input ports 4506/data input ports 4606/data input ports 4706 via which any type of data, media content, and inputs can be received, such as user-selectable inputs, messages, music, television content, recorded video content, and any other type of audio, video, or image data received from any content or data source. Data input ports 4506/data input ports 4606/data input ports 4706 may include Universal Serial Bus (USB) ports, coaxial-cable ports, and other serial or parallel connectors (including internal connectors) for flash memory, Digital Versatile Discs (DVDs), Compact Disks (CDs), and the like. These data-input ports may be used to couple the electronic device to components, peripherals, or accessories such as keyboards, microphones, or cameras.

Electronic device 4500/electronic device 4600/electronic device 4700 of this example includes processor system 4508/processor system 4608/processor system 4708 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively, or in addition, the electronic device can be implemented with any one or combination of software, hardware, firmware, or fixed-logic circuitry that is implemented in connection with processing and control circuits, which are generally identified as processing and control 4510/processing and control 4610/processing and control 4710. Although not shown, electronic device 4500/electronic device 4600/electronic device 4700 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 4500/electronic device 4600/electronic device 4700 also includes one or more memory devices 4512/memory devices 4612/memory devices 4712 that enable data storage, examples of which include random access memory (RAM), non-volatile memory (e.g., read-only memory (ROM), flash memory, EPROM, EEPROM, etc.), and a disk storage device. Memory devices 4512/memory devices 4612/memory devices 4712 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 4512/memory devices 4612/memory devices 4712 provide data storage mechanisms to store the device data 4504/device data 4604/device data 4704, other types of information or data, and/or various device applications 4514/device applications 4614/device applications 4714 (e.g., software applications). For example, operating system 4516/operating system 4616/operating system 4716 can be maintained as software instructions within memory devices 4512/memory devices 4612/memory devices 4712 and executed by processor system 4508/processor system 4608/processor system 4708.

Electronic device 4500/electronic device 4600/electronic device 4700 optionally includes audio and video processing system 4518/audio and video processing system 4618/audio and video processing system 4718 that processes audio data and passes through the audio and video data to optional audio system 4520/audio system 4620/audio system 4720. Audio system 4520/audio system 4620/audio system 4720 and optional display system 4522/display system 4620/display system 4720 may include any modules that process, display, or otherwise render audio, video, display, or image data. Display data and audio signals can be communicated to an audio component and to a display component via a radio-frequency link, S-video link, HDMI, composite-video link, component-video link, digital video interface, analog-audio connection, or other similar communication link, such as optional media data port 4524/media data port 4624/media data port 4524. In some implementations, optional audio system 4520/audio system 4620/audio system 4720 and optional display system 4522/display system 4620/display system 4720 are external components to electronic device 4500/electronic device 4600/electronic device 4700. Alternatively, or additionally, optional audio system 4520/audio system 4620/audio system 4720 and optional display system 4522/display system 4620/display system 4720 can be an integrated component of the example electronic device 4500/electronic device 4600/electronic device 4700, such as part of an integrated speaker and/or an integrated display and touch interface.

In some aspects, memory devices 4512 of electronic device 4500 includes content management module 4526 to manage the content that is presented by electronic device 4500. Various implementations of content management module 4526 access cloud-based services over a network using communication transceivers 4502 and/or device applications 4514 associated with communication exchange. While these modules are illustrated and described as residing within memory devices 4512, other implementations of these modules can alternately or additionally include software, firmware, hardware, or any combination thereof.

In some aspects, electronic device 4600 includes organization access module 4626, sensors 4628, and actuation mechanism 4630. Organization access module 4626 provides electronic device 4600 with access to specific functionality provided by the organization information distribution system, such as cloud-based services, communication message formatting, etc. Sensors 4628 represent detection mechanisms that can discern when events of interest occur in an area surrounding electronic device 4600, examples of which are provided herein. Actuation mechanism 4630 represents an exposed user interface that enables a user to invoke a trigger event through a single user-interaction and/or multiple user interactions. This can include a mechanical mechanism (e.g., a hardware button) and/or a software mechanism. While electronic device 4600 includes both sensors 4628 and actuation mechanism 4630, alternate implementations include sensors without actuation mechanisms, or an actuation mechanism without a sensor. Organization access module 4626, sensors 4628, and actuation mechanism 4630 can include software, firmware, hardware, or any combination thereof.

In some aspects, memory devices 4712 of electronic device 4700 includes organization action module 4726 and organization profile 4728. Organization action module 4726 provides an organization information distribution system with the ability to deploy actions and/or distribute content across an organization based on trigger events. In some implementations, organization action module 4726 provides cloud-based services to various devices in the organization information distribution system, such as a content management device. Organization profile 4728 represents customized configuration parameters associated with an organization that are applied and/or used by organization action module 4726 to discern what actions and/or content to disseminate throughout an organization.

In view of the many possible aspects to which the principles of the present discussion may be applied, it should be recognized that the implementations described herein with respect to the drawing figures are meant to be illustrative only and should not be taken as limiting the scope of the claims. Therefore, the techniques as described herein contemplate all such implementations as may come within the scope of the following claims and equivalents thereof.

We claim:

1. A device comprising:
one or more processor; and
one or more memory storage devices storing processor executable instructions that, responsive to execution by the one or more processors, cause the device to perform operations comprising:
connecting, over a network, to a camera via a video monitoring device;
obtaining, from the camera, video data associated with a live video stream;
storing the video data in a circular buffer;
receiving a trigger event associated with an organization information distribution system;
generating a video clip from the video data in the circular buffer based on the trigger event, the video clip including video data stored prior to the trigger event, and
transmitting the video clip to a destination computing device via the organization information distribution system.

2. The device as recited in claim 1, wherein generating the video clip comprises:
extracting a first amount of the video data prior to the trigger event from the circular buffer based on a first predetermined extraction value;
extracting a second amount of the video data after the trigger event from the circular data based on a second predetermined extraction value; and
combining the first amount of the video data with the second amount of the video data to generate the video clip.

3. The device as recited in claim 1, wherein said receiving the trigger event comprises receiving the trigger event from an external computing device.

4. The device as recited in claim 1, wherein said receiving the trigger event comprises:
analyzing the video stream to identify motion captured in the video stream; and
generating the trigger event in response to identifying the motion.

5. The device as recited in claim 1, wherein the operations further comprise:
transmitting, in response to receiving the trigger event, live video stream to the destination computing device.

6. The device as recited in claim 1, wherein said receiving the trigger event comprises:
analyzing the live video stream using a facial recognition algorithm to determine an identity of a person captured by the live video stream;
determining that the identity of the person lacks proper authentication; and
generating the trigger event based on said determining.

7. The device as recited in claim 1, wherein the operations further comprise:
determining that a network connection has been disconnected;
caching the circular buffer of video data to generate stored video data that has been captured at a time associated with the network connection being disconnected;
determining that the network connection has been reconnected; and
forwarding stored video data to the destination computing device.

8. The device as recited in claim 1, wherein the trigger event comprises a vape detection trigger event.

9. The device as recited in claim 1, wherein the trigger event comprises a switch closure trigger event.

10. The device as recited in claim 1, wherein the operations further comprise:
receiving a command to update a value of the first predetermined amount or the second predetermined amount;
updating the first predetermined extraction value or the second predetermined extraction value to generate an updated extraction value; and
generating the video clip using the updated extraction value.

11. A computing device comprising:
one or more processor; and
one or more memory storage devices storing processor executable instructions that, responsive to execution by the one or more processors, cause the device to perform operations comprising:
establishing, over a network, a connection between a vape detection device and an organization information distribution system;
receiving, over the network, a vape detection trigger event from the vape detection device; and
deploying, over the network, a notification of the vape trigger across the organization information distribution system to one or more devices.

12. The computing device as recited in claim 11, wherein deploying the notification comprises deploying an immediate view that indicates the vape detection trigger event has been received.

13. The computing device as recited in claim 11, wherein deploying the notification comprises:
extracting location information from the vape detection trigger event; and
including the location information in the notification.

14. The computing device as recited in claim 11, wherein the operations further comprise:
extracting timestamp information from the vape detection trigger event; and
requesting a video clip based on the timestamp information from a video monitoring device associated with the organization information distribution system.

15. The computing device as recited in claim 11, wherein said establishing the connection between the vape detection device and the organization information distribution system comprises:
accessing an organization profile associated with the organization information distribution system;
extracting an address associated with the vape detection device from the organization profile; and
using the address to communicate with the vape detection device.

16. A computing device comprising:
one or more processor; and
one or more memory storage devices storing processor executable instructions that, responsive to execution by the one or more processors, cause the device to perform operations comprising:
authenticating a request from a remote computing device for remote access to an organization information distribution system;
providing the remote access in response to authenticating the request as being valid;
receiving a real-time message trigger event from the remote computing device; and
distributing a real-time message to one or more devices of the organization information distribution system.

17. The computing device as recited in claim 16, wherein authenticating the request comprises authenticating a username and password pair.

18. The computing device as recited in claim 16, wherein receiving the real-time message trigger event comprises text data to distribute as content of the real-time message.

19. The computing device as recited in claim 18, wherein distributing the real-time message comprises:
generating an audible alert from the text data; and
distributing the audible alert to at least one device of the one or more devices.

20. The computing device as recited in claim 16, wherein providing the remote access in response to authenticating the request as being valid comprises distributing a markup file that is consumable by a generic application.

21. A computing device comprising:
one or more processor; and
one or more memory storage devices storing processor executable instructions that, responsive to execution by the one or more processors, cause the device to perform operations comprising:
establishing a connection between a remote computing device and an organization information distribution system;
receiving, from the remote computing device, a control request; and
deploying an action corresponding to the control request to one or more devices of the organization information distribution system.

22. The computing device as recited in claim 21, wherein said establishing the connection comprises establishing a connection with a mobile phone application at the remote computing device.

23. The computing device as recited in claim 21, wherein deploying the action comprises deploying a pause playback command to a content management device.

24. The computing device as recited in claim 21, wherein said establishing the connection comprises establishing a connection between a server-side application at the computing device and client-side application at the remote computing device.

25. The computing device as recited in claim 21, wherein the operations further comprise:
receiving a query from the remote computing device for a list of features associated with the organization information distribution system;
determining a number of features within a predetermined threshold; and
returning, to the remote computing device, each feature included in the number of features.

26. A method comprising
establishing a connection to a switch associated with monitoring a security sensor;
receiving a security event message from the switch that indicates a security event has been detected by the security sensor;
accessing an event distribution action plan associated with the security event;
generating, based on the event distribution action plan, a security provider message that indicates the security event has been detected; and
forwarding the security provide message to a security provider.

27. The method as recited in claim 26, wherein said receiving the security event message comprises receiving a switch identifier and a motherboard identifier in the security event message.

28. The method as recited in claim 26, wherein generating the security provider message comprises generating a message particular to the security provider.

29. The method as recited in claim 28, wherein the operations further comprise:
deploying, based on the event distribution action plan, an immediate view to a content management device that indicates the security event has been detected.

30. The method as recited in claim 26, wherein establishing a connection to the switch device comprises accessing an organization profile to obtain address information associated with the switch device.
